(19) United States
(12) Patent Application Publication
(10) Pub. No.: US 2014/0071125 A1
(43) Pub. Date: Mar. 13, 2014

(54) Patient-Specific Segmentation, Analysis, and Modeling from 3-Dimensional Ultrasound Image Data

(71) Applicants: Philippe M. Burlina, N. Bethesda, MD (US); Ryan N. Mukherjee, Brookeville, MD (US); Chad R. Sprouse, Ellicott City, MD (US)

(72) Inventors: Philippe M. Burlina, N. Bethesda, MD (US); Ryan N. Mukherjee, Brookeville, MD (US); Chad R. Sprouse, Ellicott City, MD (US)

(73) Assignee: THE JOHNS HOPKINS UNIVERSITY, Baltimore, MD (US)

(21) Appl. No.: 13/609,476

(22) Filed: Sep. 11, 2012

(51) Int. Cl. G06T 17/00

(52) U.S. Cl. CPC G06T 17/00
USPC 345/420

(57) ABSTRACT

Methods and systems to analyze and predict patient-specific physiological behavior of a human organ or anatomical entity such as the heart complex and the heart subcomponents from 3-dimensional volumetric ultrasound (3D) or time-sequential volumetric (4D) ultrasound image data, to assist physicians in performing diagnostics and cardiac preoperative planning. Also disclosed herein are methods and systems to segment patient-specific anatomical features from 3D/4D ultrasound. Also disclosed herein are methods and systems to compute patient-specific tissue motion and blood flow from 3D/4D ultrasound and contrast-enhanced 3D/4D ultrasound image data. Also disclosed herein are methods and systems to simulate the patient-specific mechanical behavior of the organ and anatomical entity using both 3D/4D ultrasound and mechanical models. Also disclosed herein are methods and systems to estimate tissue stress and strain and physiological parameters of the tissues from 3D/4D ultrasound.

### CROSS REFERENCE TO RELATED APPLICATIONS

U.S. Provisional Patent Application No. 61/422,778, titled, “Estimating Blood Flow Motion in the Left Intraventricular Cavity using Contrast Enhanced Ultrasound,” filed Dec. 14, 2010, is incorporated herein by reference in its entirety.

### BACKGROUND

1. Technical Field

Patient-specific preoperative planning based on segmentation, motion analysis, simulation and modeling of anatomical entities and organs from 3-dimensional volumetric (3D) ultrasound image data and 3-dimensional volumetric time-sequenced (4D) ultrasound image data; Preoperative planning for heart and valve surgery (valvuloplasty); Patient-specific simulation, modeling, and prediction of the mechanical behavior of anatomical entities and organs from 3D and 4D ultrasound image data; Determination of tissue motion from 3D/4D ultrasound and blood motion flow from contrast-enhanced 3D/4D ultrasound (CEUS) image data.

2. Related Art

Surgeons and cardiologists have limited tools for analyzing patient data and preoperative imagery, and rely primarily on experience and case studies when analyzing this data to select a course of action.

What are needed, therefore, are preoperative analysis planning tools to simulate post-surgical outcome.

### SUMMARY

Disclosed herein are methods and systems to analyze and predict patient-specific physiological behavior of a human organ or anatomical entity such as the heart complex and the heart subcomponents from 3-dimensional volumetric ultrasound (3D) or time-sequential volumetric (4D) ultrasound image data, to assist physicians in performing diagnostics and cardiac preoperative planning.

Also disclosed herein are methods and systems to segment patient-specific anatomical features from 3D/4D ultrasound.

Also disclosed herein are methods and systems to compute patient-specific tissue motion and blood flow from 3D/4D ultrasound and contrast-enhanced 3D/4D ultrasound image data.

Also disclosed herein are methods and systems to simulate the patient-specific mechanical behavior of the organ and anatomical entity using both 3D/4D ultrasound and mechanical models.

Also disclosed herein are methods and systems to estimate tissue stress and strain and physiological parameters of the tissues from 3D/4D ultrasound.

### BRIEF DESCRIPTION OF THE DRAWINGS

FIG. 1-1a is an ultrasound image slice taken during diastole of an open valve.

FIG. 1-1b is the image of FIG. 1-1a following segmentation with k-means clustering.

FIG. 1-1c is a distance map to provide intensity correction for signal fall-off further away from an ultrasound probe.

FIG. 1-1d is the image of FIG. 1-1a, following segmentation with, signal fall-off compensation (intensity remapping), k-means clustering, and thin-tissue detection.

FIG. 1-1e is an image 1-140 of image 1-100, where less-strict boundaries are used for the k-means and thin-tissue detection results.

FIG. 1-2a is a 3D TEE cube image 1-200 of the mitral valve, viewed from the atrium to show the mitral valve and the aortic valve.

FIG. 1-2b is a side-view 1-210 of 3D TEE cube image 1-200 to show the anterior leaflet and the aortic valve.

FIG. 1-3 is a set of segmentation images, including segmentation images of an intra-atrial cavity (upper row images), and segmentation images of an intra-ventricular cavity (lower row of images).

FIG. 1-4a is an image of coronal ground-truth.

FIG. 1-4b is another image of coronal ground-truth.

FIG. 1-4c is an image of coronal level set segmentation.

FIG. 1-4d is an image of sagittal ground-truth.

FIGS. 1-5a is an ultrasound image.

FIG. 1-5b is another ultrasound image to contrast with that of FIG. 1-5a.

FIG. 1-6a includes receiver operating characteristic (ROC) curves for open-valve atrium segmentation, including a mean curve, a median curve, a minimum curve 1-606, and a maximum curve.

FIG. 1-6b includes ROC curves for closed-valve atrium segmentation, including a mean curve, a median curve, a minimum curve, and a maximum curve.

FIG. 1-6c includes ROC curves for open-valve ventricle segmentation, including a mean curve, a median curve, a minimum curve, and a maximum curve.

FIG. 1-6d includes ROC curves for closed-valve ventricle segmentation, including a mean curve, a median curve, a minimum curve, and a maximum curve.

FIG. 1-6e includes ROC curves for open-valve left heart segmentation, including a mean curve, a median curve, a minimum curve, and a maximum curve.

FIG. 1-6f includes ROC curves for closed-valve left heart segmentation, including a mean curve, a median curve, a minimum curve, and a maximum curve.

FIG. 2-1 is a rendered 3D ultrasound image obtained with a 4D TEE probe, including a mitral valve, intra-atrial cavity, sections of the intraventricular cavity, and aortic valve.

FIG. 2-2 is a graph of 3D flow vectors, computed using a variational technique disclosed herein, on ultrasound data that have been synthetically laterally rotated by 6 degrees.

FIG. 2-3 is another graph of 3D flow vectors, computed using the variational technique on ultrasound data that have been synthetically laterally deformed by 6 percent.

FIG. 2-4 is an image of a phantom apparatus, including a 4D abdominal probe held in place to contact a multi-purpose tissue-equivalent ultrasound phantom.

FIG. 2-5 is an image of a frame pair, including two overlaid long-axis slices, showing 6 mm translation phantom movement.

FIG. 2-6a is a graph of 3D flow vectors for a pair of phantom images containing a translation of 6 mm, computed based on a correlation technique disclosed herein.

FIG. 2-6b is another graph of 3D flow vectors for a pair of phantom images containing a translation of 6 mm, computed based on the variational technique disclosed herein.

FIG. 3-1 is a flowchart of a method of modeling mitral valve closure.

FIG. 3-2 includes an anterior σ_{bb} plot and a posterior σ_{bb} plot.

FIG. 3-3 includes an anterior σₐₐ plot, an anterior σ_{bb} plot, a posterior σₐₐ plot, and a posterior σ_{bb} plot.

FIG. 3-4 includes an anterior σₐₐ plot, an anterior σ_{bb} plot, a posterior σₐₐ plot, and a posterior σ_{bb} plot.

FIG. 3-5 includes an anterior σₐₐ plot, an anterior σ_{bb} plot, a posterior σₐₐ plot, and a posterior σ_{bb} plot.

FIG. 3-6a is an image of 3D thin tissue segmentation detection of MV leaflets with respect to a long axis/four chambers view.

FIG. 3-6b is an image of 3D thin tissue segmentation detection of MV leaflets with respect to a long axis/two chambers view.

FIG. 3-7a illustrates automated (i.e., machine-generated) close mitral valve segmentation results.

FIG. 3-7b illustrates close valve segmentation results after manual semi-automated segmentation.

FIG. 3-7c illustrates open valve automated segmentation results 3-706.

FIG. 3-7d illustrates open valve segmentation results 3-708 after semi-automated segmentation.

FIG. 3-8a illustrates an initial open valve configuration from TEE segmentation.

FIG. 3-8b illustrates a corresponding closed configuration predicted using mechanical modeling as disclosed herein.

FIG. 3-9 is an error map distribution for a case 1 of an experiment.

FIG. 3-10 includes plots of error versus tether scaling, for other cases of the experiment.

FIG. 3-11a illustrates a simulation for which a patient-specific MV model is modified to represent chordae rupture leading to prolapse of the anterior leaflet.

FIG. 3-11b illustrates a simulation for which the patient-specific MV model is modified to represent chordae rupture leading to prolapse of anterior leaflets.

FIG. 3-11c illustrates a simulation for which the patient-specific MV model is modified to represent chordae rupture leading to prolapse of posterior leaflets.

FIG. 3-11d illustrates a simulation for which the patient-specific MV model is modified to represent shortened chordae preventing correct coaptation of the leaflets, which may result from a surgical intervention that caused an excessive shortening of the chordae tendineae.

FIG. 4-1 illustrates stress-strain behavior for an anterior leaflet under equibiaxial deformation in which the membrane is deformed in directions parallel and perpendicular to the fiber direction equally.

FIG. 4-2 illustrates stress-strain behavior for the anterior leaflet under parallel strip-biaxial deformation in which the membrane is deformed parallel to the fiber direction while keeping the perpendicular deformation fixed at +15%.

FIG. 4-3 is an illustration of a simulated closed-state mesh, with circumferential Almansi strain for each facet overlaid on the mesh.

FIG. 4-4 is an illustration of the simulated closed-state mesh of FIG. 4-3, with circumferential Cauchy stress for each facet overlaid on the mesh.

FIG. 4-5 is an illustration of the simulated closed-state mesh of FIG. 4-3, with radial Almansi strain for each facet overlaid on the mesh.

FIG. 4-6 is an illustration of the simulated closed-state mesh of FIG. 4-3, with radial Cauchy stress for each facet overlaid on the mesh.

FIG. 4-7 illustrates a simulated final closed-state of another mesh.

FIG. 4-8a is a box plot 4-802 depicting circumferential Almansi strain for the anterior leaflets across all experiments tested, as well as for each set of parameters.

FIG. 4-8a is a box plot depicting circumferential Almansi strain for the posterior leaflets across multiple experiments tested, as well as for each set of parameters.

FIG. 4-9a is a box plot depicting circumferential Cauchy stress for the anterior leaflets across the multiple experiments tested, as well as for each set of parameters.

FIG. 4-9b is a box plot depicting circumferential Cauchy stress for the posterior leaflets across the multiple tested, as well as for each set of parameters.

FIG. 4-10a is a box plot depicting radial Almansi strain for the anterior leaflets across the multiple experiments tested, as well as for each set of parameters.

FIG. 4-10b is a box plot depicting radial Almansi strain for the posterior leaflets the multiple experiments tested, as well as for each set of parameters.

FIG. 4-11a is a box plot depicting radial Cauchy stress for the anterior leaflets across the multiple experiments tested, as well as for each set of parameters.

FIG. 4-11b is a box plot depicting radial Cauchy stress for the posterior leaflets across the multiple experiments tested, as well as for each set of parameters.

FIG. 4-12a is a box plot depicting shear Almansi strain for the anterior leaflets across the multiple experiments tested, as well as for each set of parameters.

FIG. 4-12b is a box plot depicting shear Almansi strain for the anterior leaflets across the multiple experiments tested, as well as for each set of parameters.

FIG. 4-13a is a box plot depicting shear Cauchy stress for the anterior leaflets across the multiple experiments tested, as well as for each set of parameters.

FIG. 4-13b is a box plot depicting shear Cauchy stress for the posterior leaflets across the multiple experiments tested, as well as for each set of parameters.

FIG. 4-14a is a box plot depicting percent leaflet area change across the multiple experiments.

FIG. 4-14b is a box plot depicting mesh-to-mesh error in mm across the multiple experiments for each set of parameters.

FIG. 4-15 is an illustration of a reference feature and a deformed version of the reference feature.

FIG. 5-1 is an image of a frame of a sequence of transthoracic CEUS images taken during systole, showing contrast enhanced blood (light areas) in the center of frame 5-100 and surrounding myocardium (darker areas).

FIG. 5-2 is an image of another frame of the sequence of transthoracic CEUS images taken during diastole.

FIG. 5-3 is an image of computed flow at early systole stage.

FIG. 5-4 is an image of computed flow at mid systole stage.

FIG. 5-5 is an image of computed flow at early diastole stage.

FIG. 5-6 is an image of computed flow at mid diastole stage.

FIG. 6-1 is a block diagram of a computer system configured to process ultrasound data such as 3DTEE as described herein.

FIG. 6-2 is a block diagram of a processor and storage of FIG. 6-1.

In the drawings, the leftmost digit(s) of a reference number identifies the drawing in which the reference number first appears.

### DETAILED DESCRIPTION

### Contents

### I. Patient-Specific Segmentation of 3D Ultrasound Image Data

### A. 3D Level Sets

1. Evolving 3D Dynamic Surfaces

2. Inhibition Function

### B. Experiments and Evaluation

### C. Derivation of the Evolution Function

### II. Patient-Specific Computation of 3D Tissue Motion/Displacement

### A. Variational 3D Optical Flow Techniques

### B. Experiments

1. Intraoperative Data

2. Intraoperative Data with Synthetic Motion

3. Phantom Data

### III. Patient-Specific Modeling of Anatomical Feature Motion

### A. Modeling of Mitral Valve Closure

1. Segmentation

2. Lagrangian Modeling of the Mitral Valve System

3. Blood Loading Energy

4. Strain Energy

5. Tethering Energy

6. Collision Energy

7. Optimization

8. Annulus Deformation

9. Chordal Length Estimation

### B. Validation Framework Modeling

### IV. Patient-Specific Modeling of Tissue Stress/Strain

### A. Segmentation and Mesh Construction

### B. Force Modeling

1. Hyperelastic Modeling

### C. Experiments

### D. Equation Derivations

1. Energy Density and Force Functions

2. St. Venant-Kerchoff Model

3. May-Newman-Yin (MNY) Model

4. Holzapfel Model

### V. Patient-Specific Blood Flow Motion Estimation

### A. Contrast Enhanced Ultrasound

### B. Blood Motion Flow Estimation

### A. Experiments

### VI. Example Implementations

Methods and systems are described below with respect to the mitral valve and with respect to 3D and 4D transesophageal echocardiography (3D-TEE) image data, for illustrative purposes. Methods and systems disclosed herein are not, however, limited to transesophageal echocardiography, echocardiography, or the mitral valve.

P. Burlina et al., “Patient-specific Modeling and Analysis of the Mitral Valve Using 3D-TEE,” Information Processing in Computer-Assisted Interventions, pp. 135-146, 2010, in incorporated herein by reference in its entirety.

Publications identified further above are also incorporated herein by reference in their entireties.

### I. Patient-Specific Segmentation of 3D Ultrasound Image Data

Disclosed below are methods and systems to segment volumetric (3-dimensional or 3D) ultrasound (US) images or image data, such as to distinguish between tissue (e.g., tissue walls or surfaces), and blood and/or other anatomical features. Segmentation, as disclosed herein, may be implemented as a partially or fully-automated or machine-implemented process.

Automated or semi-automated segmentation of biological features such as the endocardial wall may be used for one or more of a variety of purposes including, without limitation, characterization pathophysiology of cardiovascular disease, input to a biomechanical model, pre-operative planning, and/or beating heart surgical systems.

Endocardial wall segmentation has a variety of applications in cardiology and cardiothoracic surgery. Automated segmentation can inform diagnostics, computer-aided minimally-invasive interventions, and pre-operative surgical planning and modeling.

An example is mitral valve disease (MVD). Surgical interventions for MVD are challenging and treatment may involve one or more options, including insertion of an annuloplasty ring, reshaping of mitral valve leaflets, or the re-composition of mitral valve chordae tendineae. Pre-operative evaluation of these options can be accomplished by simulating their likely outcomes. Recent studies performing biomechanical simulations of the heart have exploited patient-specific anatomy (Votta et al., 2008; Burlina et al., 2010; Hammer et al., 2011).

Segmentation of the endocardial walls provides boundary conditions which may be used as input to personalized modeling techniques to generate or train patient-specific models.

Endocardial wall segmentation is also useful for diagnosing cardiovascular diseases, such as for computation of end-systolic, end-diastolic, and stroke volumes, as well as left ventricular ejection fraction (LVEF), (Cohn et al., 1993), all of which are important measures that doctors use to assess patients.

An example is hypertrophic cardiomyopathy (HCM), an inherited condition characterized by an enlarged myocardial muscle (Maron, 2002; Afonso et al., 2008; Burlina et al., 2011), which are incorporated herein by reference in their entireties. HCM limits an individual's ability to perform routine activities and can often lead to heart failure. Automated delineation of endocardial walls can help a clinician determine the severity of HCM, as it can provide information on the blood pool volume.

A condition caused by hypertrophy is a narrowing in the outflow of the left ventricle during ejection at systole, called “outflow tract obstruction.” This is created by a movement of the mitral valve leaflets that are pulled towards the septum during left ventricle contraction. During this pulling, the blood flow narrows and there is an increase in velocity, a phenomenon very well explained by Bernoulli's equation.

Automated endocardial delineation may be used in place of, or in addition to contrast enhanced ultrasound (CEUS), which is currently used to characterize this narrowing. Automated endocardial delineation may also be used in scientific investigations into mechanisms underpinning HCM, such as outflow tract obstruction and diastolic dysfunction, which are poorly understood and not consistently observed across HCM patients. Techniques disclosed herein may also be used to delineate the full myocardium, which may be useful in characterization of tissue enlargement.

High temporal resolution is an important capability in HCM and MVD. 3D TEE is a cardiac imaging modality that has recently gained increased importance in pre-operative and intra-operative settings, in part due to its relatively fast speed or high image capture frequency. 3D TEE may permit acquisition of 3D time-varying image sequences at rates up to, and sometimes exceeding 90 Hz, which is well above that of other modalities such as CT and MRI. A 3D TEE system generally has a smaller overall size and more moderate cost relative to CT and MRI. 3D TEE is also safer because it does not rely on ionizing radiation.

3D TEE may provide acceptable contrast for features near an US wand, such as the left atrium and mitral valve areas, but may provide reduced-contract for features further from the US wand, such as the basal and apical areas of the left ventricle. Conventional segmentation may be complicated by degraded contrast.

Conventional segmentation may be complicated by imaging artifacts, which may include or result from noise, shadowing, and/or reverberation.

3D TEE image quality may depend in part upon the skill of the ultra-sonographer, which may complicate conventional segmentation techniques.

Acquisition of high frequency 3D TEE images over time may result in a relatively large dataset, especially where 3D TEE images are acquired over repeated cycles of an event, such several heart cycles. Such a large data set(s) cannot be practically segmented by a human in a reasonable amount of time.

High frequency 3D image capture is useful in observing rapid motions that occur in left heart anatomical components such as mitral and aortic valves. High frequency 3D image capture may also be useful to image anatomical features at particular instants, such as to image anatomical features of the heart at various times or instants of the cardiac cycle. This may include segmentation of static 3D TEE cubes.

Techniques disclosed below extend the level set formulation to 3D US image data, including 3D TEE image data, with a growth inhibition function. The growth inhibition function may include one or more functions or components to address specific challenges of an anatomical feature, an imaging device, and/or the LSM.

For example, with 3D TEE-based left endocardial wall segmentation, the level set has tendency to march over finer structures, such as the mitral valve leaflets. Noise and contrast issues may exacerbate this behavior. The growth inhibition function may include one or more components to help preserve such structures. The inhibition function may include, for example, a combination of a k-means term and an edge indicator function to handle the endocardial boundaries. The inhibition function may further include an adjunct factor in the form of a structure tensor-based thin tissue detector dedicated to the mitral valve leaflets.

A. 3D Level Sets

Described below are methods and systems to segment based on an expanding 3D dynamic surface approach implemented as a level set method.

Described further below is an inhibition function to halt expansion of the dynamic surface at a tissue boundary, such as the endocardial wall and mitral valve boundaries.

The level set method (LSM) is a numerical technique for tracking interfaces and shapes. With the LSM, an evolving contour is represented with a signed function, where its zero level corresponds to the actual contour. A similar flow for an implicit surface may then be derived with a motion equation of the contour such that, when applied to the zero-level, will reflect the propagation of the contour.

The LSM permits numerical computations involving objects such as curves and surfaces to be performed on a fixed Cartesian grid without having to parameterize the objects. The LSM is useful for examining shapes that change topology, for example when a shape splits in two, develops holes, or the reverse of these operations. The LSM is thus useful for modeling time-varying objects. The level set method is implicit and parameter-free, provides a direct way to estimate geometric properties of an evolving structure, can change the topology, and is intrinsic.

1. Evolving 3D Dynamic Surfaces

The dynamic surface exploits a 3D level set approach and works as follows: at time t=0, a dynamic surface is initialized in the atrial and/or intra-ventricular cavities. The dynamic surface is then obtained at any subsequent time t by considering an evolving function □(x, y, z, t). The dynamic surface may be determined as S(t), the zero level set of □(•). In other words, S(t)={(x, y, z)|□(x, y, z, t)=0}.

□(•) evolves under a driving force designed to expand the surface until it reaches the intensity boundaries marking the inner walls of the atrial and ventricular cavities. An inhibition function g(•), described further below later, halts expansion of the dynamic surface at the wall boundaries. The time evolution equation may be expressed as:

$$\frac{\partial φ}{\partial t} = - \frac{δ E}{δφ} , \qquad EQ . ( 1 \text{-} 1 )$$

where the right hand side of EQ. (1-1) denotes the Gâteaux derivative.

The energy E(□) includes three terms and is defined as:

E(φ)=μP(φ)+λA_{g}(φ)+vV_{g}(φ), EQ. (1-2)

As in Li et al. (2005), evolution equation of □(•) includes a penalty term P(□) to evolve □ so that, at all times, □ closely approximates a signed distance function, which may be useful to determine the zero level set S(t).

The penalty may be expressed as:

$$P ( φ ) = {\int }_{Ω} \frac{1}{2} {( \vert ∇ φ \vert - 1 )}^{2} d x d y d z , \qquad EQ . ( 1 \text{-} 3 )$$

where ∇□ is the gradient of □ and Ω⊂R³ is the domain of □.

Terms A_{g}(□) and V_{g}(□) in EQ. (1-2) correspond to the surface area and volume, respectively, which drive the surface's evolution to the desired goals, with balancing weights λ and v. The primary role of terms A_{g}(□) and V_{g}(□) is to expand or contract the dynamic surface by expanding or contracting its enclosed volume V_{g}(□), while keeping this surface simple, which is done by penalizing the surface area A_{g}(□).

A_{g}(□) and V_{g}(□) may be expressed as:

A_{g}(φ)=∫_{Ω}gδ(φ)|∇φ|dxdydz EQ. (1-4)

V_{g}(φ)=∫_{Ω}gH(−φ)dxdydz, EQ. (1-5)

where δ(□) denotes the Dirac delta function, and H(□) is the Heaviside function. Weight v is chosen here to be negative so that the surface expands.

If the level set is unrestricted, it would produce a sphere (solving the maximum volume/minimum surface area problem), which would continue to grow and expand. To halt the expansion and make the surface adhere to the endocardial walls, the terms in EQS. (1-4) and (1-5) contain an inhibition function g(•) to abate the motion of the dynamic surface in places corresponding to the myocardium and mitral valve leaflets boundaries. The inhibition function is discussed further below.

Regrouping terms from EQS. (1-2), (1-4), and (1-5) into EQ. (1-1), and using the Gâteaux derivative, it can be shown that the evolution of □ may be expressed as:

$$\frac{\partial φ}{\partial t} = μ [ Δφ - ∇ \cdot ( \frac{∇ φ}{\vert ∇ φ \vert} ) ] + λδ ( φ ) ∇ \cdot ( g \frac{∇ φ}{\vert ∇ φ \vert} ) + vg δ ( φ ) , \qquad EQ . ( 1 \text{-} 6 )$$

where ∇• denotes the divergence and Δ the Laplacian operators.

EQ. (1-6) specifies a time-update evolution equation for ∂□/∂t which corresponds to a form of steepest descent. EQ. (1-6) is discretized to evolve the function □ so as to minimize the objective functional E(□). Derivation of EQ. (1-6) is provided further below.

2. Inhibition Function

The inhibition function g(•) is designed to address features and challenges associated with the imaging of the left heart complex using a TEE probe, as discussed further above. The inhibition function may include one or more of a k-means clustering component, a structure tensor-based thin tissue detector component, and a TEE intensity gradient component.

a). Intensity Gradient

Information on the heart wall and anatomical structures may be obtained via intensity gradient magnitude and edge information. Unlike other techniques, such as transthoracic echocardiography, TEE provides an obstruction-free and high-contrast image of the upper left heart, including the left atrium, mitral valve, annulus, and leaflets. Because of this, it has been determined that using gradient information is appropriate in TEE and useful in inhibiting the growth of level set curves in certain areas of an image.

This information is captured by the function ed(•), as in:

$$ed ( x , y , z ) = \frac{1}{1 + a {\vert ∇ G * I ( x , y , z ) \vert}^{2}} , \qquad EQ . ( 1 \text{-} 7 )$$

where ∇G*l is the gradient of the Gaussian-smoothed TEE intensity, and a is a sharpness weight that can modify the range of accepted intensity gradients. This function represents a ‘negative’ of the gradient magnitude map, taking small values for high gradient magnitudes, and values close to 1 for small gradient magnitudes.

b). K-Means Clustering

The use of gradient-based information in ed(•) might be an issue for the mid and apical regions of the left ventricle where signal attenuation and shadowing by upper structures such as the valve leaflets tend to limit contrast. Because of this, a second component in the inhibition function design includes k-means clustering, which provides a good outline of the endocardial and surrounding structure as the myocardium tends to appear as brighter while the endocardial cavity containing the blood pool appears as darker. The k-means clustering is obtained after low pass filtering and intensity remapping in an attempt to correct for signal drop-off at points further from the probe.

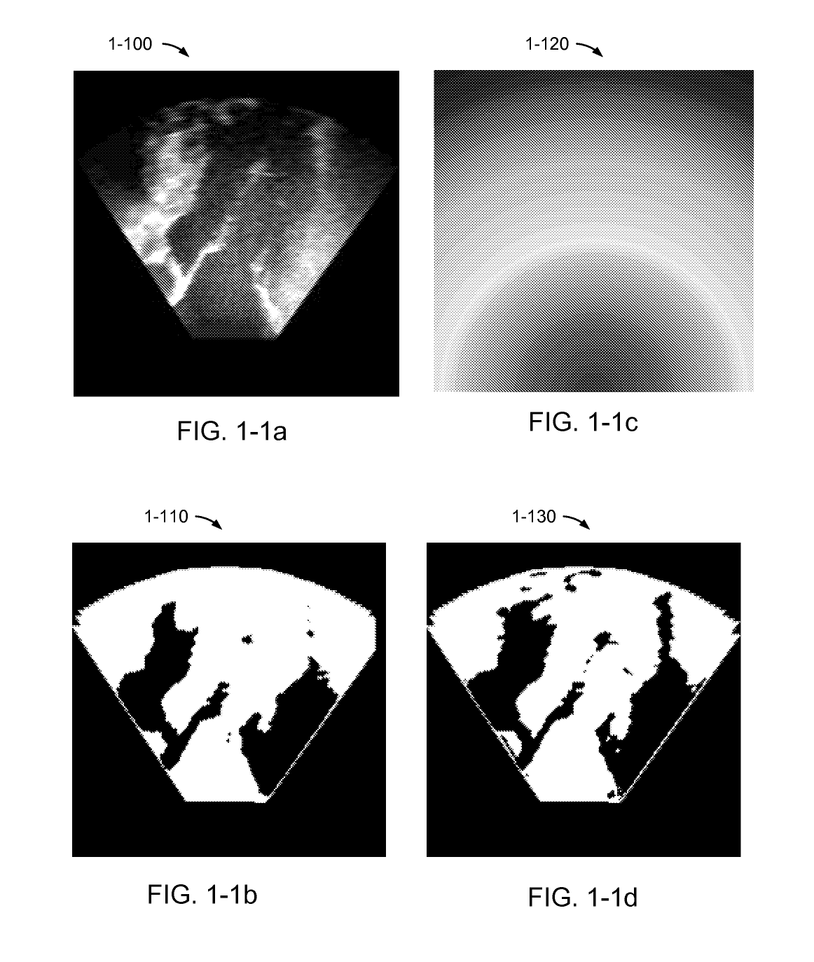

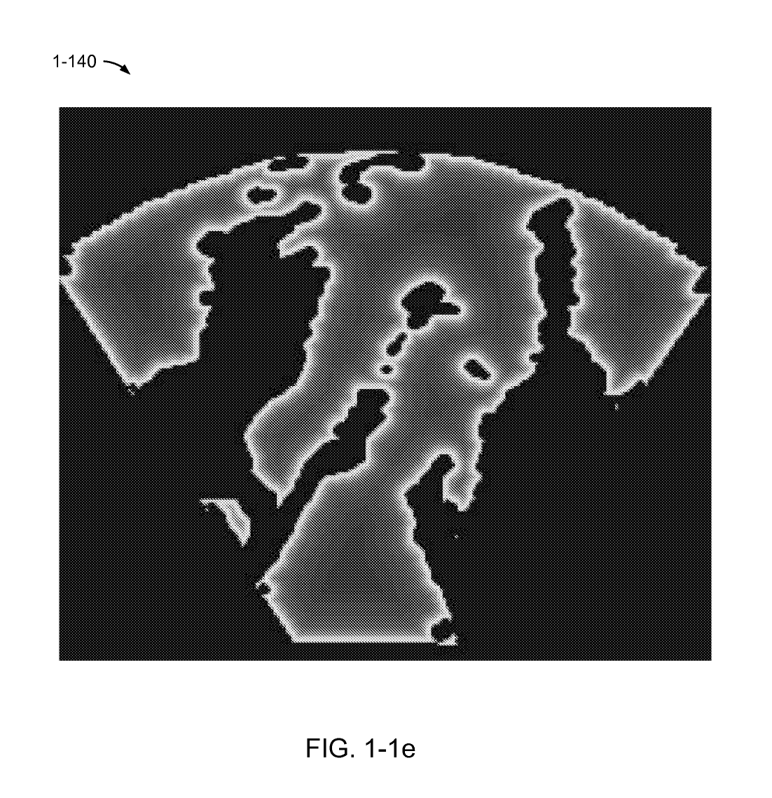

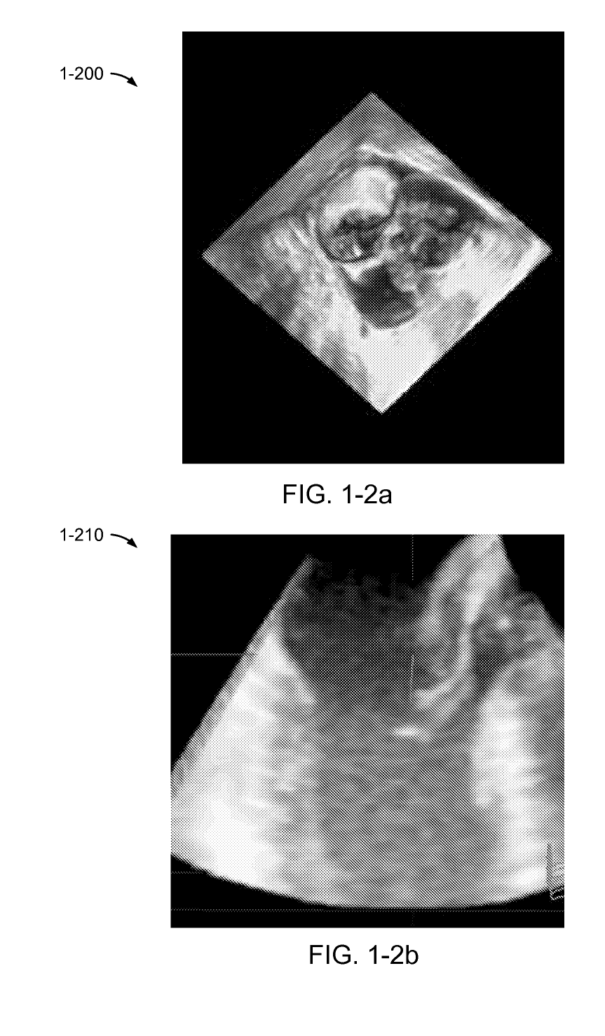

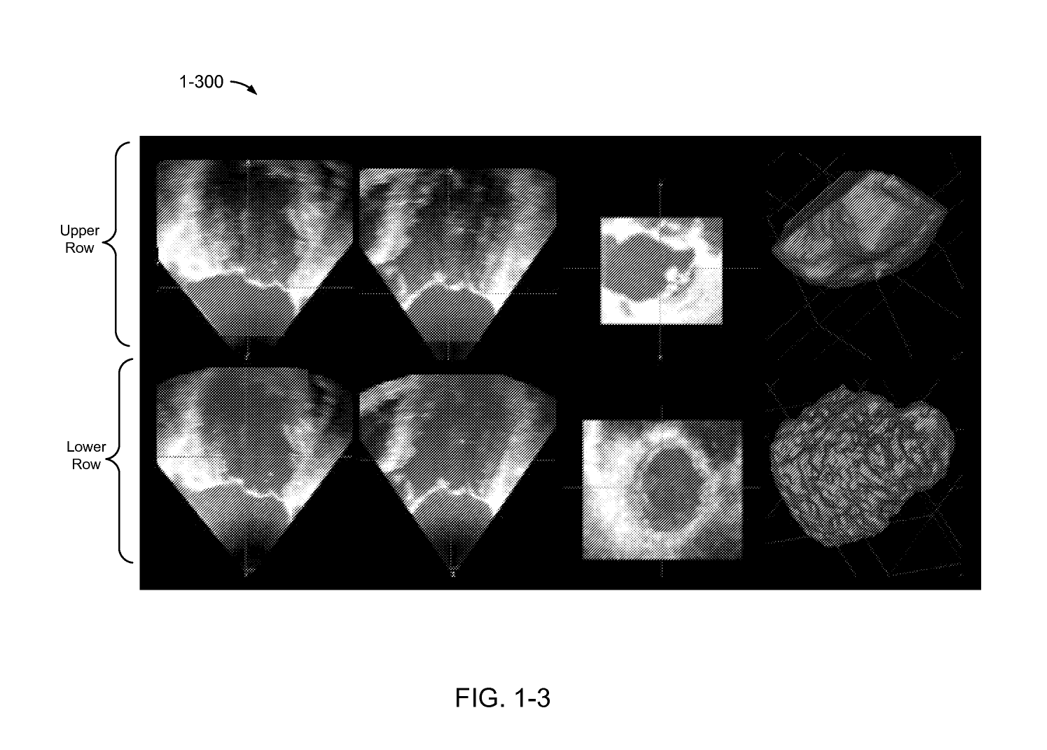

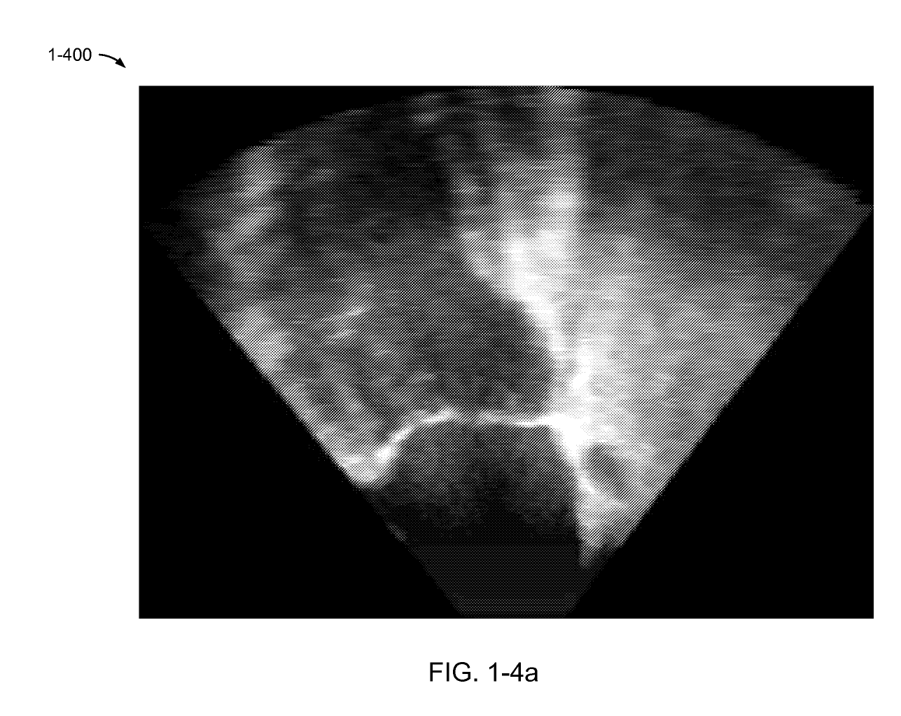

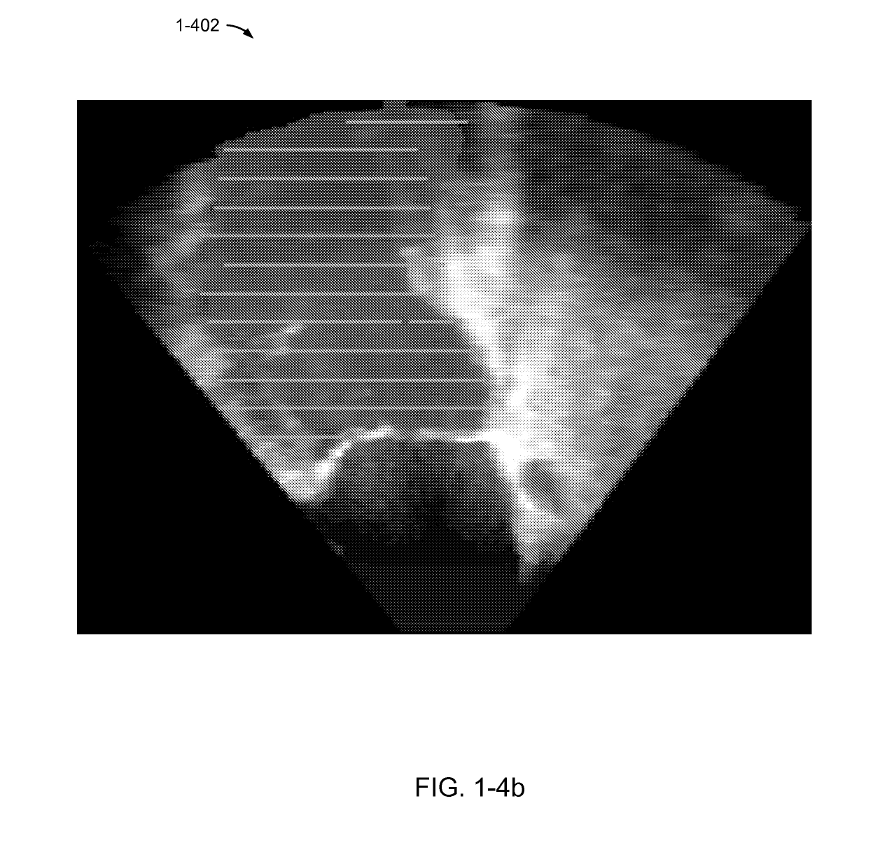

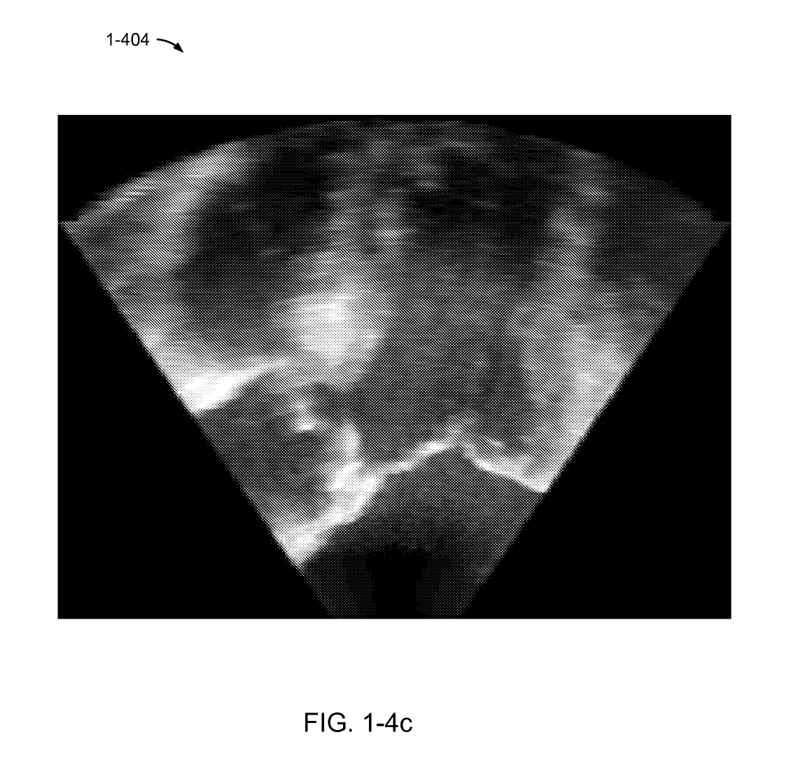

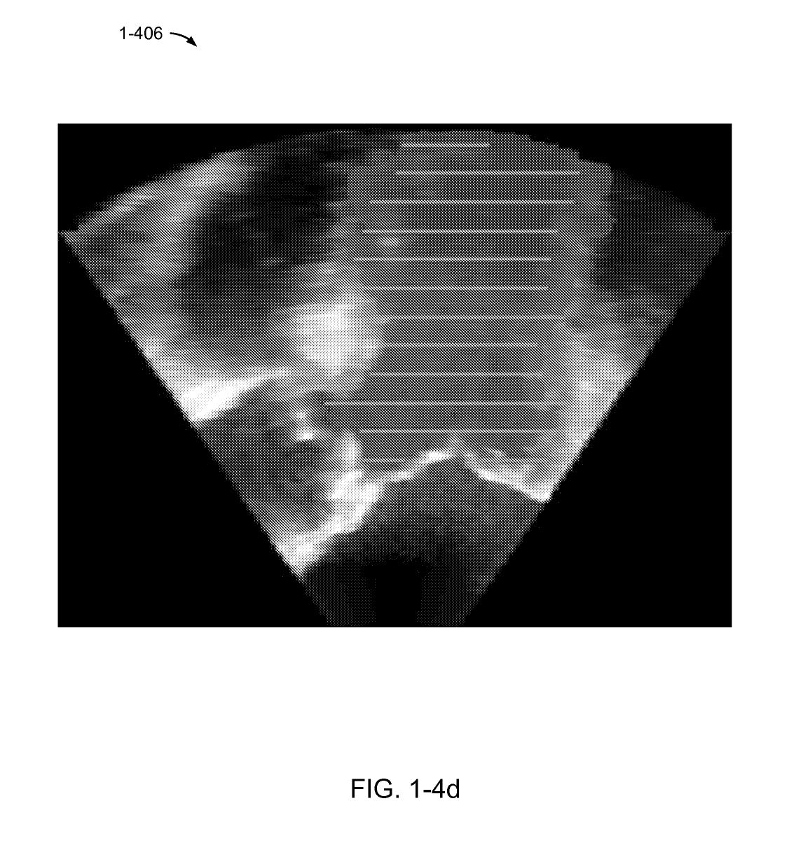

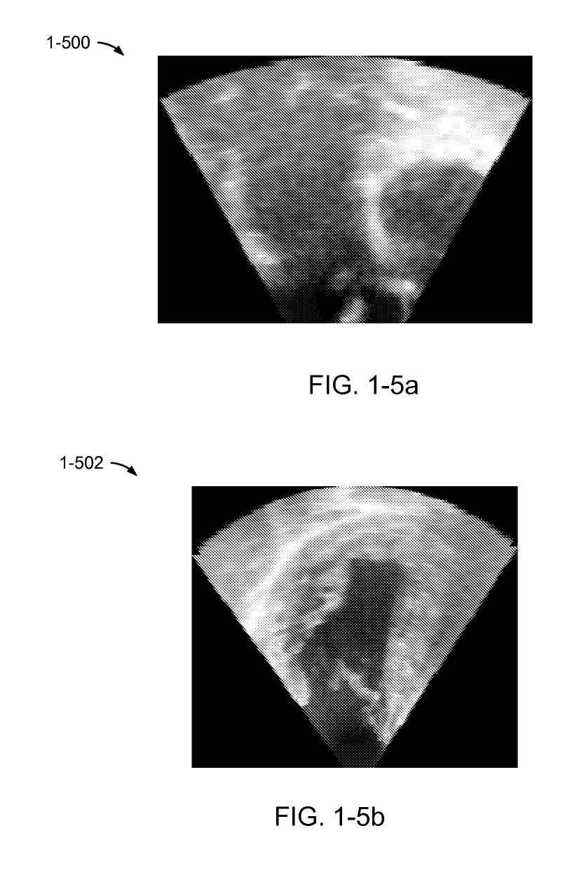

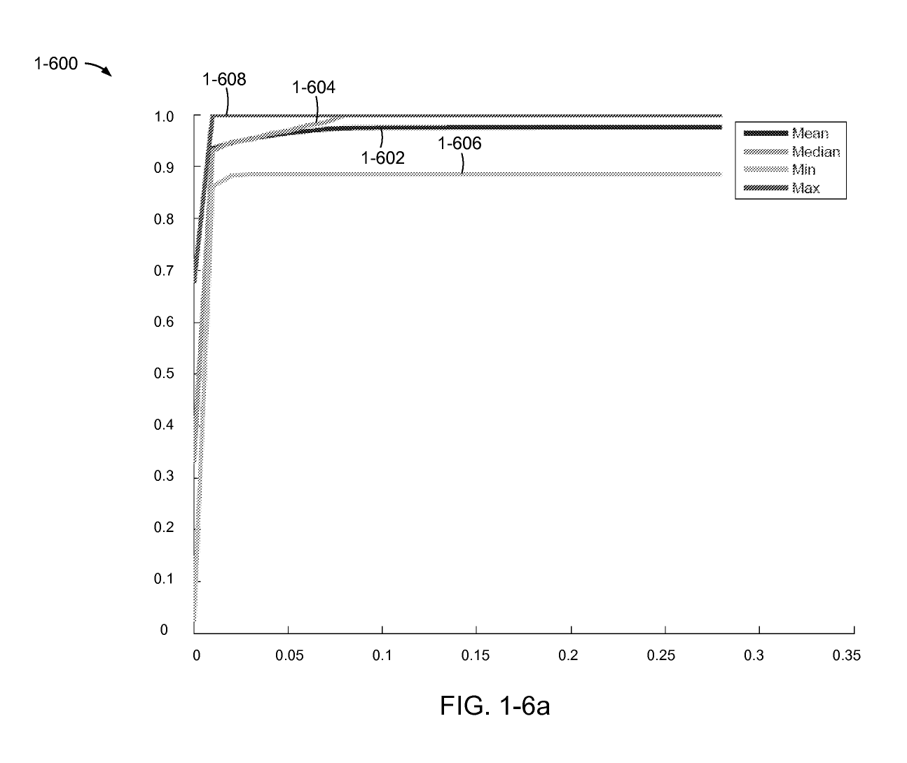

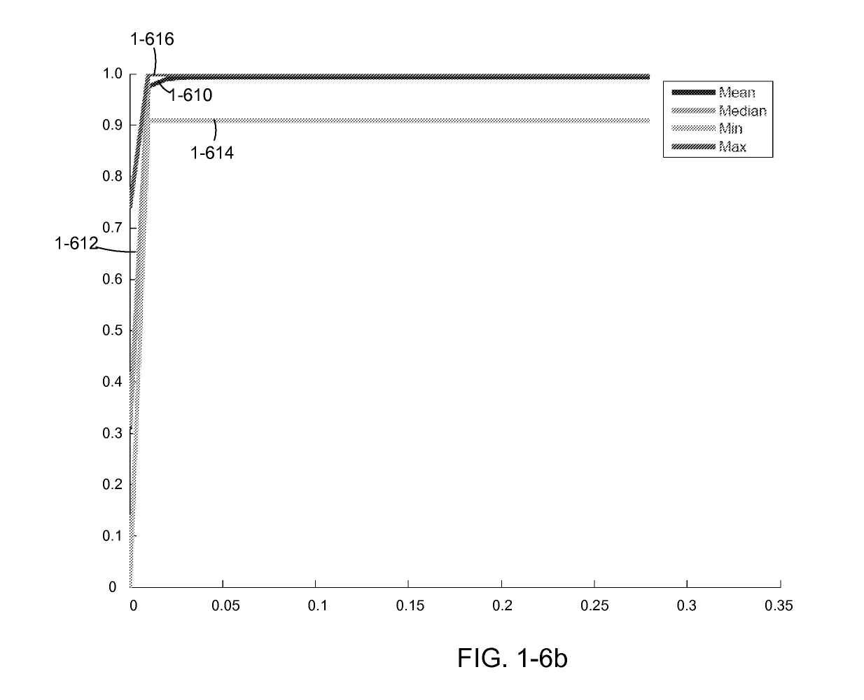

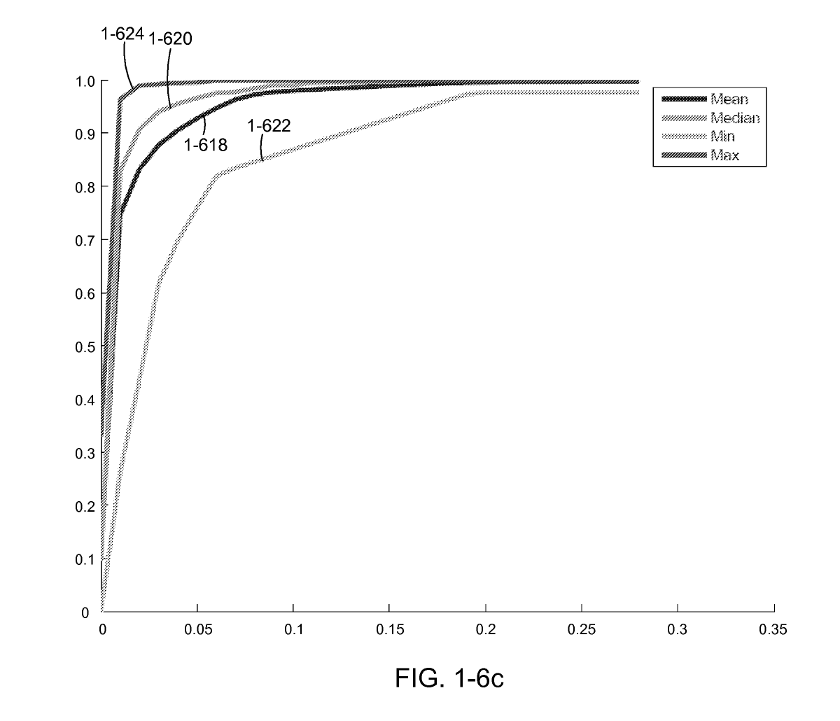

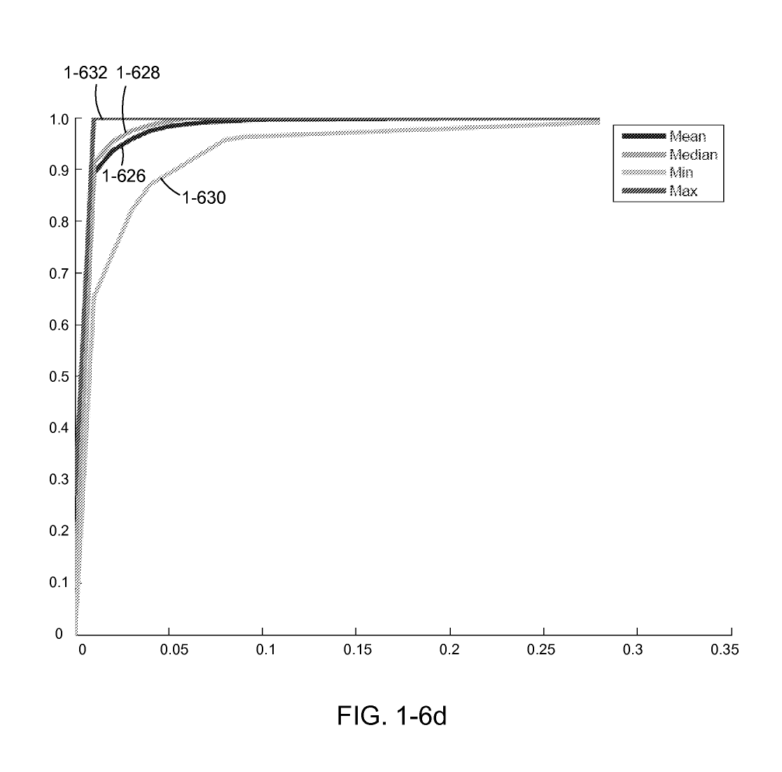

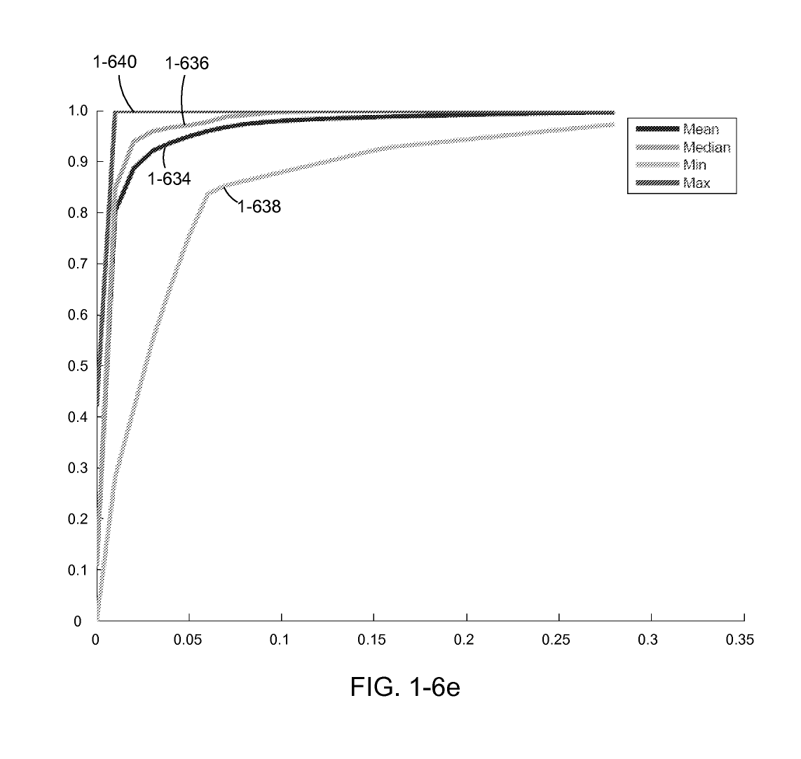

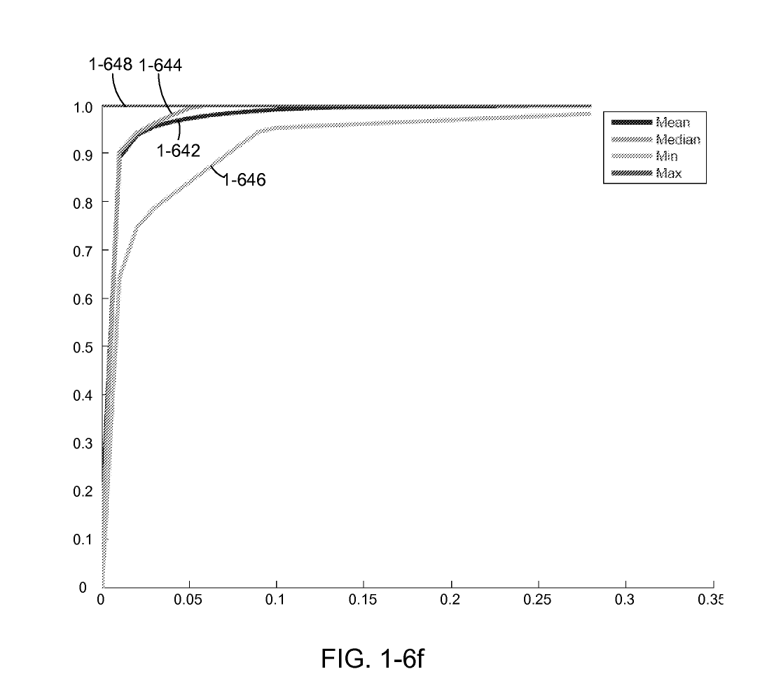

K-means clustering and remapping are described below with reference to FIGS. 1-1a through 1-1e.

FIG. 1-1a is an image slice 1-100 taken during diastole of an open valve. The origin of the TEE probe is at the bottom-center of image 1-100. The apex of the left-ventricle is located at the top-center of image 1-100. The transducer is focused on the mitral valve, resulting in a slight increase in intensity near the mitral valve in the middle of the image, before falling off approaching the apex of the ventricle.

FIG. 1-1b is an image 1-110 of image slice 1-100 following k-means segmentation, without intensity remapping. Note that the walls are missing near the apex of the ventricle.

FIGS. 1-1a and 1-1b demonstrate how k-means would perform without correction (note the drop in intensity approaching the apex of the ventricle, or top of the image, and the resulting poor segmentation performance by uncorrected k-means).

FIG. 1-1c is an example distance map 1-120 to correct for intensity and signal fall off further away from the TEE probe. The inner-most portion of map 1-120 indicates the lowest scaling values. The outer-most portion of map 1-120 indicates the highest scaling values.

The output of the k-means algorithm is denoted by the indicator function J_{KM}(x, y, z), equal to one where the k-means algorithm clustered the darker voxels (including the intra-ventricular and intra-atrial cavities), and zero otherwise (including the myocardial areas).

c). Thin Tissue Detector

The third term of the inhibition function exploits the structure tensor to detect the location of thin tissue, such as the mitral or aortic valve leaflets, whose detection may sometimes be problematic, causing the leaflets to be traversed by the dynamic curve when only using the two former methods for the inhibition function.

A structure tensor, also referred to as a second-moment matrix, is a matrix derived from the gradient of a function. The structure tensor summarizes the predominant directions of the gradient in a specified neighborhood of a point, and a degree to which those directions are coherent.

Denoting by (x, y, z) the coordinates of the voxel at position x, and f(x) the image intensity at that location, values of voxels surrounding a location x₀ may be approximated using a second-order Taylor series expansion as:

$$f ( x ) \approx f ( {x}_{0} ) + {( x - {x}_{0} )}^{T} ∇ {f}_{0} + \frac{1}{2} {( x - {x}_{0} )}^{T} {∇}^{2} {f}_{0} ( x - {x}_{0} ) , \qquad EQ . ( 1 \text{-} 8 )$$

where ∇f₀ and ∇²f₀ denote the gradient vector and the Hessian matrix at x₀, respectively.

The Hessian matrix is defined by:

$${∇}^{2} f = [ \begin{matrix}{f}_{xx} & {f}_{xy} & {f}_{xz} \\ {f}_{yx} & {f}_{yy} & {f}_{yz} \\ {f}_{zx} & {f}_{zy} & {f}_{zz}\end{matrix} ] . \qquad EQ . ( 1 \text{-} 9 )$$

From this approximation, the varying intensities surrounding X₀ is spanned by the eigenvectors of the Hessian matrix. The eigenvalues corresponding to these eigenvectors may be used to define a new space that is invariant under orthonormal transformations. Tissue classification may be performed in this space to detect thin planes in the new space.

In other words, thin planar structures may be identified from the eigenvalues of the Hessian. If one of the eigenvalues is negative with relatively large amplitude, and the other two eigenvalues have similar and small amplitude, this suggests the presence of a “light intensity sheet” or thin tissue structure.

Consider e₁(x), e₂(x), and e₃(x) be the eigenvectors of the Hessian matrix ∇²f where e₁(x) corresponds to the eigenvector with the largest eigenvalue λ₁(x), e₂(x) corresponds to the eigenvector with the next largest eigenvalue λ₂(x), and e₃(x) corresponds to the eigenvector with the smallest eigenvalue λ₃(x) (i.e. λ₁≧λ₂≧λ₃).

A measure of the planarity of the surrounding local structure can be defined by:

$${S}_{sheet} \{ f \} = \{ \begin{matrix}\vert {λ}_{3} \vert \cdot w ( {λ}_{2} , {λ}_{3} ) \cdot w ( {λ}_{1} , {λ}_{3} ) , & {λ}_{3} < 0 \\ 0 & otherwise ,\end{matrix} \qquad EQ . ( 1 \text{-} 10 )$$

where w(λₛ, λₜ) is defined by:

$$w ( {λ}_{s} , {λ}_{t} ) = \{ \begin{matrix}{( 1 + \frac{{λ}_{s}}{\vert {λ}_{t} \vert} )}^{γ} , & {λ}_{t} \leq {λ}_{s} < 0 \\ {( 1 - α \frac{{λ}_{s}}{\vert {λ}_{t} \vert} )}^{γ} , & \frac{\vert {λ}_{t} \vert}{α} > {λ}_{s} > 0 \\ 0 & otherwise .\end{matrix} \qquad EQ . ( 1 \text{-} 11 )$$

In EQS. (1-10) and (1-11), γ controls the sharpness of selectivity, and 0<α≦1. α controls the asymmetrical characteristic in the negative and positive regions of λₛ. For example, values of γ=0.5 and α=0.25 worked well in experiments. The inverse of the indicator function, denoting the leaflet position found by the structure tensor method, is denoted as Jₜ(x, y, z).

FIG. 1-1d is an image 1-130 of image 1-100, following k-means clustering and thin-tissue detection after intensity remapping. Note that small pieces of the heart wall are still missing near the apex of the ventricle.

d). Weighting of K-Means and Thin Tissue Components

To account for imperfections in the k-means clustering and thin tissue detection, and to prevent convergence towards the strict boundaries that these two methods return, these two components may be further weighted by the distance from their respective boundaries. In other words, we the k-means and thin tissue components may first be eroded to obtain the following:

J_{erode}(x,y,z)=(J_{KM}(x,y,z)·Jₗ(x,y,z))⊖K_{3×3×3}, EQ. (1-12)

where K_{3×3×3} represents either a ball or cube morphological kernel.

The distance is then computed in voxels, from each voxel to the nearest k-means or thin tissue boundary. The distances values are added back to the k-means and thin tissue components before multiplying by ed(•), to provide the following final equation:

$$g ( x , y , z ) = [ {J}_{erode} + \frac{1}{dist ( {J}_{erode} )} ] \cdot ed ( x , y , z ) , \qquad EQ . ( 1 \text{-} 13 )$$

where dist(•) represents the distance from each voxel to the nearest non-zero voxel, or zero if that voxel is non-zero itself.

FIG. 1-1e is an image 1-140 of image 1-100, where less-strict boundaries are used for the k-means and thin-tissue detection results.

B. Experiments and Evaluation

Real-time 3D TEE full-volume data sequences were acquired intra-operatively from patients of the Johns Hopkins University's School of Medicine. Data sequences were collected under a protocol approved by the JHU Institutional Review Board, and each patient provided informed consent.

Some of the patients underwent coronary artery bypass grafting (CABG), other patients underwent interventions for valvular dysfunction, and at least one patient was symptomatic with regard to MVD and exhibited a vegetation or tumor on the mitral valve.

TEE acquisition was performed using an iE33 Philips console fitted with an X7-2t probe, from Philips Medical Systems, of Bothell, Wash.

The 4D TEE probe was run at frequencies ranging from 3 to 5 MHz. The iE33 platform and software used did not allow the operator to set a specific frequency, and did not store the specific frequency used anywhere in the data files. Frequency was set by adjusting the “2D Opt” control to penetration, general, or resolution. The spatial resolutions ranged from approximately 0.4 to 0.8 mm.

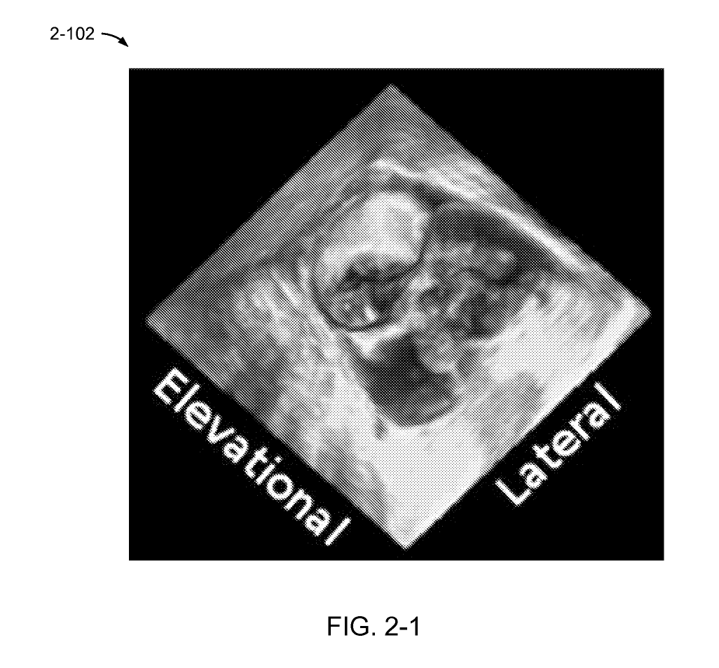

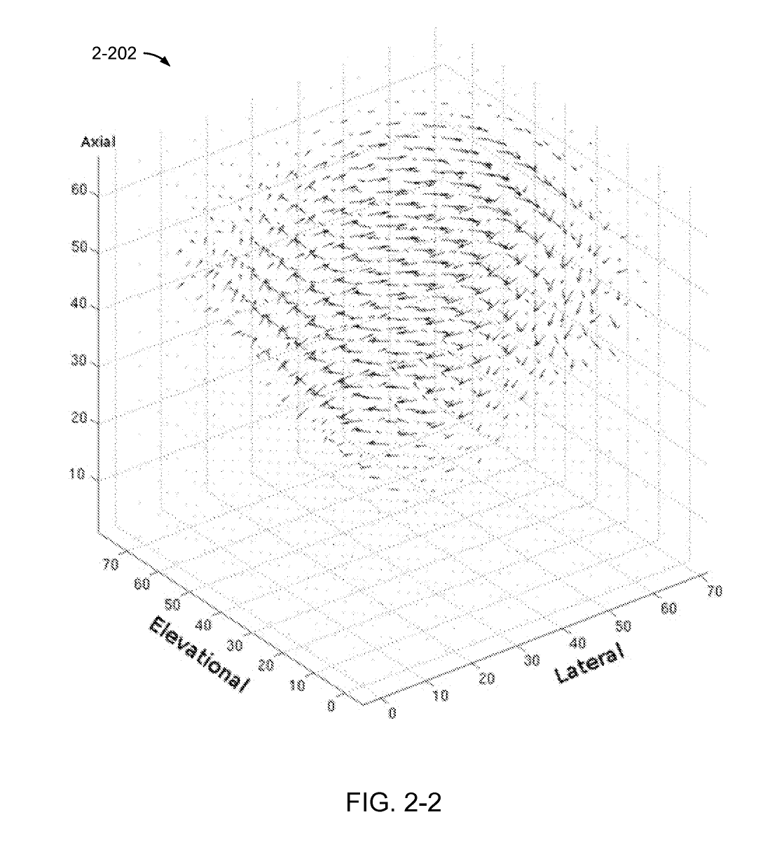

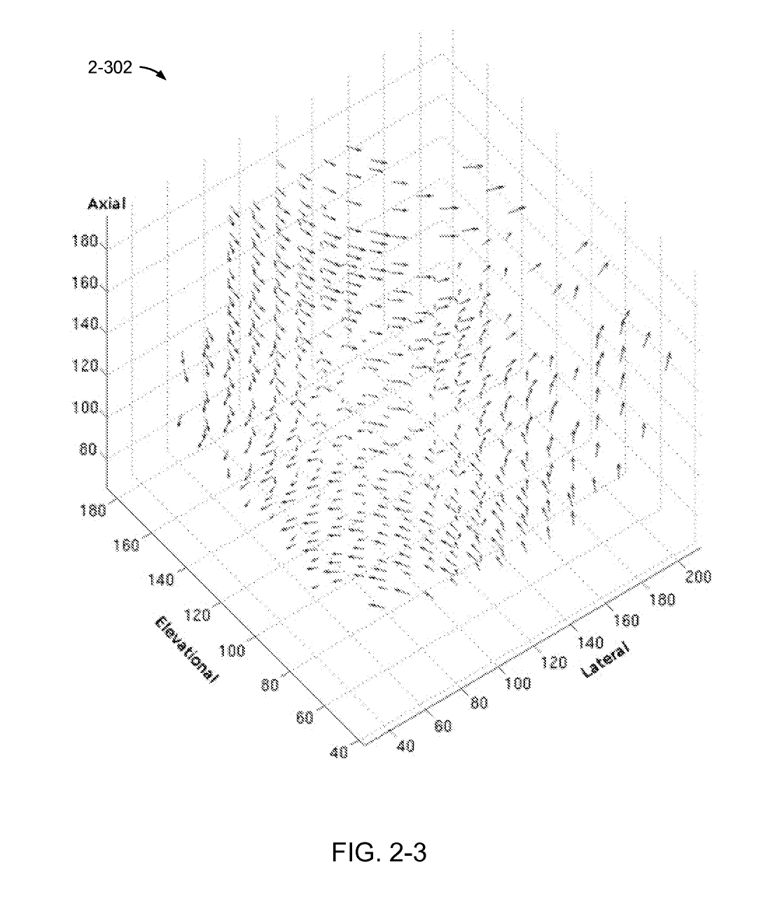

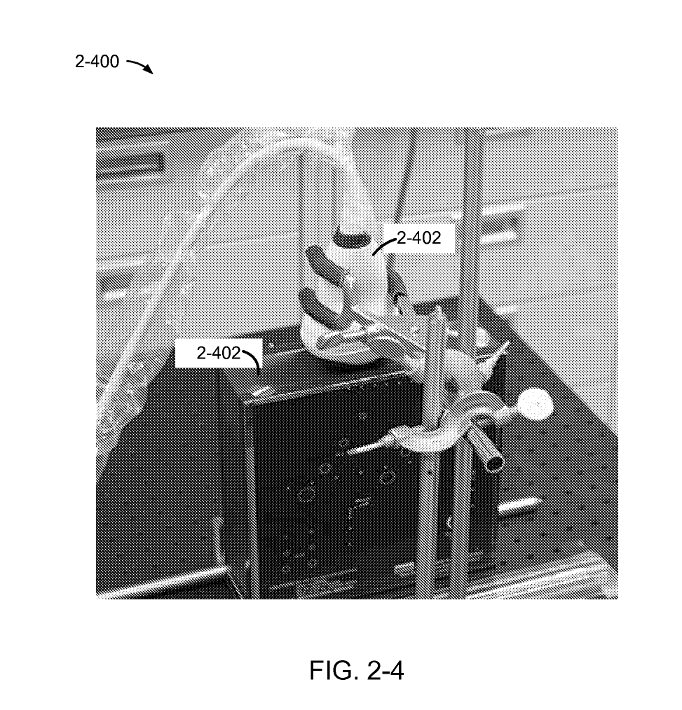

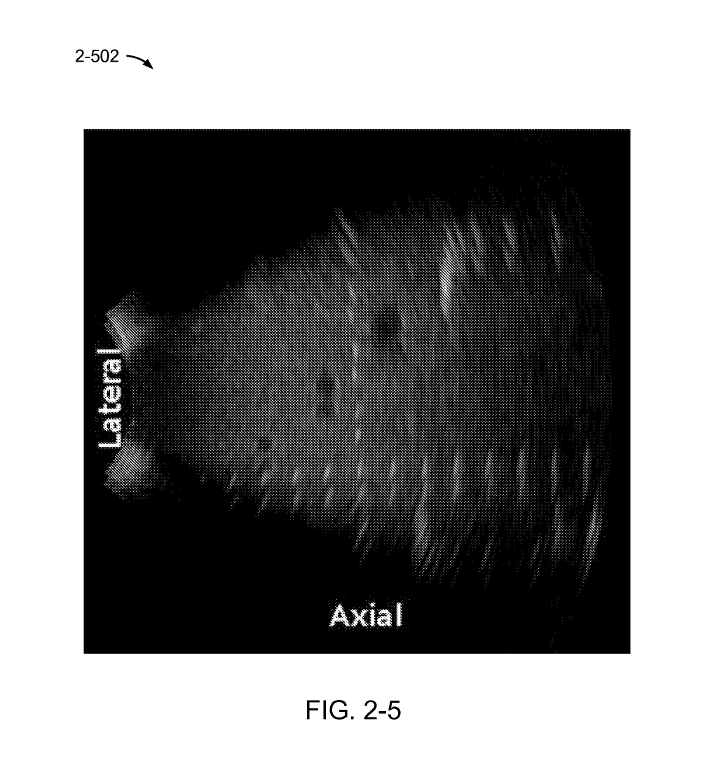

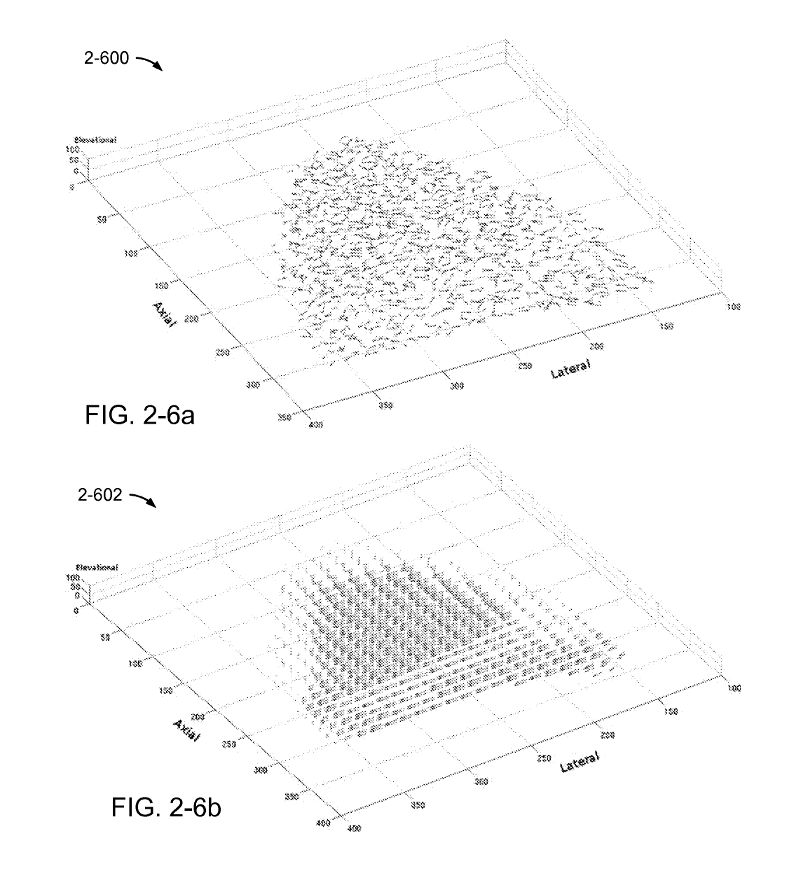

Data was collected intra-operatively using a seven breath-hold protocol, resulting in frame rates from 24 to 56 Hz. The TEE cube sizes were 224×208×208 voxels, measured along the 3D US canonical elevational, lateral (lateral-elevational plane corresponding to the x-y plane parallel to the plane containing the echo-graphic transducers), and axial (along the acoustic path and corresponding to the z-axis) directions. The lateral-elevational plane, which is parallel to the planar array of transducer elements, corresponds to the x-y plane, as illustrated in FIG. 2-1.

3D TEE cubes of the mitral valve are presented in FIGS. 1-2a and 1-2b.

FIG. 1-2a is a 3D TEE cube image 1-200 of the mitral valve, viewed from the atrium to show the mitral valve and the aortic valve.

FIG. 1-2b is a side-view 1-210 of 3D TEE cube image 1-200 to show the anterior leaflet and the aortic valve.

The imagery was collected with the iE33 machine in “Full Volume” mode, an acquisition method where the workstation's spatial and temporal resolution is enhanced by stitching together multiple image sequences of different sectors of the heart. Each sector is acquired over a full heart cycle (smaller sector sizes allow for increased frame rates), and all of the sectors collected are stitched together by utilizing the temporal synchronization of an electrocardiogram (leading to increased spatial resolution).

The breath-hold protocol used to collect the data was intended to minimize artifacts caused by the patient's breathing apparatus. Before acquiring a TEE volume, the anesthesiologist temporarily deactivates the patient's respirator and allows the patient's chest to steady. However, the patients were still breathing during acquisition, which occasionally resulted in unintended probe motion that generated misalignment artifacts between sectors. Cardiac arrhythmia can also cause misalignment artifacts, however the patients selected were mostly asymptomatic with regard to arrhythmia.

For this experiment, sequences with severe sector misalignment were excluded. Imagery was selected to avoid cropping of left-heart structures. Some images did, however, contain poorly defined or missing ventricle walls.

The final dataset included fourteen separate sequences corresponding to eight different patients. Parameters of the sequences are provided in Table 1-1, including voxel resolution, frame rate, depth, and image quality. In Table 1-1, image quality is rated from 1 (high quality, no artifacts), to 5 (poor quality, many artifacts).

3D flow was computed on a sequence of frames spanning 1 full heart cycle. A total of 28 sequences from 12 separate patients were used. Each sequence contained between 30 and 50 frames. After computing 3D optical flow, movies were generated for each sequence, displaying flow vector and heat map overlays. As shown in Table 1-1, the generated movies and 3D flow results were evaluated by a cardiologist and all but one sequence obtained the highest marks for physiologic plausibility in both direction and magnitude.

TABLE 1-1

| | Voxel Resolution | Frame Rate | Depth Setting | Image |
|---|---|---|---|---|
| Seq. | (mm) | (Hz) | (cm) | Quality |
| 1 | 0.41 × 0.4 × 0.44 | 52 | 9 | 2 |
| 2 | 0.37 × 0.36 × 0.39 | 56 | 8 | 2 |
| 3 | 0.61 × 0.6 × 0.53 | 44 | 11 | 2 |
| 4 | 0.67 × 0.66 × 0.58 | 41 | 12 | 1 |
| 5 | 0.67 × 0.66 × 0.58 | 41 | 12 | 1 |
| 6 | 0.72 × 0.71 × 0.63 | 39 | 13 | 2 |
| 7 | 0.72 × 0.71 × 0.63 | 39 | 13 | 2 |
| 8 | 0.67 × 0.66 × 0.58 | 41 | 12 | 2 |
| 9 | 0.67 × 0.66 × 0.58 | 41 | 12 | 1 |
| 10 | 0.5 × 0.49 × 0.44 | 52 | 9 | 2 |
| 11 | 0.78 × 0.77 × 0.68 | 36 | 14 | 2 |
| 12 | 0.78 × 0.77 × 0.68 | 36 | 14 | 2 |
| 13 | 0.78 × 0.77 × 0.68 | 36 | 14 | 1 |
| 14 | 0.67 × 0.66 × 0.58 | 24 | 12 | 2 |

Image quality is a subjective rating, by a cardiologist, of the overall quality and amount of artifacts in each sequence. The best quality images may have required multiple collections using the iE33 machine to minimize stitching artifacts due to breathing and/or irregular heart motion.

Table 1-2 provides atrium, ventricle, and whole left-heart segmentation Dice coefficients for each image sequence.

TABLE 1-2

| | | Atrium | | Ventricle | | Whole LH. | |
|---|---|---|---|---|---|---|---|
| Seq. | Expert | Diastole | Systole | Diastole | Systole | Diastole | Systole |
| 1 | A | 0.8883 | 0.9551 | 0.1764 | 0.8128 | 0.6292 | 0.8735 |
| 1 | B | 0.924 | 0.9509 | 0.7295 | 0.7885 | 0.6628 | 0.8618 |
| 1 | C | 0.895 | 0.956 | 0.7411 | 0.8261 | 0.6855 | 0.8672 |
| 2 | A | 0.8981 | 0.8664 | 0.6057 | 0.7284 | 0.8157 | 0.7769 |
| 3 | C | 0.8669 | 0.9337 | 0.8349 | 0.8588 | 0.8364 | 0.8838 |
| 4 | B | 0.9131 | 0.9348 | 0.7998 | 0.897 | 0.8345 | 0.8847 |
| 5 | B | 0.9096 | 0.9423 | 0.7414 | 0.857 | 0.8276 | 0.8594 |
| 6 | C | 0.95 | 0.9522 | 0.7951 | 0.811 | 0.8666 | 0.8736 |
| 7 | A | 0.8718 | 0.9653 | 0.7857 | 0.8429 | 0.8162 | 0.8624 |
| 7 | B | 0.9493 | 0.9593 | 0.7829 | 0.7224 | 0.8315 | 0.8681 |
| 7 | C | 0.9128 | 0.9473 | 0.8315 | 0.8078 | 0.8666 | 0.8821 |
| 8 | A | 0.9051 | 0.8477 | 0.662 | 0.8022 | 0.7209 | 0.8227 |
| 9 | A | 0.8962 | 0.9365 | 0.6348 | 0.8174 | 0.6955 | 0.7885 |
| 9 | B | 0.8862 | 0.9312 | 0.6135 | 0.8182 | 0.689 | 0.8546 |
| 9 | C | 0.863 | 0.869 | 0.6042 | 0.8333 | 0.6686 | 0.8435 |
| 10 | C | 0.7496 | 0.8463 | 0.731 | 0.7977 | 0.7313 | 0.7709 |
| 11 | A | 0.8953 | 0.8525 | 0.6994 | 0.7951 | 0.7923 | 0.8315 |
| 11 | B | 0.9545 | 0.9511 | 0.7926 | 0.7933 | 0.8763 | 0.8898 |
| 11 | C | 0.9323 | 0.9382 | 0.7869 | 0.7574 | 0.8786 | 0.8638 |
| 12 | A | 0.933 | 0.9397 | 0.7351 | 0.7747 | 0.8698 | 0.8488 |
| 12 | B | 0.9556 | 0.9581 | 0.7792 | 0.7922 | 0.8889 | 0.8928 |
| 12 | C | 0.9278 | 0.939 | 0.7676 | 0.7066 | 0.8872 | 0.8318 |
| 13 | B | 0.9393 | 0.9391 | 0.806 | 0.6994 | 0.8322 | 0.7941 |
| 14 | A | 0.8626 | 0.833 | 0.7994 | 0.8346 | 0.8186 | 0.8222 |
| 14 | B | 0.8729 | 0.913 | 0.7909 | 0.8478 | 0.8055 | 0.8661 |
| 14 | C | 0.8557 | 0.887 | 0.8538 | 0.8402 | 0.8663 | 0.8494 |

The level set method was implemented and run in MATLAB. The program was mostly single-threaded and no attempt with made to parallelize or optimize the program. When processing full-size 224×208×208 cubes, iterations took approximately three minutes on an Intel i7-720QM laptop with 4 GB of RAM. The process typically reaches acceptable segmentation results in fewer than 30 iterations. Nearly identical results may be achieved in a shorter time frame by down-sampling the initial cube and then up-sampling the segmentation results. Examples of the resulting segmentation of full TEE cubes are shown in FIG. 1-3.

FIG. 1-3 is a set of segmentation images 1-300, including segmentation images of an intra-atrial cavity (upper row images), and segmentation images of an intra-ventricular cavity (lower row of images). Images in each of the upper and lower rows, from left to right, correspond to long axis/2 chambers, long axis/4 chambers, short axis, and 3D rendered views, respectively.

Ground-truth comparisons can be an important part of validating segmentation performance. Various comparison methods are provided and analyzed, but one of the most important pieces of this comparison is the ground-truth segmentation itself. Errors in the ground-truth may affect every comparison method used. To minimize the effects of ground-truth errors, experts segmented as many images as possible within time and monetary constraints.

Before segmenting these images, an initial set of experiments was performed. Experts segmented a small subset of images using two different methods. The first, more conventional ground-truthing method involved volumetrically segmenting the desired object across the entire 3D image cube. The second method involved only segmenting the desired object across every 10th short-axis slice of the 3D image cube. Both methods were performed using the paintbrush tool in ITK-SNAP (Yushkevich et al., 2006).

When generating error metrics for the sub-sampled ground-truth segmentations, a matching subset of every 10^{th} slice from the level set segmentation was used for comparison. The second ground-truthing method may be performed in considerably reduced amount of time. The initial set of experiments that were performed compared error values for expert ground-truth segmentations between the two different methods for the same imagery.

FIGS. 1-4a through 1-4f are images ground-truth versus level set segmentation comparisons. Specifically:

FIG. 1-4a is an image 1-400 of coronal ground-truth;

FIG. 1-4b is an image 1-402 of coronal ground-truth:

FIG. 1-4c is an image 1-404 of coronal level set segmentation:

FIG. 1-4d is an image 1-406 of sagittal ground-truth;

An acceptable ±2% margin of error in Dice coefficients was found between ground-truth segmentations using the first method and ground-truth segmentations using the second method. As a result, the second method of segmenting only every 10th slice was used to ground-truth a majority of the 3D TEE imagery used.

Also, while many of the image cubes were segmented by a single expert, some were segmented by all three experts. This allowed for the computations of inter-operator error values, or the error between expert segmentations of identical imagery, for each of the metrics used, as shown in Table 1-3.

TABLE 1-3
Average Inter-Operator Error

| Id | Mean (vox) | RMS (vox) | Mean (mm) |
|---|---|---|---|
| Atrium (Diastole) | 1.1332 | 1.5419 | 0.4724 |
| Atrium (Systole) | 1.0996 | 1.4924 | 0.4584 |
| Ventricle (Diastole) | 2.5968 | 3.6544 | 1.0826 |
| Ventricle (Systole) | 2.7876 | 3.3830 | 1.1621 |
| Whole LH (Diastole) | 2.0492 | 2.9440 | 0.8543 |
| Whole LH (Systole) | 1.9129 | 2.5278 | 0.7975 |

| Id | RMS (mm) | Dice |
|---|---|---|
| Atrium (Diastole) | 0.6428 | 0.9088 |
| Atrium (Systole) | 0.6222 | 0.9557 |
| Ventricle (Diastole) | 1.5235 | 0.8639 |
| Ventricle (Systole) | 1.4104 | 0.8125 |
| Whole LH (Diastole) | 1.2274 | 0.8828 |
| Whole LH (Systole) | 1.0538 | 0.8737 |

In the experiments, it was found that the following parameters values work well for left ventricle and atrium segmentation: λ=4, μ=0.04, v=−6, and a=300. These parameter values were determined manually by experimentation and knowledge of how the various parameters cooperate to segment noisy TEE left-heart structures. The parameter values, while not necessarily most optimal, were kept unchanged for all experiments as the segmentation method was benchmarked. Benchmarking was performed using a total of 28 frames from 14 different 3D TEE sequences, many of which contain different viewpoints of the left atrium and left ventricle, as well as vastly different contrast ratios (see. FIGS. 1-5a and 1-5b).

FIGS. 1-5a is an ultrasound image 1-500. FIG. 1-5b is an ultrasound image 1-502. Image 1-502 is of better quality than image 1-500.

Receiver operating characteristic (ROC) curves were generated using the number of level set iterations as their criterion. True positive rates were calculated as the number of voxels correctly identified as belonging to the segmentation target, divided by the total number of voxels in the segmentation target. False positive rates were calculated as the number of voxels incorrectly identified as belonging to the segmentation target, divided by the total number of voxels in the cube.

ROC curves were generated to separately evaluate segmentation performance of the following areas: the entire left heart, only the left atrium, only the left ventricle, volumes taken during diastole exhibiting an open valve, and volumes taken during systole exhibiting a closed valve (as seen in FIGS. 1-6a through 1-6f).

FIG. 1-6a includes ROC curves for open-valve atrium segmentation, including a mean curve 1-602, a median curve 1-604, a minimum curve 1-606, and a maximum curve 1-608.

FIG. 1-6b includes ROC curves for closed-valve atrium segmentation, including a mean curve 1-610, a median curve 1-612, a minimum curve 1-614, and a maximum curve 1-616.

FIG. 1-6c includes ROC curves for open-valve ventricle segmentation, including a mean curve 1-618, a median curve 1-620, a minimum curve 1-622, and a maximum curve 1-624.

FIG. 1-6d includes ROC curves for closed-valve ventricle segmentation, including a mean curve 1-626, a median curve 1-628, a minimum curve 1-630, and a maximum curve 1-632.

FIG. 1-6e includes ROC curves for open-valve left heart segmentation, including a mean curve 1-634, a median curve 1-636, a minimum curve 1-638, and a maximum curve 1-640.

FIG. 1-6f includes ROC curves for closed-valve left heart segmentation, including a mean curve 1-642, a median curve 1-644, a minimum curve 1-646, and a maximum curve 1-648.

The open valve and closed valve areas each consisted of half of the images in the entire dataset. Atrium and ventricle segmented were performed by using different seeds, with the whole left heart segmentation performed using a combination of the two seeds.

Each ROC curve plot contains four curves: maximum and minimum error values per iteration are displayed in blue and yellow, respectively, mean error values are displayed in red, and median error values are displayed in green. Note that the max, min, mean, and median values were based on the true positive and false positive rates at matching iterations for each of the target segmentation areas. For example, all the open valve atrium segmentations after one iteration were used to calculate the first iteration min, max, mean, and median true positive and false positive rates for the open valve atrium ROC curve.

The rationale for operating on the number of iterations, as opposed to other intrinsic level set parameters, stems from the inherent noise and wall boundary uncertainty present in TEE imagery. Structures and walls in TEE imagery do not have edges that are as well defined and smooth as what one might see in, for example, MRI imagery. Because of these poorly defined boundaries, if the level set method were evolved over too many iterations, it would creep out of the desired segmentation target and expand into the frustum.

In addition to ROC curves, several other error metrics were computed. Mean errors, RMS errors, Dice coefficients, average area-under-the-ROC-curve values, and ROC curve equal error rate (EER) values are all reported in Table 1-4.

TABLE 1-4
Average Level Set Segmentation Error

| Id | Mean (vox) | RMS (vox) | Mean (mm) |
|---|---|---|---|
| Atrium (Diastole) | 1.3913 | 1.9490 | 0.8196 |
| Atrium (Systole) | 1.4568 | 2.3164 | 0.8676 |
| Ventricle (Diastole) | 3.0147 | 3.9555 | 1.7036 |
| Ventricle (Systole) | 2.3801 | 3.1196 | 1.3745 |
| Whole LH (Diastole) | 2.4132 | 3.4290 | 1.3770 |
| Whole LH (Systole) | 2.1558 | 3.2302 | 1.2567 |

| Id | RMS (mm) | Dice | AUC | EER |
|---|---|---|---|---|
| Atrium (Diastole) | 1.1368 | 0.8914 | 0.9655 | 0.0439 |
| Atrium (Systole) | 1.3614 | 0.9103 | 0.9880 | 0.0172 |
| Ventricle (Diastole) | 2.2361 | 0.7391 | 0.9797 | 0.0534 |
| Ventricle (Systole) | 1.8052 | 0.8092 | 0.9873 | 0.0329 |
| Whole LH (Diastole) | 1.9361 | 0.7919 | 0.9817 | 0.0471 |
| Whole LH (Systole) | 1.8635 | 0.8352 | 0.9855 | 0.0404 |

In Table 1-4, mean and RMS error values are the average and root mean square distances that a particular segmentation's outline lies from the ground-truth segmentation's outline. Lower mean and RMS error values represent segmentation outlines that lie closer to the ground-truth.

For the experiment, the Dice coefficient (Dice, 1945) is a voxel-by-voxel similarity measure between two sets, and is computed as follows:

$$Dice = \frac{2 \vert {I}_{LS} ⋂ {I}_{GT} \vert}{\vert {I}_{LS} \vert + \vert {I}_{GT} \vert} , \qquad EQ . ( 1 \text{-} 14 )$$

where I_{LS} is the level set segmentation and I_{GT} is the ground-truth segmentation.

Dice values closer to 1 signify better matches. Area-under-the-curve (AUC) values represent the total area covered by a given ROC curve. As ROC curves lie on a plane of size 1×1, AUC values closer to 1 signify better performance. EER specifies the rate at which false positive and false negative errors are equal, and smaller values indicate better performance.

As seen in Tables 1-3 and 1-4, mean outline distance results vary from 1.39-1.46 voxels for automated atrium segmentation, compared to 1.10-1.13 voxels inter-operator error, and 2.38-3.01 voxels for automated ventricle segmentation, compared to 2.60-2.79 voxels inter-operator error. Average Dice coefficients for automated atrium segmentation vary from 0.89-0.91, compared to 0.91-0.96 inter-operator error, and for automated ventricle segmentation the average Dice coefficients vary from 0.74-0.81, compared to 0.81-0.86 inter-operator error.

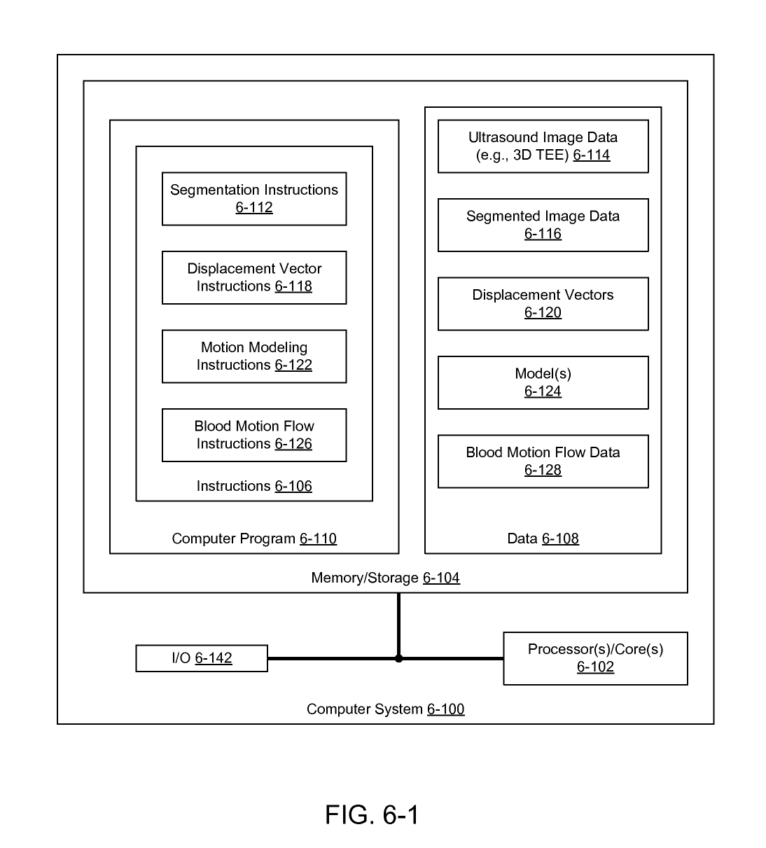

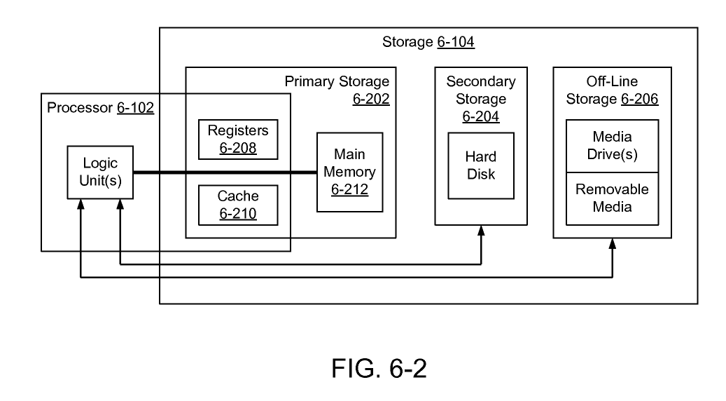

From FIG. 6a, automated atrium segmentation performs well, with the lowest true positive rates being above 0.85 for false positive rates greater than 0.02. Closed-valve systolic phase atrium segmentation, in FIG. 6b, performs slightly better with true positive rates above 0.9 for the same false positive rates. As shown in FIGS. 6c-6d, automated ventricle segmentation performs worse. Although, average true positive rates given a false positive rate of 0.02 are close to 0.85 for open-valve segmentation and 0.9 for closed-valve segmentation, a small number of images performed very poorly, resulting in minimum true positive rates of 0.4 and 0.7 (given the same false positive rate of 0.02) for open-valve and closed-valve ventricle segmentation, respectively.

To fully characterize the performance of the method described above, a variety of error metrics are provided. The utility of 3D segmentation methods is widespread, with different use cases requiring vastly different tolerances for various types of errors. Metrics such as Dice do a good job of highlighting subtle differences between two sets, but if an application requires more accurate volume measurements and can tolerate boundary delineation imperfections, Dice will not necessarily identify the best method. Metrics such as ROC curves, applied as described above, have the opposite effect. Most of these metrics are used in literature, and their use depends on the specific application of the method.

For example, in applications involving the computation of ejection fraction, boundary delineation imperfections may be acceptable so long as the computed volume is close enough to the actual volume. ROC curves and, more specifically, true positive and false positive rates are an excellent comparison in this regard, because they provide an indication of the percentages of volume that were correctly or incorrectly identified.

While some studies only provide volumetric measurements as a criterion for evaluating segmentation performance and this might be sufficient for certain use cases, in general, this information may be insufficient for a full performance characterization of the method. For example, a method could incorrectly segment large portions of an image but still arrive at a volume similar to that of the left-ventricle, especially when evaluating iterative methods like level set, which under a constrained number of iterations in free space may naturally expand to enclose a volume similar to that of a normal ventricle.

True positive and false positive rates solve this issue by quantifying the method's volumetric performance only with respect to the ground-truth voxels. In other words, if the method segments an equal volume to the ground-truth, but in the wrong place, its true positive rate will be low and its false positive rate will be high.

On the other hand, for precise boundary segmentation, as may be necessary in the modeling community, Dice as well as the mean and RMS boundary errors may provide the best insight. True positive and false positive rates do not do as good a job quantifying a method's ability to segment the fine structures in the left-heart, such as trabeculation, chordae tendineae, or valve leaflets. However, these fine left-heart structures are sometimes difficult even for experts to segment. Poor image quality and contrast variations play a significant role in determining the best possible error values achieved for a given image. In some scenarios, heart structures may appear broken and discontinuous in a single slice, and only by visualizing the cube in true volumetric form (which was not typically done during ground-truthing) can an expert make out the true structure.

From Table 1-4, it can be seen that the level set method performs better when segmenting the right ventricle as opposed to the left atrium. This is partially due to the decrease in contrast moving away from the probe towards the apex of the left ventricle. In some image sequences, the US probe was set to focus on the mitral valve, which resulted in the apex of the left ventricle being poorly defined or not defined at all. As a result, the level set method could expand out the bottom of the ventricle and into the surrounding area of the frustum. As an expert segments such an image, they may utilize the curvature of portions of the ventricle wall that are visible to extrapolate how missing portions of the ventricle wall should appear. This may point towards the usefulness of atlas-based methods, since the only means for the level set method to handle this artifact is by tuning the number of iterations. Modifying the level set parameters alone may not prevent the method from expanding beyond a wall that cannot be seen.

Contrast aside, another explanation for the difference in error values between atrium and ventricle segmentation is that, due to the positioning of the TEE probe, there is essentially only one side of the atrium segmentation that is meaningful. In a majority of images, the atrium is cropped on all but one side by the frustum, as can be seen in the top row of FIG. 1-3. The cropping artificially restricts the level set expansion and reduces the area where segmentation errors may appear.

As shown in Table 1-3, there is a similar increase in error between expert segmentations of the left ventricle and left atrium. This error difference between atrium and ventricle ground-truth segmentations may be due contrast and image quality issues discussed above, and/or the presence of additional complex structures in the ventricle. Segmentation errors for the algorithm are, however, similar in magnitude to the inter-operator errors, especially for closed valve scenarios. Overall, when compared to the conventional methods, level set techniques disclosed herein provide better performance and fewer segmentation errors.

C. Derivation of the Evolution Function

Derivation of EQ. (1-6) is provided below.

It may be useful or desirable to find the first variation of the energy functional:

$$E ( φ ) = {\int }_{Ω} [ \frac{μ}{2} {( \vert ∇ φ \vert - 1 )}^{2} + λ g δ ( φ ) \vert ∇ φ \vert + vgH ( - φ ) ] d V , \qquad EQ . ( 1 \text{-} 15 )$$

It is noted note that H(−□)=1−H(□) and that H′(□)=δ(□).

Let □ be the minimizing function of E, ψ be any other function, and τ be a scalar, then:

$$\frac{d}{d τ} E ( φ + τψ ) {\vert}_{τ = 0} = 0. \qquad EQ . ( 1 \text{-} 16 )$$

The derivatives of the three terms in EQ. (1-15) are given by:

$$\begin{matrix}\frac{d}{d τ} {E}_{1} ( φ + τψ ) = μ {\int }_{Ω} ( \vert ∇ φ + τ ∇ ψ \vert - 1 ) \frac{∇ φ + τ ∇ ψ}{\vert ∇ φ + τ ∇ ψ \vert} \cdot ∇ ψ d V , & EQ . ( 1 \text{-} 17 ) \\ \frac{d}{d τ} {E}_{2} ( φ + τψ ) = λ {\int }_{Ω} [ g δ ( φ + τψ ) \frac{∇ φ + τ ∇ ψ}{\vert ∇ φ + τ ∇ ψ \vert} \cdot ∇ ψ + g {δ}^{′} ( φ + τψ ) \vert ∇ φ + τ ∇ ψ \vert ψ ] d V , \\ and , & EQ . ( 1 \text{-} 18 ) \\ \frac{d}{d τ} {E}_{3} ( φ + τψ ) = - v {\int }_{Ω} g δ ( φ + τψ ) ψ d V . & EQ . ( 1 \text{-} 19 )\end{matrix}$$

Evaluated at τ=0, EQS. (1-17), (1-18), and (1-19) become:

$$\begin{matrix} \frac{d}{d τ} {E}_{1} ( φ + τψ ) {\vert}_{τ = 0} = μ {\int }_{Ω} ( \vert ∇ φ \vert - 1 ) \frac{∇ φ}{\vert ∇ φ \vert} \cdot ∇ ψ d V , & EQ . ( 1 \text{-} 20 ) \\ \frac{d}{d τ} {E}_{2} ( φ + τψ ) {\vert}_{τ = 0} = λ {\int }_{Ω} [ g δ ( φ ) \frac{∇ φ}{\vert ∇ φ \vert} \cdot ∇ ψ + g {δ}^{′} ( φ ) \vert ∇ φ \vert ψ ] d V , \\ and , & EQ . ( 1 \text{-} 21 ) \\ \frac{d}{d τ} {E}_{3} ( φ + τψ ) {\vert}_{τ = 0} = - v {\int }_{Ω} g δ ( φ ) ψ d V . & EQ . ( 1 \text{-} 22 )\end{matrix}$$

Using Green's first identity,

∫_{Ω}ψΔφ+∇φ·∇ψdV=∫_{∂Ω}ψ∇φ·dā, (1-23)

EQ. (1-20) may be recast as:

$$\begin{matrix}μ {\int }_{Ω} ( \vert ∇ φ \vert - 1 ) \frac{∇ φ}{\vert ∇ φ \vert} \cdot ∇ ψ d V = - μ {\int }_{Ω} ∇ \cdot ( ∇ φ - \frac{∇ φ}{\vert ∇ φ \vert} ) ψ d V & EQ . ( 1 \text{-} 24 ) \\ = - μ {\int }_{Ω} [ Δφ - ∇ \cdot ( \frac{∇ φ}{\vert ∇ φ \vert} ) ] ψ d V , & EQ . ( 1 \text{-} 25 )\end{matrix}$$

where the surface term in EQ. (1-23) is omitted based on the assumption that the variation is zero on the boundary (i.e., the boundary values of the functions over which E is considered are specified and hence ψ=0 on ∂Ω).

Similarly, the first term in EQ. (1-21) becomes:

$$λ {\int }_{Ω} g δ ( φ ) \frac{∇ φ}{\vert ∇ φ \vert} \cdot ∇ ψ d V = - λ {\int }_{Ω} [ g {δ}^{′} ( φ ) \vert ∇ φ \vert + δ ( φ ) ∇ \cdot ( g \frac{∇ φ}{\vert ∇ φ \vert} ) ] ψ d V . \qquad EQ . ( 1 \text{-} 26 )$$

Since, from EQ. (1-16):

$$\frac{d}{d τ} E ( φ + τψ ) {\vert}_{τ = 0} = 0 , \\ then \text{:} \\ {\int }_{Ω} \{ - μ [ Δφ - ∇ \cdot ( \frac{∇ φ}{\vert ∇ φ \vert} ) ] - λδ ( φ ) ∇ \cdot ( g \frac{∇ φ}{\vert ∇ φ \vert} ) - vg δ ( φ ) \} ψ d V = 0. \qquad EQ . ( 1 \text{-} 27 )$$

As this must be true for any ψ, the portion of the integrand in braces must be identically zero for the minimizer □. The Gâteaux derivative may therefore be defined as:

$$\frac{\partial E}{\partial φ} = - μ [ Δφ - ∇ \cdot ( \frac{∇ φ}{\vert ∇ φ \vert} ) ] - λδ ( φ ) ∇ \cdot ( g \frac{∇ φ}{\vert ∇ φ \vert} ) - vg δ ( φ ) , \qquad EQ . ( 1 \text{-} 28 )$$

such that the minimizer □ satisfies the Euler-Lagrange equation

$$\frac{\partial E}{\partial φ} = 0.$$

### II. Patient-Specific Computation of 3D Tissue Motion/Displacement

Heart disease is one of the leading causes of death in the United States. In 2006, an estimated 26% of all deaths were caused by heart-related conditions (Heron et al. 2009). Fortunately, many of these conditions can be treated or prevented if doctors have the right tools at their disposal and are able to diagnose pathologies early.

Recovery of data concerning dense myocardial displacement from 4D echocardiography is an important endeavor in this regard because it has many applications in diagnostics, modeling, simulation, and training.

Myocardial strain, which may be obtained from displacement vectors, may play a role in the diagnosis of cardiovascular diseases. An illustrative pathology related to strain-based diagnostics is hypertrophic cardiomyopathy (HCM). Accurate strain information may allow clinicians to more deeply understand the mechanisms behind HCM, and may provide a relatively fast and accurate screening technique for the disease.

Dense myocardial displacement recovery may also be useful in modeling and simulation. As described further above, many treatments for the mitral valve involve challenging time-constrained cardiothoracic surgical procedures. The procedures are often begun with limited information about the unique structures inside a patient's heart. The outcome of such procedures may be improved if potential valve modifications can be simulated beforehand and if various reconstruction options are compared.

Reliable patient-specific simulations cannot, however, be performed without first recovering physiological characteristics of the patient, at least some of which may be unique to the patient. Errors in the observation of patient-specific parameters may, however, propagate, which may render modeling and simulation stages unreliable.

Characterizing complex fast-moving heart structures requires data with sufficiently high spatial and temporal resolution. 4D US represents one of the few viable options for this purpose. In contrast to other modalities, such as fluoroscopy, x-ray CT, and MRI. 4D US involves minimal patient risks. In addition, 4D US equipment is relatively small and inexpensive.

Although progress has been made in the development of piezoelectric elements and signal-processing techniques, conventional 4D US imaging is still affected by noise and artifacts that can make the data difficult to analyze, and example of which is provided in FIG. 2-1.

FIG. 2-1 is a rendered 3D ultrasound image 2-102 obtained with a 4D TEE probe. Image 2-102 includes a mitral valve, intra-atrial cavity, sections of the intraventricular cavity, and aortic valve.

Disclosed below are methods and systems to compute dense 3D tissue motion in the form of 3D velocity or displacement vectors from four-dimensional (4D) ultrasound images (i.e., 3 spatial dimensions plus time).

The methods and systems provide relatively highly accuracy patient-specific data, which may be used to improve patient-specific modeling and simulation fidelity.

Methods and systems are described below with respect to computation of 3D displacement vectors for the myocardium and valves from 4D echocardiography. The methods and systems are not, however, limited to the myocardium or echocardiography.

The methods and systems include optical flow techniques inspired by approaches of Brox et al. (2004), Liu et al. (2008), and Sun et al. (2010), in combination with a variational technique to account for constraints of 4D TEE brightness intensity and of spatiotemporal smoothness regularization.

A. Variational 3D Optical Flow Techniques

When computing optical flow, brightness intensity should remain constant when visually following a feature point within a bounded temporal window. This is referred to herein as a brightness intensity constraint.

Consider two 3D frames taken at times t and t+1. According to the brightness intensity constraint, the intensity value of a voxel in the first frame of an image at time t and at location x≡(x, y, z) should remain constant and match the intensity value of a voxel in the second frame taken at time t+1, at position x+u, where u≡(x, y, z). In other words:

I(x,t)=I(x+u,t+1). EQ. (2-1)

A method of applying this constraint to all of the voxels in the images is to form an energy function that penalizes differences in voxel value between pairs of frames, such as:

L_{D}(u)=∫^{|}Ψ(|I(x+u,t+1)−I(x,t)|²)dx. EQ. (2-2)

The function Ψ(s²)=\sqrt{s²+ó²} constitutes an L2 norm, which allows the application of quadratic optimization techniques, while behaving as a robust L norm when □→0.

The use of this as a sole constraint may lead to an ill-posed problem (i.e., one constraint for three unknowns u). An additional spatiotemporal smoothness constraint may utilized based on the assumption that the flow between two successive frames and two neighboring voxels does not involve sudden local changes.

This constraint may be incorporated with an energy function that penalizes large gradients in the flow vectors at each voxel, such as:

L_{S}(u)=∫Ψ(|∇u|²+|∇V|²+|∇w|²)dx. EQ. (2-3)

A final objective function may be formed by summing together the two previously-discussed energy components. To allow for the amount of flow-vector smoothness to be adjusted as desired, α>0 may be used as in:

L(u)=L_{D}(u)+αL_{S}(u). EQ. (2-4)

To minimize the objective function, which involves an unknown under an integral operator, the Euler-Lagrange equation may be used.

The Euler-Lagrange equations for EQ. (2-4) are as follows:

$$\begin{matrix} \frac{\partial }{\partial u} - ∇ \cdot \frac{\partial }{\partial ∇ u} = 0 & EQ . ( 2 \text{-} 5 a ) \\ \frac{\partial }{\partial v} - ∇ \cdot \frac{\partial }{\partial ∇ v} = 0 & EQ . ( 2 \text{-} 5 b ) \\ \frac{\partial }{\partial w} - ∇ \cdot \frac{\partial }{\partial ∇ w} = 0 , \\ where , \\ = {Ψ ( {\vert I ( x + u , t + 1 ) - I ( x , t ) \vert}^{2} )}^{\vert} + αΨ ( {\vert ∇ u \vert}^{2} + {\vert ∇ v \vert}^{2} + {\vert ∇ w \vert}^{2} ) & EQ . ( 2 \text{-} 5 c )\end{matrix}$$

is the Lagrangian density, and

$$\begin{matrix}∇ \cdot \frac{\partial }{\partial ∇ u} ≡ \frac{\partial }{\partial x} \frac{\partial }{\partial {u}_{x}} + \frac{\partial }{\partial y} \frac{\partial }{\partial {u}_{y}} + \frac{\partial }{\partial z} \frac{\partial }{\partial {u}_{z}} & EQ . ( 2 \text{-} 56 a ) \\ ∇ \cdot \frac{\partial }{\partial ∇ v} ≡ \frac{\partial }{\partial x} \frac{\partial }{\partial {v}_{x}} + \frac{\partial }{\partial y} \frac{\partial }{\partial {v}_{y}} + \frac{\partial }{\partial z} \frac{\partial }{\partial {v}_{z}} & EQ . ( 2 \text{-} 6 b ) \\ ∇ \cdot \frac{\partial }{\partial ∇ w} ≡ \frac{\partial }{\partial x} \frac{\partial }{\partial {w}_{x}} + \frac{\partial }{\partial y} \frac{\partial }{\partial {w}_{y}} + \frac{\partial }{\partial z} \frac{\partial }{\partial {w}_{z}} \\ Here , {u}_{x} ≡ \frac{\partial u}{\partial x} . & EQ . ( 2 \text{-} 6 c )\end{matrix}$$

Expanding EQS. (2-5a) through (2-5c) results in the following equations:

$$\begin{matrix}{Ψ}^{′} ( {\vert I ( x + u , t + 1 ) - I ( x , t ) \vert}^{2} ) {\partial }_{x} \{ I ( x + u , t + 1 ) \} \times ( I ( x + u , t + 1 ) - I ( x , t ) ) - α ∇ ( {Ψ}^{′} ( {\vert ∇ u \vert}^{2} + {\vert ∇ v \vert}^{2} + {\vert ∇ w \vert}^{2} ) ∇ u ) = 0 & EQ . ( 2 \text{-} 7 a ) \\ {Ψ}^{′} ( {\vert I ( x + u , t + 1 ) - I ( x , t ) \vert}^{2} ) {\partial }_{y} \{ I ( x + u , t + 1 ) \} \times ( I ( x + u , t + 1 ) - I ( x , t ) ) - α ∇ ( {Ψ}^{′} ( {\vert ∇ u \vert}^{2} + {\vert ∇ v \vert}^{2} + {\vert ∇ w \vert}^{2} ) ∇ v ) = 0 & EQ . ( 2 \text{-} 7 b ) \\ {Ψ}^{′} ( {\vert I ( x + u , t + 1 ) - I ( x , t ) \vert}^{2} ) {\partial }_{z} \{ I ( x + u , t + 1 ) \} \times ( I ( x + u , t + 1 ) - I ( x , t ) ) - α ∇ ( {Ψ}^{′} ( {\vert ∇ u \vert}^{2} + {\vert ∇ v \vert}^{2} + {\vert ∇ w \vert}^{2} ) ∇ w ) = 0. & EQ . ( 2 \text{-} 7 c )\end{matrix}$$

Because of the nonlinearity of the preceding equations, an iterative numeric approximation technique may be used as in Liu et al. (2008). Incorporating inner and outer fixed-point iterations, combined with a coarse-to-fine multi-scale image warping approach (as in Lucas and Kanade 1981, and Brox et al. 2004), 3 equations are obtained whose solutions make up the displacement vector for a given slice of the coarse-to-fine pyramid on which to iterate.

Defining:

Iₜ^{k}≡I(x+u^{k},t+1)−I(x,t),

Iₓ^{k}≡∂ₓI(x+u^{k},t+1),

I_{y}^{k}≡∂_{y}I(x+u^{k},t+1),and

I_{z}^{k}≡∂_{z}I(x+u^{k},t+1),

EQS. (7a) through (7c) may be written at level k+1 as:

Ψ′(|Iₜ^{k+1}|²)Iₓ^{k}Iₜ^{k+1}−α∇(Ψ′(|∇u^{k+1}|²+|∇v^{k+1}|²+|∇w^{k+1}|²)∇u^{k+1})=0 (2-8a)

Ψ′(|Iₜ^{k+1}|²)I_{y}^{k}Iₜ^{k+1}−α∇(Ψ′(|∇u^{k+1}|²+|∇v^{k+1}|²+|∇w^{k+1}|²)∇u^{k+1})=0 (2-8b)

Ψ′(|Iₜ^{k+1}|²)I_{z}^{k}Iₜ^{k+1}−α∇(Ψ′(|∇u^{k+1}|²+|∇v^{k+1}|²+|∇w^{k+1}|²)∇u^{k+1})=0 (2-8c)

where k represents the current level of the coarse-to-fine pyramid.

Using Taylor expansions of the following form:

$$\begin{matrix}{I}_{t}^{k + 1} ≡ I ( x + {u}^{k + 1} , t + 1 ) - I ( x , t ) \approx {I}_{t}^{k} + ( {u}^{k + 1} - {u}^{k} ) \cdot ∇ I ( x + {u}^{k} , t + 1 ) = {I}_{t}^{k} + {I}_{x}^{k} {du}^{k} + {I}_{y}^{k} {dv}^{k} + {I}_{z}^{k} {dw}^{k} \\ provides , & EQ . ( 2 \text{-} 8 d ) \\ {Ψ}_{1}^{′} {I}_{x}^{k} ( {I}_{t}^{k} + {I}_{x}^{k} {du}^{k , l + 1} + {I}_{y}^{k} {dv}^{k , l + 1} + {I}_{z}^{k} {dw}^{k , l + 1} ) - α ∇ ( {Ψ}_{2}^{′} ∇ ( {u}^{k} + {du}^{k , l + 1} ) ) = 0 & EQ . ( 2 \text{-} 9 a ) \\ {Ψ}_{1}^{′} {I}_{y}^{k} ( {I}_{t}^{k} + {I}_{x}^{k} {du}^{k , l + 1} + {I}_{y}^{k} {dv}^{k , l + 1} + {I}_{z}^{k} {dw}^{k , l + 1} ) - α ∇ ( {Ψ}_{2}^{′} ∇ ( {v}^{k} + {dv}^{k , l + 1} ) ) = 0 & EQ . ( 2 \text{-} 9 b ) \\ {Ψ}_{1}^{′} {I}_{z}^{k} ( {I}_{t}^{k} + {I}_{x}^{k} {du}^{k , l + 1} + {I}_{y}^{k} {dv}^{k , l + 1} + {I}_{z}^{k} {dw}^{k , l + 1} ) - α ∇ {( {Ψ}_{2}^{′} ∇ ( {w}^{k} + {dw}^{k , l + 1} ) )}^{\vert} = 0 \\ where , \\ {Ψ}_{1}^{′} ≡ {Ψ}^{′} ( {\vert {I}_{t}^{k} + {I}_{x}^{k} {du}^{k , l} + {I}_{y}^{k} {dv}^{k , l} + {I}_{z}^{k} {dw}^{k , l} \vert}^{2} ) \\ {Ψ}_{2}^{′} ≡ {Ψ}^{′} ( {\vert ∇ ( {u}^{k} + {du}^{k , l} ) \vert}^{2} + {\vert ∇ ( {v}^{k} + {dv}^{k , l} ) \vert}^{2} + {\vert ∇ ( {w}^{k} + {dw}^{k , l} ) \vert}^{2} ) & EQ . ( 2 \text{-} 9 c )\end{matrix}$$

and l represents the current step of the fixed-point iteration loop.

Immediately following each warping step in the coarse-to-fine pyramid, a median filter, such as a 5×5×5 median filter, may be applied to the flow vectors. More specifically, the 5×5×5 median filter may be applied to each three 3D cube, representing the values u, v, and w for each displacement vector u. As the displacement vectors are 3D, the computation of u^{k} for each level of the coarse-to-fine pyramid involves tri-linear interpolation.

To prevent computation of flow vectors in areas where flow is not well defined (e.g., regions of uniform intensity), empty and/or blood-filled cavities may be removed from the data to permit processing of only the myocardium. To remove all but the myocardium, k-means clustering may be used after compensating for attenuation, to group voxels of the cube into two clusters. The above-described variational optical flow algorithm may be subsequently run on the brighter-intensity cluster.

To summarize, 3D ultrasound image data is processed with first-order (brightness constancy) and second-order (smoothness) constraints, exploiting coarse-to-fine pyramid computation. Results at intermediate computation stage of the pyramid are median-filtered, and iterative numerical techniques are used to solve non-linear equations.

B. Experiments

Using a variety of metrics, a performance evaluation of the technique is presented with respect to synthetic, phantom, and intraoperative 4D transesophageal echocardiographic data.

Intraoperative 4D TEE frames are used to qualitatively compare results the techniques with known behavior of the ventricle and mitral valve during diastolic and systolic phases.

Synthetic transformations are also applied to single intraoperative 4D TEE images to create pairs of frames for which ground-truth motion is known.

A multipurpose US phantom is used with an external 4D probe to generate real ultrasound data with known ground-truth motion.

1. Intraoperative Data

To qualitatively evaluate the technique and investigate any challenges associated with its clinical application, tests were performed using intraoperative real-time 4D TEE data, obtained from patients at the Johns Hopkins University School of Medicine as described further above. Spatial resolutions ranged approximately from 0.4 mm to 1 mm.

Further to the discussion above, unintended probe motion may overwhelm meaningful flow. To compensate, relative flow within the heart may be examined and/or or the myocardium may be registered between frame pairs to eliminate effects of probe motion and/or global heart movement.

3D flow was computed on a sequence of frames spanning 1 full heart cycle. A total of 28 sequences from 12 separate patients were used. Each sequence contained between 30 and 50 frames. After computing 3D optical flow, movies were generated for each sequence, displaying flow vector and heat map overlays.

Table 2-1 provides parameters for each sequence. As shown in Table 2-1, the generated movies and 3D flow results were evaluated by a cardiologist and all but one sequence obtained the highest marks for physiologic plausibility in both direction and magnitude.

TABLE 2-1

| | | Frame | | | |
|---|---|---|---|---|---|
| 4D TEE | Voxel resolution | rate | US depth | Vector | Image |
| sequence | (mm) | (Hz) | (cm) | motion | quality |
| 1 | 0.41 × 0.4 × 0.44 | 52 | 9 | 1 | 2 |
| 2 | 0.37 × 0.36 × 0.39 | 56 | 8 | 1 | 2 |
| 3 | 0.61 × 0.6 × 0.53 | 44 | 11 | 1 | 3 |
| 4 | 0.61 × 0.6 × 0.53 | 44 | 11 | 2 | 2 |
| 5 | 0.61 × 0.6 × 0.53 | 44 | 11 | 1 | 2 |
| 6 | 0.41 × 0.4 × 0.44 | 52 | 9 | 1 | 1 |
| 7 | 0.67 × 0.66 × 0.58 | 41 | 12 | 1 | 1 |
| 8 | 0.67 × 0.66 × 0.58 | 41 | 12 | 1 | 1 |
| 9 | 0.72 × 0.71 × 0.63 | 39 | 13 | 1 | 2 |
| 10 | 0.72 × 0.71 × 0.63 | 39 | 13 | 1 | 2 |
| 11 | 0.72 × 0.71 × 0.63 | 39 | 13 | 1 | 2 |
| 12 | 0.67 × 0.66 × 0.58 | 41 | 12 | 1 | 2 |
| 13 | 0.67 × 0.66 × 0.58 | 41 | 12 | 1 | 1 |
| 14 | 0.5 × 0.49 × 0.44 | 52 | 9 | 1 | 2 |
| 15 | 0.5 × 0.49 × 0.44 | 52 | 9 | 1 | 2 |
| 16 | 0.78 × 0.77 × 0.68 | 36 | 14 | 1 | 2 |
| 17 | 0.78 × 0.77 × 0.68 | 36 | 14 | 1 | 2 |
| 18 | 0.78 × 0.77 × 0.68 | 36 | 14 | 1 | 2 |
| 19 | 0.78 × 0.77 × 0.68 | 36 | 14 | 1 | 1 |
| 20 | 0.56 × 0.55 × 0.48 | 48 | 10 | 1 | 2 |
| 21 | 0.56 × 0.55 × 0.48 | 48 | 10 | 1 | 2 |
| 22 | 0.56 × 0.55 × 0.48 | 48 | 10 | 1 | 2 |
| 23 | 0.56 × 0.55 × 0.48 | 48 | 10 | 1 | 2 |
| 24 | 0.67 × 0.66 × 0.58 | 41 | 12 | 1 | 3 |
| 25 | 0.67 × 0.66 × 0.58 | 41 | 12 | 1 | 3 |
| 26 | 0.67 × 0.66 × 0.58 | 41 | 12 | 1 | 3 |
| 27 | 0.5 × 0.49 × 0.44 | 30 | 9 | 1 | 2 |
| 28 | 0.67 × 0.66 × 0.58 | 24 | 12 | 1 | 2 |

2. Intraoperative Data with Synthetic Motion

To quantitatively assess algorithm performance, sequences where synthetically generated by subjecting clinical 3D volumes to known motion transformations. Because the motion transformations were known, ground-truth flow vectors for each voxel were obtainable. Using the ground-truth vectors, angular and endpoint errors were computed to compare performance of optical flow algorithms. Both error metrics were computed as in Baker et al. (2007) with an extension to handle 3D flow vectors.

FIG. 2-2 is a graph 2-202 of 3D flow vectors computed using the variational method on US data that have been synthetically laterally rotated by 6 degrees (i.e., α, β, and γ are set equal to 1, and θ is set to 6 degrees).

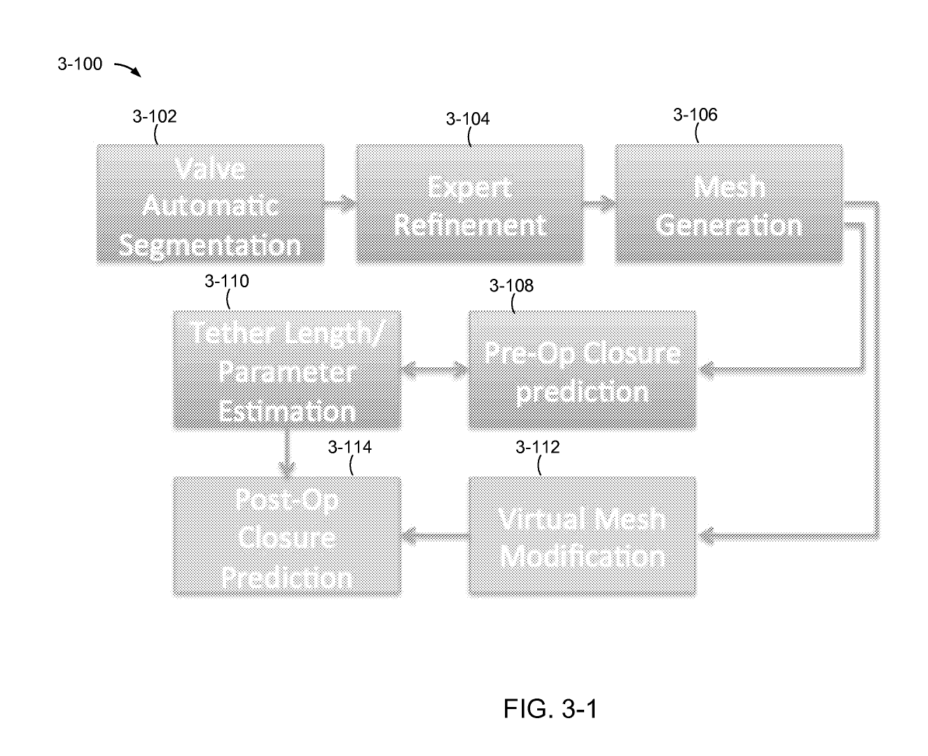

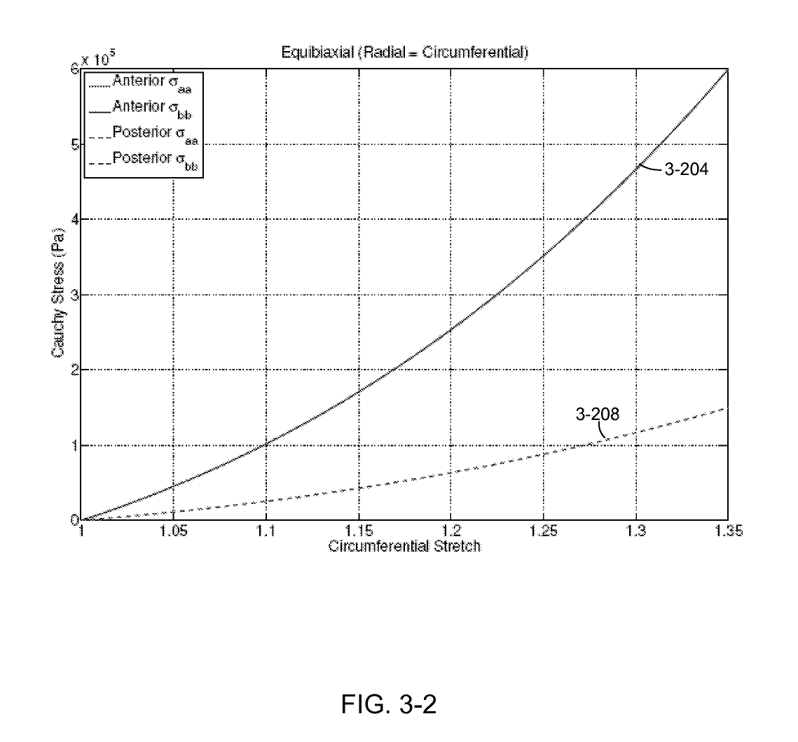

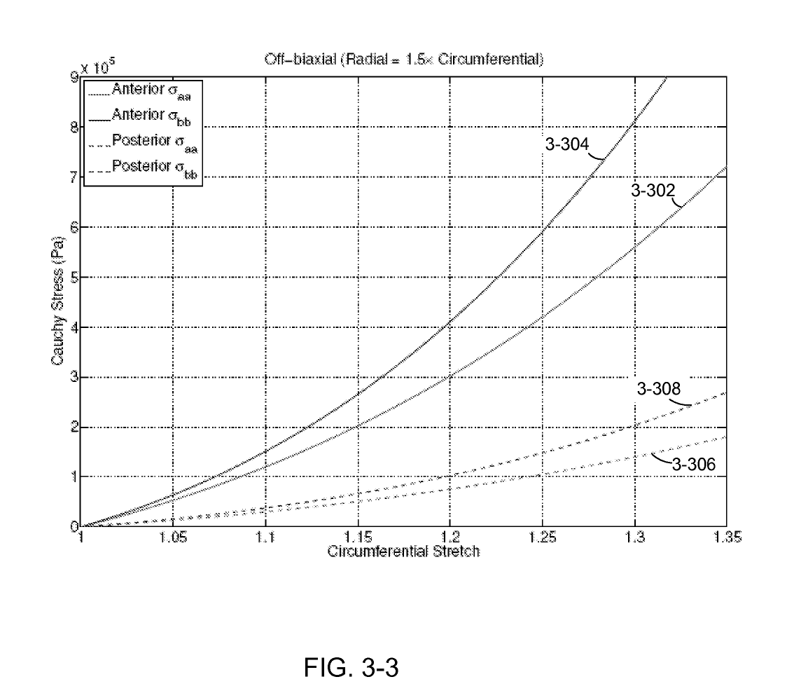

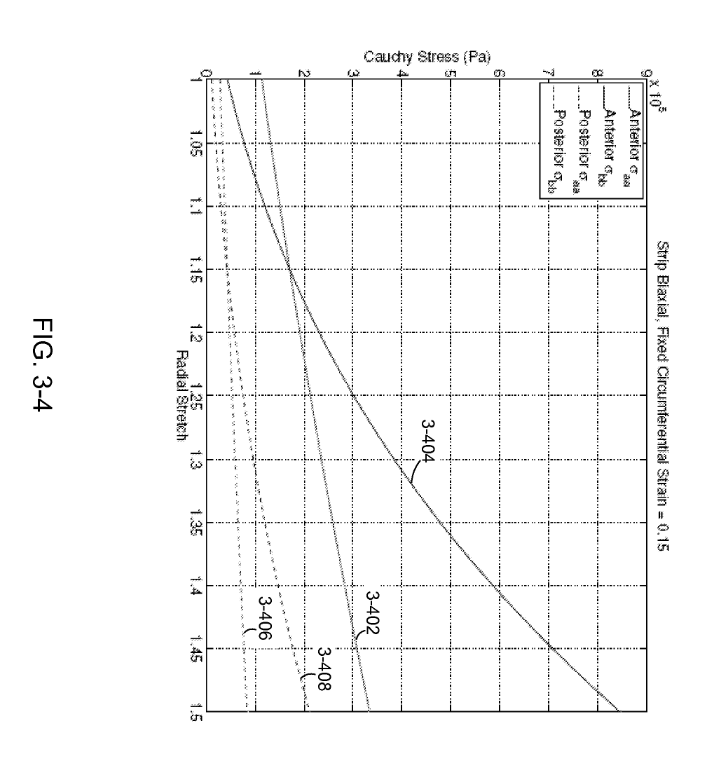

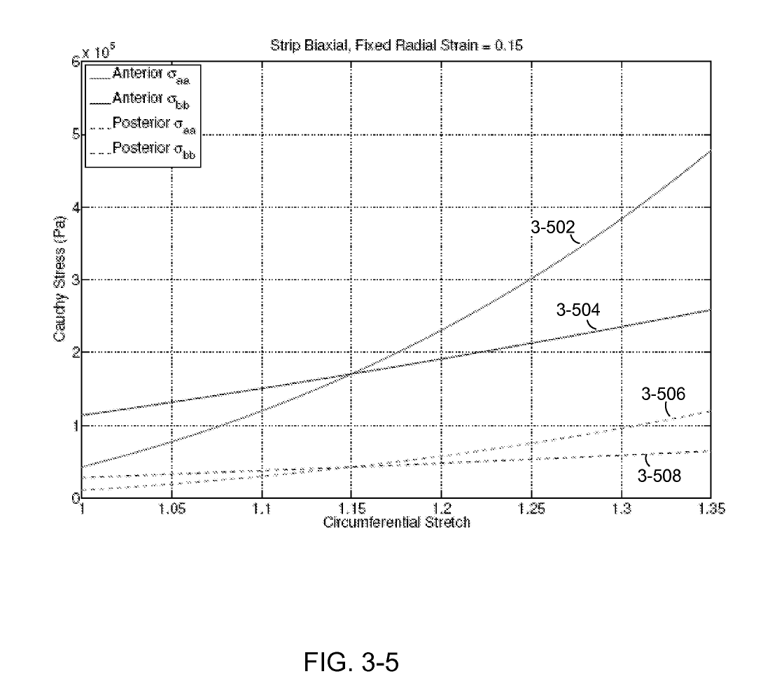

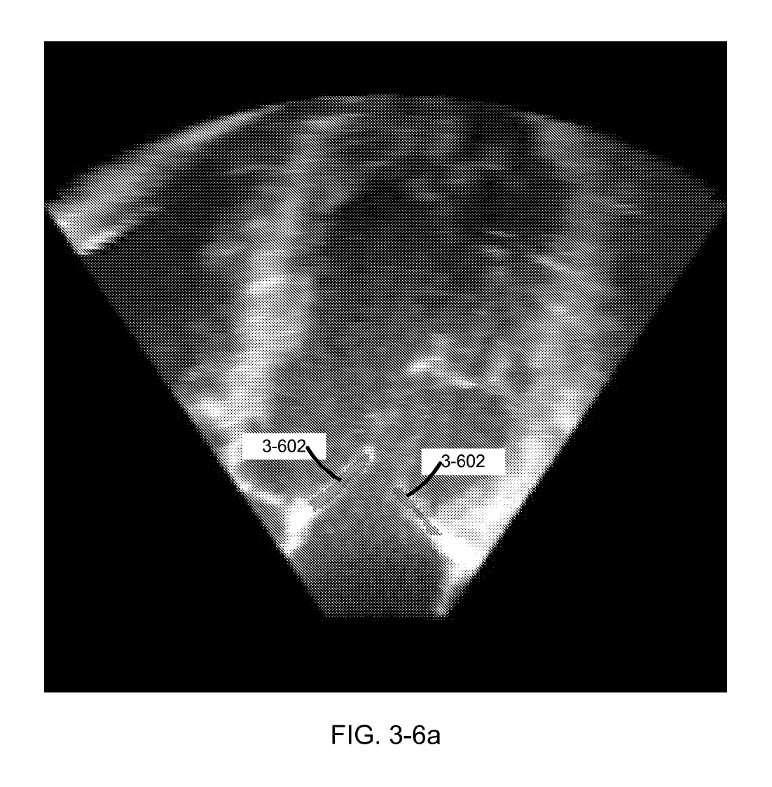

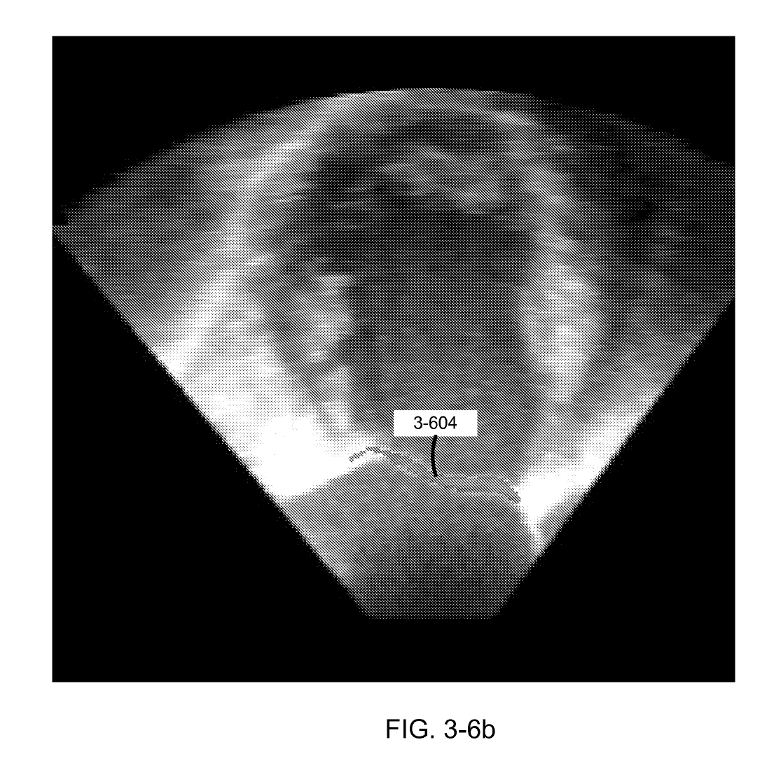

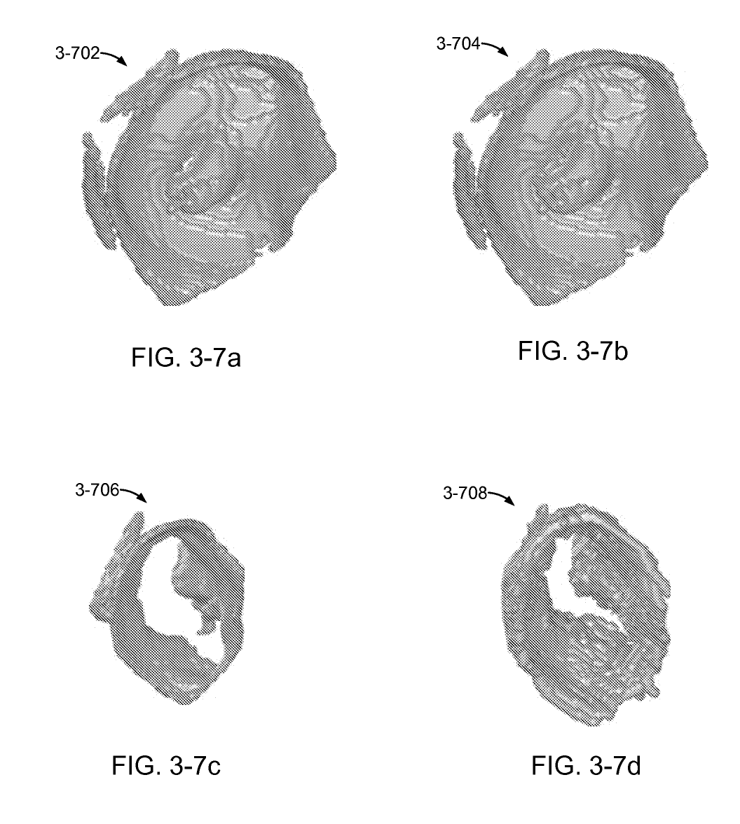

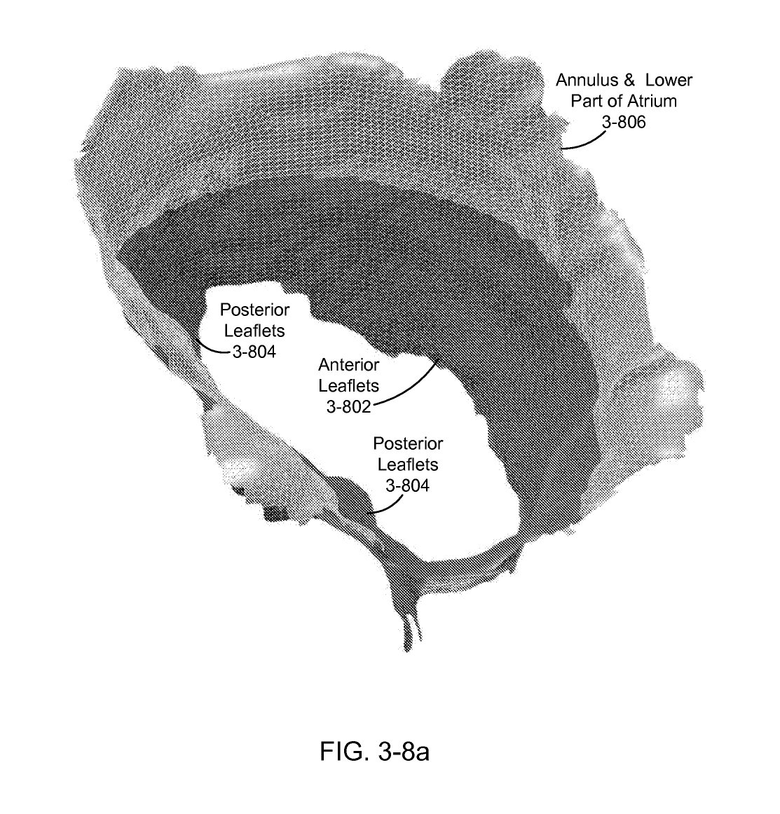

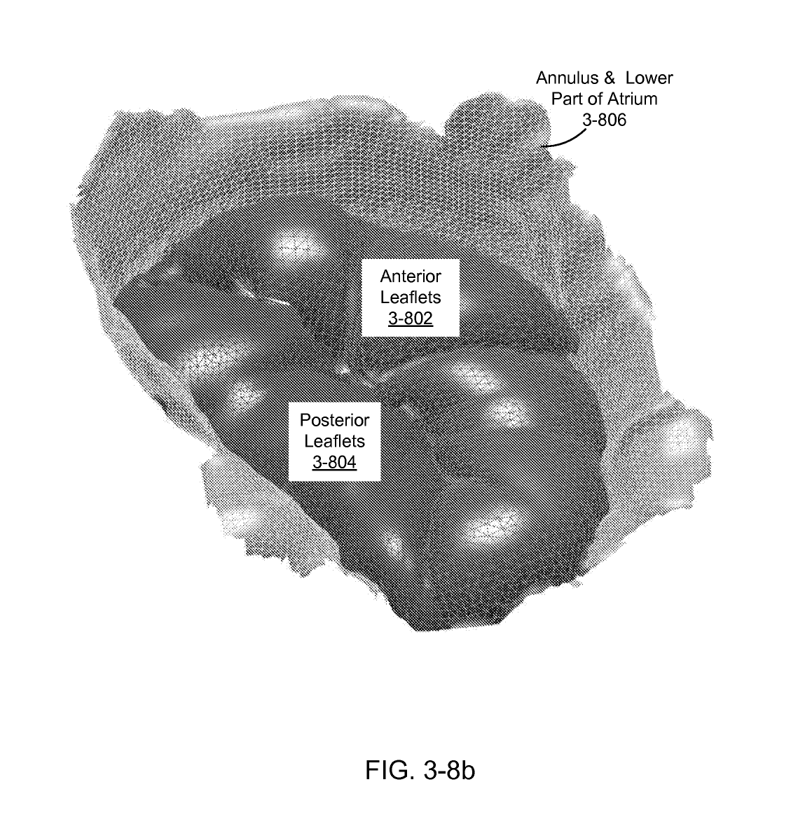

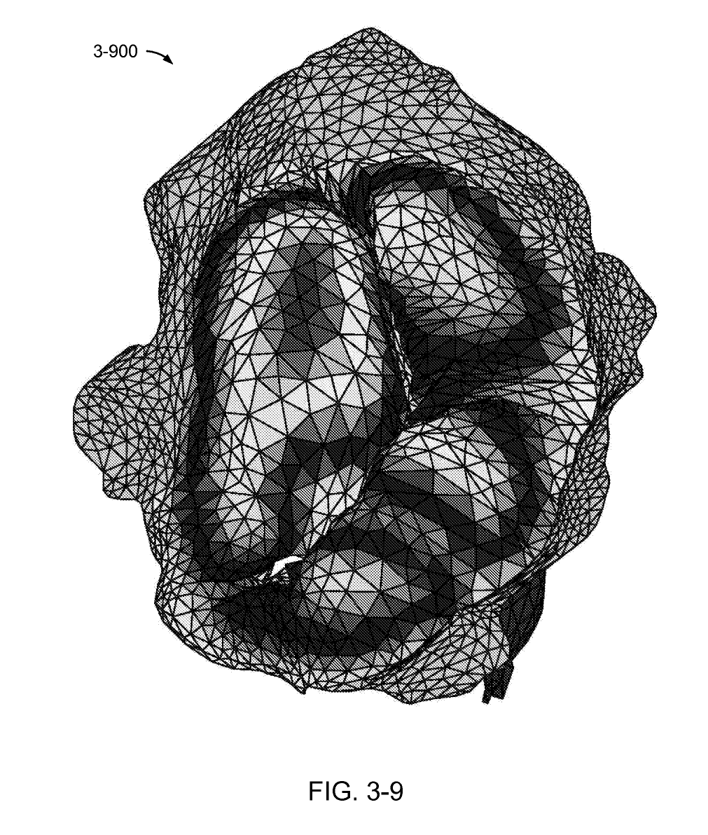

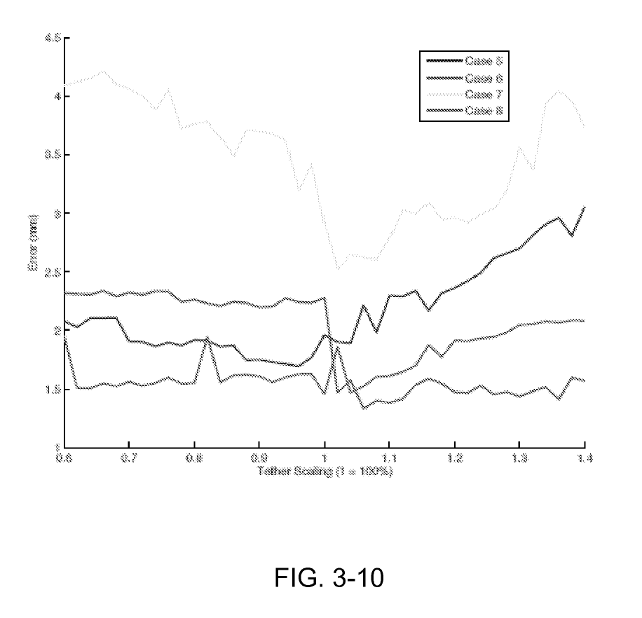

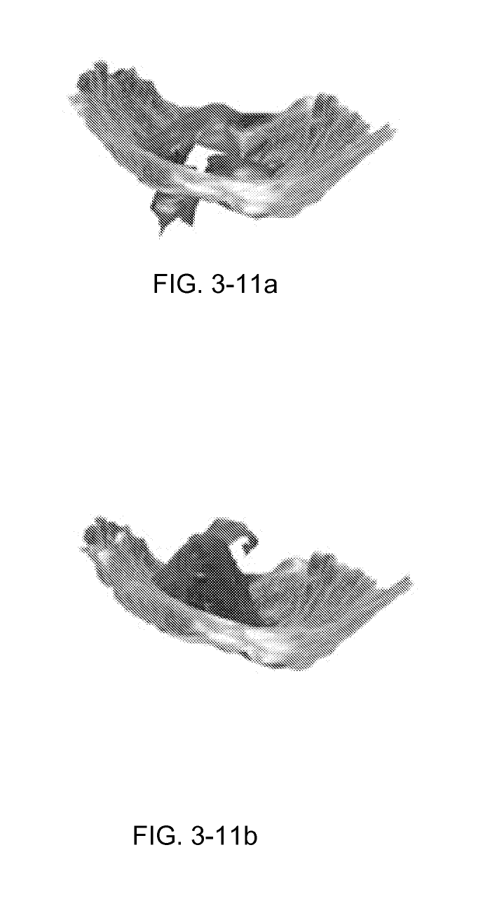

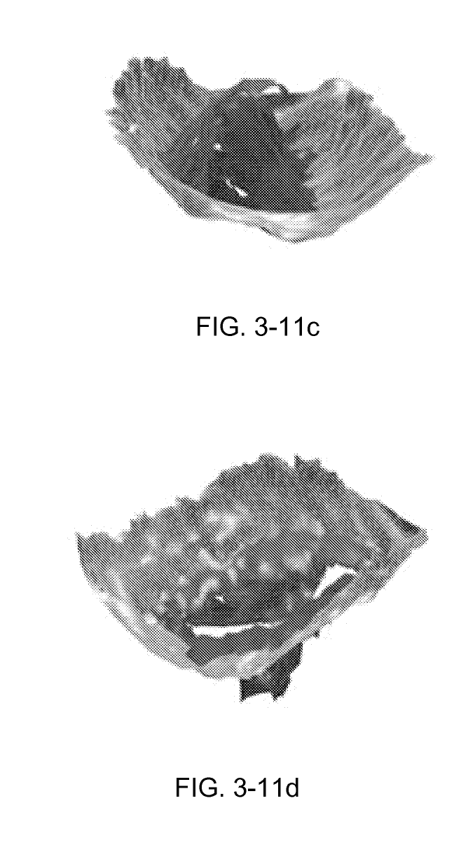

FIG. 2-3 is a graph 2-302 of 3D flow vectors computed using the variational method on US data that have been synthetically laterally deformed by 6 percent (i.e., α=1.06, β=1/1.06, and γ=1).

For further comparison, a correlation-based optical flow approach was implemented and evaluated using the experimentally-obtained data. The correlation-based optical flow approach computes the cross-correlation coefficient r across a given search window centered around every 5×5×5 volume:

$$r = \frac{\sum ( I ( x , t ) I ( x + u , t + 1 ) )}{\sqrt{\sum ( {I ( x , t )}^{2} ) \vert \sum ( {I ( x + u , t + 1 )}^{2} )}} . \qquad EQ . ( 2 \text{-} 10 )$$

Translation, rotation, and deformation transformations were applied to intraoperative data and errors were calculated for both methods. Translation was performed by shifting a sub-cube of the data by a known number of voxels in the lateral, elevational, or axial direction.

Translation may be expressed by the following equation:

$$( \begin{matrix}{x}^{′} \\ {y}^{′} \\ {z}^{′}\end{matrix} ) = ( \begin{matrix}x \\ y \\ z\end{matrix} ) + ( \begin{matrix}u \\ v \\ w\end{matrix} ) . \qquad EQ . ( 2 \text{-} 11 )$$

Tables 2-2 and 2-3 compare angular and endpoint error values between the variational technique presented herein and the correlation-based technique as computed using the experimental data. The correlation-based technique returned zero angular and endpoint error across all translations tested, whereas the variational technique recorded near-zero angular and endpoint error values, with angular error values decreasing as the amount of translation increased.

TABLE 2-2
(Angular error comparison for synthetic translation of intra-operative
data).

| | Variational | | Cross-correlation | |
|---|---|---|---|---|
| Translation | Mean | SD | Mean | SD |
| 1 voxel | 0.09 degrees | 0.73 degrees | 0 degrees | 0 degrees |
| 2 voxels | 0.06 degrees | 0.46 degrees | 0 degrees | 0 degrees |
| 3 voxels | 0.04 degrees | 0.33 degrees | 0 degrees | 0 degrees |
| 4 voxels | 0.03 degrees | 0.26 degrees | 0 degrees | 0 degrees |
| 5 voxels | 0.03 degrees | 0.20 degrees | 0 degrees | 0 degrees |
| 6 voxels | 0.02 degrees | 0.16 degrees | 0 degrees | 0 degrees |

TABLE 2-3
(Endpoint error comparison (voxels) for synthetic translation of intra-
operative data).

| | |
|---|---|
| Variational | Cross-correlation |

| Translational | Mean | SD | Mean | SD |
|---|---|---|---|---|
| 1 voxel | 0 | 0.02 | 0 | 0 |
| 2 voxels | 0 | 0.02 | 0 | 0 |
| 3 voxels | 0 | 0.02 | 0 | 0 |
| 4 voxels | 0 | 0.02 | 0 | 0 |
| 5 voxels | 0 | 0.02 | 0 | 0 |
| 6 voxels | 0 | 0.02 | 0 | 0 |

Rotation and deformation transformations may be computed using the following equation:

$$( \begin{matrix}{x}^{′} \\ {y}^{′} \\ {z}^{′}\end{matrix} ) = {( \begin{matrix}α cos θ & - β sin θ & 0 \\ α sin θ & β cos θ & 0 \\ 0 & 0 & γ\end{matrix} )}^{- 1} ( \begin{matrix}x \\ y \\ z\end{matrix} ) , \qquad EQ . ( 2 \text{-} 12 )$$

where α, β, and γ, restricted to αβγ=1 by an incompressibility constraint, represent the amount of lateral, elevational, and axial deformation, and where θ represents the amount of rotation about the z axis (i.e., the 3D US axial direction).

Tables 2-4 and 2-5 compare flow error values for transformations, where α, β, and γ are all set equal to 1 (i.e., no deformation), and θ is varied according to the number of degrees of rotation desired.

TABLE 2-4
Angular error comparison for synthetic rotation of intra-operative data).

| | Variational | | Cross-correlation | |
|---|---|---|---|---|
| Rotation | Mean | SD | Mean | SD |
| 1 degree | 0.73 degrees | 2.64 degrees | 1.43 degrees | 7.95 degrees |
| 2 degrees | 0.78 degrees | 2.83 degrees | 2.22 degrees | 10.03 degrees |
| 3 degrees | 1.01 degrees | 3.91 degrees | 3.55 degrees | 12.32 degrees |
| 4 degrees | 1.13 degrees | 5.26 degrees | 9.43 degrees | 21.34 degrees |
| 5 degrees | 1.28 degrees | 6.40 degrees | 21.79 degrees | 34.22 degrees |
| 6 degrees | 1.52 degrees | 7.86 degrees | 35.43 degrees | 41.54 degrees |

TABLE 2-5
(Enpoint error comparison (voxels) for synthetic
rotation of intra-operative data).

| | |
|---|---|
| Variational | Cross-correlation |

| Rotation | Mean | SD | Mean | SD |
|---|---|---|---|---|
| 1 degree | 0.02 | 0.09 | 0.04 | 0.22 |
| 2 degrees | 0.04 | 0.14 | 0.09 | 0.41 |
| 3 degrees | 0.07 | 0.20 | 0.26 | 0.75 |
| 4 degrees | 0.10 | 0.31 | 0.93 | 1.60 |
| 5 degrees | 0.14 | 0.43 | 2.14 | 2.68 |
| 6 degrees | 0.18 | 0.61 | 3.55 | 3.42 |

Tables 2-6 and 2-7 compare error values in lateral deformation, which is obtained by setting θ to 0, γ to 1, and adjusting α, and consequently β, according to the percentage of deformation desired.

TABLE 2-6
(Angular error comparison for synthetic lateral
deformation of intra-operative data).

| Axial | | | | |
|---|---|---|---|---|
| defor- | Variational | | Cross-correlation | |
| mation | Mean | SD | Mean | SD |
| 1% | 1.16 degrees | 0.94 degrees | 20.77 degrees | 7.75 degrees |
| 2% | 1.15 degrees | 0.71 degrees | 14.05 degrees | 8.58 degrees |
| 3% | 1.39 degrees | 0.67 degrees | 10.98 degrees | 7.60 degrees |
| 4% | 1.71 degrees | 0.72 degrees | 9.36 degrees | 8.54 degrees |
| 5% | 2.07 degrees | 0.81 degrees | 8.78 degrees | 10.22 degrees |
| 6% | 2.44 degrees | 0.92 degrees | 9.20 degrees | 12.31 degrees |

TABLE 2-7
(Enpoint error comparison (voxels) for lateral
deformation of intra-operative data).

| | |
|---|---|
| Variational | Cross-correlation |

| Axial Deformation | Mean | SD | Mean | SD |
|---|---|---|---|---|
| 1% | 0.02 | 0.02 | 0.46 | 0.24 |
| 2% | 0.03 | 0.02 | 0.41 | 0.29 |
| 3% | 0.05 | 0.03 | 0.41 | 0.25 |
| 4% | 0.09 | 0.04 | 0.44 | 0.37 |
| 5% | 0.13 | 0.06 | 0.51 | 0.58 |
| 6% | 0.18 | 0.08 | 0.68 | 0.85 |

Note that 1% lateral deformation is achieved when α=1.10 and

$$β = \frac{1}{1.01} .$$

Tables 2-8 and 2-9 compare error values for lateral-axial deformation, which is obtained by varying γ together with α as in the lateral deformation case. Lateral-axial deformation involves deformation in all three axes because the elevational axis is forced to expand due to the incompressibility constraint when the lateral and axial axes are compressed.

TABLE 2-8
(Angular error comparison for synthetic axial-lateral
deformation of intra-operative data)

| | | |
|---|---|---|
| | Variational | Cross- |
| Axial-lateral | (degrees) | correlation |

| deformation | Mean | SD | Mean | SD |
|---|---|---|---|---|
| 1% | 1.47 | 1.15 | 20.69 | 9.78 |
| 2% | 1.61 | 0.79 | 22.82 | 12.71 |
| 3% | 2.05 | 0.82 | 33.14 | 21.75 |
| 4% | 2.60 | 0.95 | 44.49 | 28.14 |
| 5% | 3.16 | 1.12 | 54.81 | 31.40 |
| 6% | 3.71 | 1.29 | 62.82 | 32.33 |

TABLE 2-9
(Endpoint error comparison (voxel) for synthetic
axial-lateral deformation of intra-operative data)

| | |
|---|---|
| Variational | Cross-correlation |

| Axial-lateral deformation | Mean | SD | Mean | SD |
|---|---|---|---|---|
| 1% | 0.04 | 0.03 | 0.54 | 0.24 |
| 2% | 0.08 | 0.04 | 0.96 | 0.60 |
| 3% | 0.15 | 0.07 | 1.85 | 1.20 |
| 4% | 0.26 | 0.12 | 2.92 | 1.69 |
| 5% | 0.39 | 0.19 | 4.04 | 2.08 |
| 6% | 0.55 | 0.26 | 5.12 | 2.38 |

Tables 2-10 and 2-11 compare error values for lateral-axial deformation, as described above, combined with rotation.

TABLE 2-10
(Angular error comparison for synthetic axial-lateral
deformation and rotation of intra-operative data)

| | | |
|---|---|---|
| | Variational | Cross- |
| Axial-lateral | (degrees) | correlation |

| deformation | Mean | SD | Mean | SD |
|---|---|---|---|---|
| 1% of 1 degree | 1.32 | 1.08 | 18.69 | 10.35 |
| 2% of 2 degrees | 1.38 | 1.15 | 26.51 | 21.24 |
| 3% of 3 degrees | .167 | 1.44 | 41.96 | 32.16 |
| 4% of 4 degrees | 2.17 | 1.97 | 53.67 | 35.29 |
| 5% of 5 degrees | 2.70 | 2.45 | 61.86 | 35.65 |
| 6% of 6 degrees | 4.23 | 2.87 | 67.63 | 35.12 |

TABLE 2-11
(Endpoint error comparison (voxel) for synthetic axial-lateral
deformation and rotation of intra-operative data)

| | | |
|---|---|---|
| Deformation | Variational | Cross-correlation |

| and rotation | Mean | SD | Mean | SD |
|---|---|---|---|---|
| 1% + 1 degree | 0.04 | 0.04 | 0.61 | 0.39 |
| 2% + 2 degrees | 0.09 | 0.08 | 1.57 | 1.42 |
| 3% + 3 degrees | 0.16 | 0.15 | 3.02 | 2.43 |
| 4% + 4 degrees | 0.29 | 0.27 | 4.48 | 3.18 |
| 5% + 5 degrees | 0.46 | 0.42 | 5.88 | 3.86 |
| 6% + 6 degrees | 0.66 | 0.61 | 7.24 | 4.53 |

In each rotation and/or deformation experiment, lower angular and endpoint error values are observed for the variational method when compared with the correlation-based method. Across all the synthetic experiment tables, the variational method's error values increase steadily as the amount of rotation and/or deformation increases.

In some cases (e.g., Tables 2-4 and 2-5), the correlation-based method experiences a sudden increase in error values after a certain amount of rotation and/or deformation. Also, in the case of lateral deformation (i.e., Tables 2-6 and 2-7), the angular and endpoint error values of the correlation-based method improve as deformation increases from 1% to 3% and subsequently deteriorate as deformation further increases from 4% to 6%.

3. Phantom Data

To account for various challenges of US imagery (e.g., attenuation, shadowing, reverberation, speckle de-correlation, and polar-to-Cartesian conversion artifacts) in the quantitative assessment, a series of experiments was performed on data obtained using a multipurpose tissue-equivalent US phantom, Model #84-317 (Nuclear Associates, Carle Place, N.Y.).

The phantom includes Zerdine, a solid-elastic water-based polymer that is designed to emulate liver tissue. Embedded within the phantom are numerous nylon wires and cyst-like structures to provide a degree of heterogeneity to the data. Still, a majority of the phantom's volume is relatively uniform and featureless, and this uniformity makes the computation of flow even more difficult.

US acquisition was performed using a SonixTouch research console and a 4DC7-3/40 probe (Ultrasonix, Vancouver, BC, Canada). The probe contains 128 elements in a curved linear array that is panned back and forth by a motor in 410 steps, where each step tilts the array by 0.183 degrees.

Volumes with a resolution of 484×364×90 were collected using a depth of 15 cm, a transmit frequency of 3.3 MHz, and a focus depth of 7.5 cm, resulting in an approximate spatial resolution of 0.485 mm. The US probe and phantom were placed inside an apparatus that maintained their positions, contacting the probe with the phantom, and allowed for controlled and measurable movement.

FIG. 2-4 is an image 2-400 of the phantom apparatus, including a 4D abdominal probe, 2-402, held in place to contact a multi-purpose tissue-equivalent US phantom, 2-404.

An initial series of experiments was performed by translating the phantom a known distance.

FIG. 2-5 is an image 2-502 of a sample frame pair, including two overlaid long-axis slices (one blue, the other red), showing 6 mm translation phantom movement.

The probe's surface is slightly larger and more curved than the surface of the phantom, so a portion of each volume collected included masking to prevent the computation of flow outside the boundaries of the phantom.

Angular and endpoint error values for both the variational and the correlation-based methods are presented in Tables 2-12 and 2-13.

TABLE 2-12
(Phantom Translation Angular Error Comparison)

| | Variational | | Cross-correlation | |
|---|---|---|---|---|
| Translation | Mean | SD | Mean | SD |
| 1 mm | 15.68 degrees | 9.27 degrees | 26.10 degrees | 24.07 degrees |
| 2 mm | 14.98 degrees | 15.46 degrees | 27.67 degrees | 33.92 degrees |
| 3 mm | 13.55 degrees | 18.97 degrees | 46.77 degrees | 43.37 degrees |
| 4 mm | 13.87 degrees | 20.39 degrees | 71.93 degrees | 42.29 degrees |
| 5 mm | 16.88 degrees | 25.42 degrees | 81.02 degrees | 39.40 degrees |
| 6 mm | 20.10 degrees | 29.27 degrees | 83.68 degrees | 38.84 degrees |

TABLE 2-13
(Phantom Translation Enpoint Error Comparison)

| | |
|---|---|
| Variational | Cross-correlation |

| Translational | Mean | SD | Mean | SD |
|---|---|---|---|---|
| 1 mm | 0.36 | 0.19 | 0.95 | 1.01 |
| 2 mm | 0.60 | 0.48 | 1.37 | 1.35 |
| 3 mm | 0.97 | 1.01 | 2.86 | 2.21 |
| 4 mm | 1.47 | 1.63 | 5.48 | 2.24 |
| 5 mm | 2.35 | 2.51 | 7.68 | 2.19 |
| 6 mm | 3.49 | 3.44 | 9.61 | 2.21 |

Both the variational and the correlation-based technique exhibit a significant increase in angular and endpoint error values when compared with the synthetic translation experiments. Also, the variational technique shows consistently lower angular and endpoint error values than the correlation-based method, and both technique display an increase in error values as the amount of phantom translation increases.

When compared with conventional optical flow and speckle tracking techniques used with 4D echocardiography, techniques disclosed herein show notable improvements in error rates. The performance improvements may have a positive impact when the technique is used as input for various applications, such as strain computation, biomechanical modeling, and/or automated diagnostics.

Some of the metrics used herein to compare techniques are currently used by researchers. Usefulness or meaningfulness of results shown in the comparisons herein may be affected by one or more of a variety of factors.

For example, the comparisons herein do not merely process the same data. Tables 2-14 and 2-15 contain error values for 2D versions of the variational and correlation-based methods, as run on the Middlebury public dataset (Baker et al. 2007). Specifically, Table 2-14 provides error in degrees and pixels, using the variational method in 2D for images in the Middlebury public dataset (Baker et al. 2007). Table 2-15 provides error in degrees and pixels, using the correlation-based technique in 2D for images in the Middlebury public dataset (Baker et al. 2007).

Tables 2-14 and 2-15 are provided to demonstrate the relatively large variation in error values across varying test data. In the case of the 4D TEE data, large variations in the error values may be due to differences in intensity uniformity among sets of test data (size and location of regions where optical flow is difficult to compute) as well as by motion magnitude.

TABLE 2-14

| | Angular error | | Endpoint error | |
|---|---|---|---|---|
| Image pair | Mean | SD | Mean | SD |
| Dimetrodon | 3.21 degrees | 5.71 degrees | 0.21 | 0.33 |
| Grove2 | 2.87 degrees | 8.07 degrees | 0.20 | 0.47 |
| Grove3 | 7.36 degrees | 18.71 degrees | 0.81 | 1.54 |
| Hydrangea | 2.67 degrees | 7.59 degrees | 0.26 | 0.51 |
| Rubber Whale | 10.14 degrees | 27.05 degrees | 0.23 | 0.49 |
| Urban2 | 4.40 degrees | 13.38 degrees | 0.48 | 1.49 |
| Urban3 | 6.57 degrees | 24.03 degrees | 0.80 | 1.96 |
| Venus | 12.41 degrees | 34.53 degrees | 0.65 | 1.01 |

TABLE 2-15

| | Angular error | | Endpoint error | |
|---|---|---|---|---|
| Image pair | Mean | SD | Mean | SD |
| Dimetrodon | 17.71 degrees | 26.84 degrees | 0.79 | 1.13 |
| Grove2 | 13.77 degrees | 24.87 degrees | 0.83 | 1.14 |
| Grove3 | 39.42 degrees | 43.41 degrees | 2.90 | 3.18 |
| Hydrangea | 25.70 degrees | 39.18 degrees | 1.88 | 2.11 |
| Rubber Whale | 11.92 degrees | 17.17 degrees | 0.42 | 0.62 |
| Urban2 | 54.06 degrees | 46.70 degrees | 7.97 | 8.50 |
| Urban3 | 68.43 degrees | 51.45 degrees | 7.01 | 5.21 |
| Venus | 42.46 degrees | 45.48 degrees | 2.90 | 2.80 |

The term motion magnitude, as used herein, such as with respect to the synthetic experiments described above, in which motion magnitude is seemingly controlled, is described below with reference to the rotation transformation as an example.

To generate Tables 2-4 and 2-5, intraoperative data is rotated about the center of each 224×208×208 cube. As a result, voxels farther from the center of rotation undergo larger displacements. But because each intraoperative data set contains varying levels of contrast and different tissue distributions, and because flow is not computed in empty and/or blood-filled cavities, the amount of motion present in a pair of synthetically rotated frames may vary. Thus, to present a proper comparison of methods using identical data, a commonly-used correlation-based approach is used.

Based on the comparisons performed, the variational technique shows improvements in error values that may have a positive impact, such as when the technique is applied to a broader algorithmic pipeline.

As shown in Tables 2-2 and 2-3, both the variational and correlation-based methods exhibit low angular and endpoint error for synthetic translation experiments. Because synthetic translation does not result in any de-correlation, the correlation-based flow matches the ground-truth. On the other hand, the smoothness constraint and coarse-to-fine approach used by the variational method causes it to return flow with very small amounts of error because it contends with handling of the sudden flow changes at the translated sub-cube's boundaries. Error values for rotation and deformation transformations, presented in Tables 2-4 through 2-11, show a relatively sizable performance improvement for the variational technique over the correlation-based technique.

For both techniques, angular and endpoint error rise steadily as the number of degrees of rotation or percent of deformation increases. However, the average endpoint and angular error values of the variational technique are consistently lower than the error values of the correlation-based technique, at times recording up to a 20-fold improvement in the case of rotation, and a four-fold improvement in the case of deformation.

The standard deviation of endpoint and angular error values for flow returned by the variational technique are also consistently and relatively significantly lower than for the correlation-based technique. Of note is the fact that the endpoint and angular error of flow returned by the correlation-based technique suddenly increases after 4 degrees of rotation. The sudden increase may be due to the magnitude of flow vectors extending beyond the range of the 7×7×7 search window used by the correlation-based technique.

Phantom flow comparisons are also performed. The phantom data used contains noise, artifacts (discussed further below), and a limited number of features for optical flow algorithms to track easily, thus making it a more realistic and difficult problem to solve.

Sensitivity to noise of early differential methods is a common rationale for the use of correlation-based techniques. Citing modern 2D performance comparisons, which use data sets with a variety of noise levels, modern variational techniques may outperform region-based methods in terms of noisy imagery.

This is confirmed by the phantom flow experiments. As can be seen in Tables 2-12 and 2-13, the variational approach performs significantly better than the correlation-based approach in terms of translational phantom data. Although the correlation-based approach matches some regions in the phantom, the high amount of noise and lack of features cause it to produce flow vectors with relatively high error values, as seen in FIGS. 2-6a and 2-6b.

FIG. 2-6a is a 3D graph 2-600 of 3D flow vectors for a pair of phantom images containing a translation of 6 mm, computed based on the correlation technique disclosed herein.

FIG. 2-6b is a 3D graph 2-602 of 3D flow vectors for a pair of phantom images containing a translation of 6 mm, computed based on the variational technique disclosed herein.

The variational approach, on the other hand, with the aid of a smoothness constraint and coarse-to-fine technique, is able to match the sparse nylon features and produce relatively consistent flow vectors across the entire volume of the phantom, as seen in FIGS. 2-6a and 2-6b.

As noted further above, optical flow results generated from real intraoperative sequences using the variational method were also evaluated by a cardiologist. The evaluation provides qualitative insight into the performance of the algorithm when applied to real clinical data. Although the synthetic and phantom experiments discussed above help to characterize algorithmic performance operating on images of varying motion magnitude and noise, they do not incorporate all the complexities of physiologic heart motion. For example, the synthetic rotation experiments test unidirectional rotation only. In healthy individuals, the ventricle exhibits a twisting motion as it contracts and expands, resulting in opposite rotation at the basal and apical regions of the ventricle. Qualitative evaluation of intraoperative flow results by a cardiologist provides confirmation of satisfactory algorithmic performance on imagery containing more complex motion and supplements the quantitative synthetic and phantom evaluations.

The intraoperative data evaluated included of 4D TEE imagery. TEE images are characterized by having the left atrial cavity closest to the probe, separated from the left ventricle (LV) chamber, seen at the bottom of the frustum, by the mitral annulus and the mitral valve apparatus (valve leaflets). The computed flow movement in each sequence appears complex, but the overall assessment may be broadly summarized as follows. During the first phase of the heart cycle, the mitral valve leaflets open and the flow vectors on the leaflets correctly point downward toward the apex of the left ventricle. At the same time, the myocardial wall relaxes and the computed flow vectors on the myocardium are seen moving outward toward the peripheral part of the field. These two movements happen together and correctly represent the diastolic portion of the cardiac cycle.

After the LV cavity fills with blood, opposite computed flow vectors on both structures are observed. Flow vectors lying on the mitral valve leaflets point up toward the left atrium and, as the myocardium contracts and shortens its length, the myocardial flow vectors point inward toward the apex and center of the LV cavity, drawing a curve with an inside-cavity direction. At the end of the systolic phase, during isovolumic relaxation, as the atrium fills up and starts a descending motion, the vectors on the mitral valve reverse direction and point downward.

There are several intricacies in clinical data that may affect optical flow results. For example, signal attenuation may degrade contrast and, as a result, make it more difficult to match voxel intensities and compute optical flow for objects farther away from the US probe. Shadowing and reverberation may obscure texture or create spurious texture that detracts from the true motion present in a cube. Polar-to-Cartesian conversions may artificially stretch or compress features. Stitching artifacts resulting from the seven-breath-hold protocol may result in chunks of a cube being artificially translated. In addition, limited acquisition frame rates may mean that fast-moving tissue, such as the mitral valve, will have large displacements between pairs of frames, which can result in increased error, as shown in the synthetic experiments.

Despite these factors, after running the variational method across sequences of varying image qualities and frame rates, all but 1 sequence obtained the highest marks from a cardiologist for following physiological motion, as shown in Table 2-1.

One or more techniques disclosed herein may be applicable to TTE data. Compared to TEE, TTE generally entails additional signal attenuation because it traverses skin and fat layers. TTE imagery may also contain more significant shadowing caused by the ribs and additional reverberation caused by the lungs and pleural interfaces. In addition, patient-specific conditions, such as emphysema, obesity, and rib cage deformities, may worsen the aforementioned artifacts. The clinical TEE data and phantom data used in the experiments described above contain shadowing, attenuation, and reverberation effects, albeit to a lesser degree than TTE data. Nevertheless, performance comparisons herein may be useful in applying techniques disclosed herein with respect to TTE data.

Another factor is application of techniques disclosed herein to more complex algorithmic pipelines, such as to track tissue. In such a situation, without correction, flow estimation errors may compound over time. In other words, without correction, residual flow estimation errors in each frame may accumulate, which may result in increased error as an object is tracked over a sequence of frames.

Also, as can be seen in the comparisons presented herein, both optical flow techniques perform better on images with less movement (fewer degrees of rotation, less deformation, etc.). Motion difference between two frames in a sequence may be achieved by capturing data at a higher frame rate. Conventional clinical systems, however, operate at frame rates significantly lower than needed for correlation-based techniques to maintain reasonable errors, especially with respect to rapid-motion systems, such as heart structures. Variational techniques disclosed herein may show more significant improvement relative to correlation-based techniques when used in real-world applications.

Techniques disclosed herein to estimate dense 3D myocardial displacement from 4D TEE may be used or applied with respect to one or more of a variety of procedures and/or systems such as, for example, biomechanical simulation, myocardial strain computation, elastography, and/or automated diagnostics of pathologies, such as HCM.

Flow estimation techniques disclosed herein may be used or applied with respect to characterization and/or clinical validation of pathologies such as HCM and mitral valve disease. For example, optical flow may be computed for a mitral valve. As another example, variational motion flow techniques may be used or applied with respect to clinical diagnostics.

Experimental results are presented herein for the variational technique as applied to 4D TEE data. The variational technique is not, however, limited to 4D TEE data and may be applied to, without limitation, TTE data and/or motion computed from tagged MRI imagery.

### III. Patient-Specific Modeling of Anatomical Feature Motion

Disclosed below are real-time 3D (RT3D)-guided physics-based modeling and simulation techniques with static load analysis and optimization, and realistic physiological forces.

Techniques disclosed below may be implemented to predict movement, motion, and/or positional information of biological features, such as tissue, based on the patient-specific anatomical information derived from 3D ultrasound image data. Methods and systems are described below with respect to prediction of MV closure based on the patient-specific 3D TEE. The methods and systems are not, however, limited to the MV or 3D TEE.

3D TEE poses a number of challenges. For example 3D TEE may provide lower spatial resolution compared to micro-CT, and may exhibit more imaging artifacts such as noise and obscuration compared to CT and MRI.

Another challenge is that some 3D TEE platforms need to acquire and recombine subsections of the TEE data cube obtained over several heart cycles using a breath-hold protocol to achieve both high spatial and temporal resolutions. When the patient exhibits arrhythmias, the stitching of the TEE data cube subsections may lead to misalignment artifacts.

Another challenge is that 3D TEE may entail self-shadowing of the valve leaflets.

Despite these challenges, 3D TEE has a number of advantages for purposes herein, compared to CT and MRI. For example, 3D TEE is already part of the established clinical cardiology workflow. It has a small form factor, is non-ionizing, has lower costs, can be used pre-operatively and intra-operatively, and allows for interactive exploration and diagnostics.

Another advantage of 3D TEE is its speed, which is unmatched by other modalities. Current 3D TEE platforms can acquire volumetric images at rates from 20 Hz up to over 50 Hz. Higher rates have been reported in recent commercial platforms. Speed is important when imaging rapid motion, such as the such as the coaptation phase of the MV during which the leaflets initially close, which can occur over less than 50 ms.

Prior modeling studies, including patient-specific and non-patient-specific studies, resort to FEM models or dynamic models, which depend on a number of parameters that cannot be measured or easily estimated.

Techniques disclosed below exploit patient-specific structural information derived from semi-automated segmentation of 3D TEE, and MV modeling based on a stationary technique and an energy minimization technique. Valve configuration may be determined by solving a shape finding problem using a stationary method and an energy minimization approach. The full valve anatomy (annulus and leaflets) may be modeled.

Techniques disclosed below may be implemented with one or more of:
physiological blood loading forces (with direction along the leaflet surface normals and with physiological pressure);
linear elastic forces based on the Saint Venant-Kirchhoff model, tuned to approximate the empirical MV leaflets' strain-stress behavior found by May-Newman;
physiological values for other entities; and
marginal and basal chordae for modeling.

Techniques disclosed below may be further implemented with one or more of:
patient-specific chordal lengths;
personalized annulus shapes; and
patient-specific annulus deformations between open and closed configurations.

### A. Modeling of Mitral Valve Closure

FIG. 3-1 is a flowchart 3-100 of a method of modeling mitral valve closure.

At 3-102, valve anatomy is recovered via segmentation.

At 3-104, segmentation data may be refined by an expert.

At 3-106, a mesh is generated from segmentation data.

At 3-108, the mesh is used in a simulation process to predict the closed position from the open position.

At 3-110, one or more parameters may be estimated, such as tether lengths.

After parameters are estimated at 3-110, the resultant model may be used to for predictive purposes. For example, the mesh may be modified at 3-112 in a way that would reflect various surgical options, such as the re-section of part of a valve leaflet or modifications of the chordae tendineae. Closure of the valve mesh may then be modeled for a proposed or contemplated surgical modification or procedure. This may, for example, permit a clinician to assess the degree of leaflet coaptation resulting from the proposed modification.

Recovery of the anatomical structure of the valve and the surrounding heart through segmentation, at 3-102 is described below.

1. Segmentation

3D segmentation of the mitral valve and surrounding left heart structure may be employed to recover a patient-specific open valve 3D structure at end diastole, to be used for mechanical modeling of the valve closure.

Segmentation may include a machine-implemented segmentation technique to recover relatively large structures, such as the lower LA, and smaller or finer structures, such as valve leaflets.

Machine-implemented segmentation may include structure tensor-based thin tissue detection, k-means clustering, and analysis of disparities of eigenvalues associated with a local intensity Hessian, such as disclosed further above. For example, a 3D TEE image at end diastole may be low-pass filtered. The structure tensor based thin tissue detection technique method is then applied to the filtered image, followed by k-means clustering (a union of the two is taken), and morphology may be used to remove noisy responses. Machine-generated segmentation data may be edited/modified by a user/expert, such as described further above. Segmentation may be applied around a window centered on the valve.

2. Lagrangian Modeling of the Mitral Valve System

A mesh may be constructed from the segmented valve data (i.e., from the machine-generated segmentation data, with or without user/expert modification).

The mesh describes the state of the valve system in the open position, and may be defined on the leaflets. Each node of the mesh introduces three degrees of freedom with which to determine a final closed configuration of the valve.

An energy term is associated with each node to represent external forces. The energy term may include components for one or more of blood pressure, internal strain energy, collision energy (which prevents intersection with other portions of the mesh), and tethering energy generated by chordae tendineae.

The energy term is then minimized to identify displacement taking the mesh from its open configuration to a stationary configuration point representing the mesh at closed position.

The mitral valve system may be modeled in the context of Lagrangian mechanics to tie the stationary method to first principles. The Lagrangian of the system may be expressed as:

L=φₖᵢₙ−φₚₒₜ EQ. (3-1)

where the kinetic energy □ₖᵢₙ from each MV mesh node i is:

$${φ}_{kin} = {\sum }_{i} \frac{1}{2} {M}_{i} {\dot{q}}_{i}^{2} \qquad EQ . ( 3 \text{-} 2 )$$

The variables qᵢ denote the degrees of freedom of the system, i.e. the x, y, z coordinates for the position of each node in the valve mesh, and the terms \dot{q}ᵢ are their time derivatives. Mᵢ are the masses associated with each element.

The potential energy is given by:

$${φ}_{pot} = {\sum }_{i} {φ}_{i}^{X} + {φ}_{i}^{E} + {φ}_{i}^{T} + {φ}_{i}^{C} \qquad EQ . ( 3 \text{-} 3 )$$

where φᵢ^{X} is the external energy, φᵢ^{E} is the strain energy, φᵢ^{T} is the tethering energy, and φᵢ^{C} is the collision energy. The expressions for these terms are provided further below.

Lagrange's equations are given by:

$$\frac{d ( \frac{\partial L}{\partial {\dot{q}}_{i}} )}{d t} - \frac{\partial L}{\partial {q}_{i}} = - \frac{\partial {F}_{i}^{diss}}{\partial {\dot{q}}_{i}} \qquad EQ . ( 3 \text{-} 4 )$$

where Fᵢ^{diss} is the Rayleigh dissipation function for each component i, defined by:

$${F}_{i}^{diss} = \frac{1}{2} C {\dot{q}}_{i}^{2} \qquad EQ . ( 3 \text{-} 5 )$$

An expression directly involving the dissipative force is obtained by considering that:

$${F}_{i} ≡ - \frac{\partial {F}_{i}^{diss}}{\partial \dot{q}} = - C {\dot{q}}_{i} \qquad EQ . ( 3 \text{-} 6 )$$

so that Lagrange's equations become:

$$\frac{d ( \frac{\partial L}{\partial {\dot{q}}_{i}} )}{d t} - \frac{\partial L}{\partial {q}_{i}} = {F}_{i} \qquad EQ . ( 3 \text{-} 7 )$$

EQ. (3-7) may serve as a basis for seeking the closure using a dynamic method taking the valve configuration from late diastole to systole.

Where conservative forces are used, as described herein, the potential energy may depend only on qᵢ. In this situation, the first term in Lagrange's equations only involves the kinetic energy and becomes:

$$\frac{d ( \frac{\partial L}{\partial {\dot{q}}_{i}} )}{d t} = M {\ddot{q}}_{i} \qquad EQ . ( 3 \text{-} 8 )$$

so that:

$$M {\ddot{q}}_{i} - \frac{\partial L}{\partial {q}_{i}} = {F}_{i} \qquad EQ . ( 3 \text{-} 9 )$$

Considering the system at the stationary position (i.e. at rest, where (\dot{q}=\ddot{q}=0), Lagrange's equations yield a necessary condition on the gradient of the Lagrangian of the stationary system:

$$\frac{\partial L}{\partial {q}_{i}} = 0 \qquad EQ . ( 3 \text{-} 10 )$$

or alternatively:

∇_{q}L=0 EQ. (3-11)

The stationary configuration is therefore found as the solution for the problem:

q*=argrin_{q}(φₚₒₜ) EQ. (3-12)

The initial state configuration of the open mesh may be used to specify the zero energy point for external (fluid pressure), elastic (strain), and tethering forces. The zero energy point for the collision force preventing mesh intersections is the configuration in which all facets of the mesh are not contacting (more specifically, further apart than a threshold distance δ). The closed state is found as the stationary point determined by solving the above energy minimization problem. Specification of the different additive components for the energy in φᵢ=φᵢ^{X}+φᵢ^{E}+φᵢ^{T}+φᵢ^{C} is now described.

3. Blood Loading Energy

Blood loading energy may be modeled as:

φᵢ^{X}=−p₀nᵢ·dᵢ EQ. (3-13)

where nᵢ is the surface normal at node i, p₀ is the blood pressure, and dᵢ is the displacement vector of node i.

For each facet on the valve leaflets, the direction of the blood pressure forces is specified to lie along the facet normal pointing toward the atrium. The pressure may be set to, for example, 13:3 kPa (or 100 mm Hg).

4. Strain Energy

Valve leaflets may be modeled as membranes. The second Piola-Kirchhoff stress at each facet j is denoted by Sⱼ and the Lagrangian Green strain at each facet by Eⱼ. The strain energy for each node i is given by:

$${φ}_{i}^{E} = \frac{1}{2} {\sum }_{j ∈ {A}_{i}} \frac{{A}_{j} d}{3} {S}_{j} \cdot {E}_{j} \qquad EQ . ( 3 \text{-} 14 )$$

where,

for each i, the sum is taken over the set Λᵢ of all adjacent facets

j containing the node i;

Aⱼ denotes the area of the un-deformed facet j; and

d denotes the membrane thickness.

For plane stress, the stress and strain tensors may be vectorized as E=(Eₓₓ,E_{yy},\sqrt{2}E_{xy})^{T} and Sⱼ=(Sₓₓ,S_{yy},\sqrt{2}S_{xy})^{T}. The stress-strain relationship may use the Saint Venant-Kirchhoff model:

Sⱼ=HEⱼ EQ. (3-15)

where the elasticity matrix H of the mesh may be written in terms of the Young modulus of elasticity, E, and the Poisson ratio, v, as:

$$H = \frac{E}{1 - {v}^{2}} ( \begin{matrix}1 & v & 0 \\ v & 1 & 0 \\ 0 & 0 & 1 - v\end{matrix} ) . \qquad EQ . ( 3 \text{-} 16 )$$

As an example, the Poisson ratio for the anterior and the posterior leaflets may be set to v=0:5 (the value for an incompressible material), leaflet thickness may be 1 mm, the Young modulus may be set to E=100 kPa for the posterior leaflet and E=400 kPa for the anterior leaflet. These values for the Young modulus are to reflect that the posterior leaflet is more pliable than the anterior leaflet, which should provide strains and stresses that are consistent with strain-stress MV leaflets behavior determined empirically in K. May-Newman and F. Yin, “A constitutive law for mitral valve tissue,” Journal of Biomechanical Engineering, vol. 120, p. 38, 1998, incorporated herein by reference in its entirety (hereinafter, May-Newman-Yin).

Resulting behavior of the stretch-stress function in the frame of reference of the deformed facets, using Cauchy stress, is plotted for different stretch situations and for the anterior and posterior leaflets in FIG. 3-2, 3-3, 3-4, and 3-5.

FIG. 3-2 includes an anterior σ_{bb} plot 3-204 and a posterior σ_{bb} plot 3-208.

FIG. 3-3 includes an anterior σₐₐ plot 3-302, an anterior σ_{bb} plot 3-304, a posterior σₐₐ plot 3-306, and a posterior σ_{bb} plot 3-308.

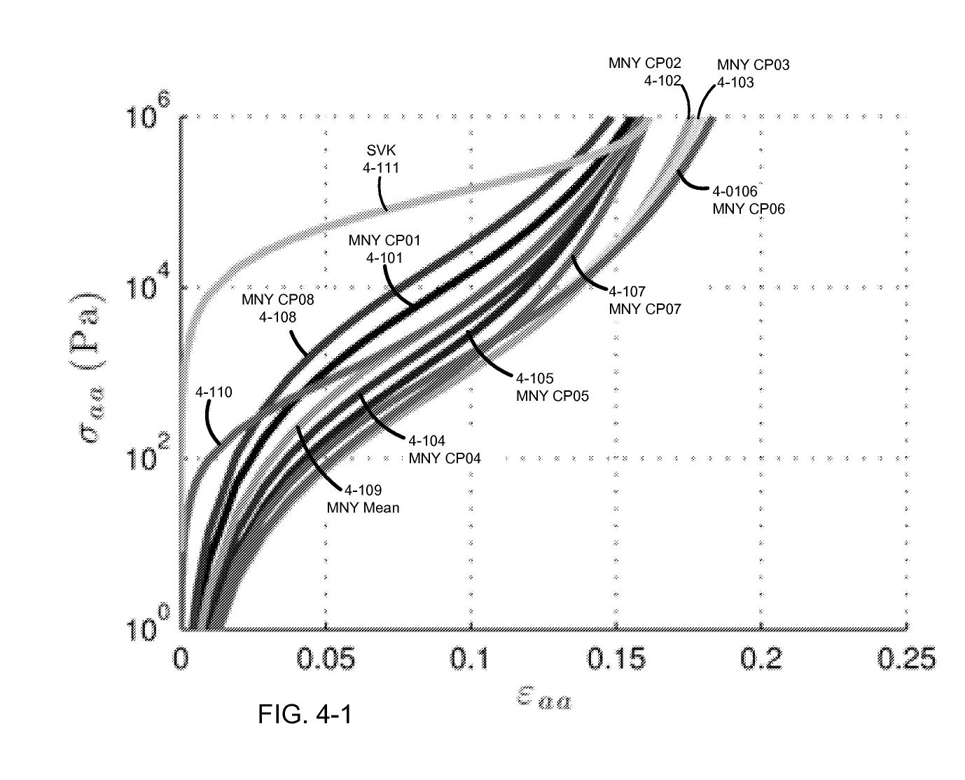

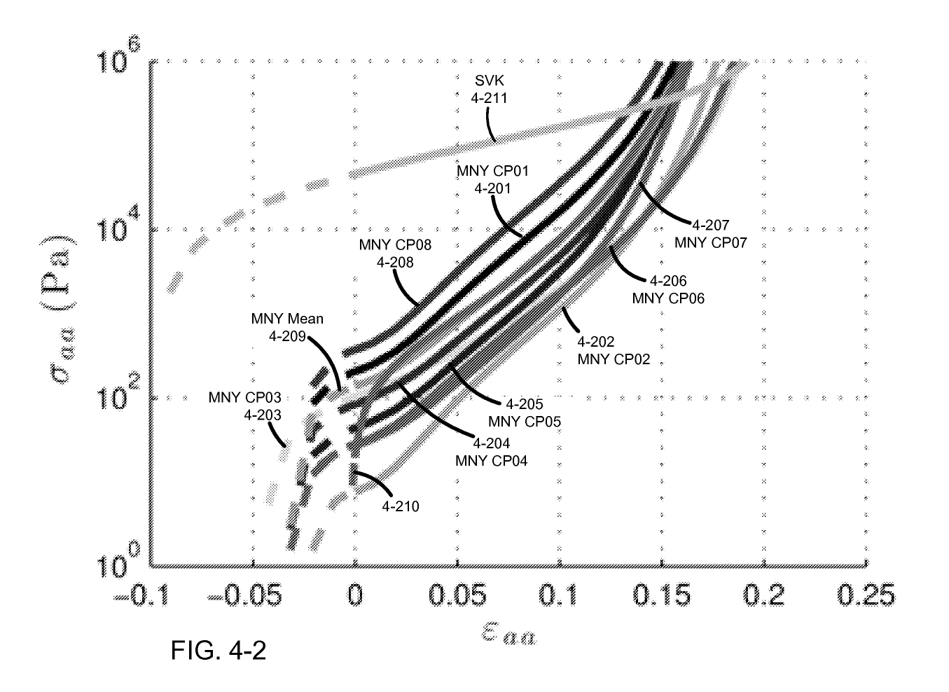

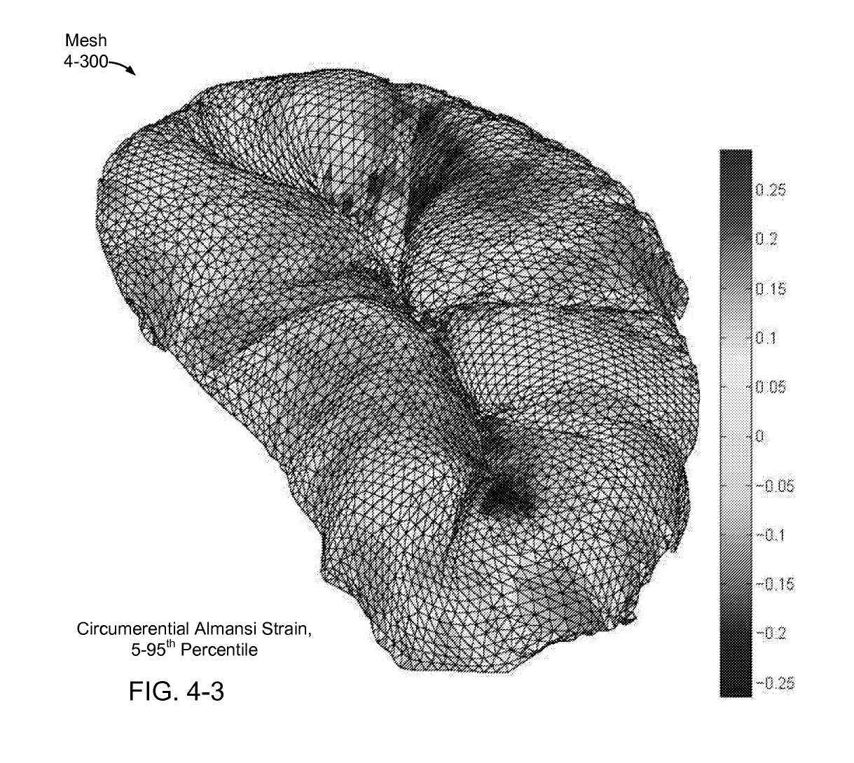

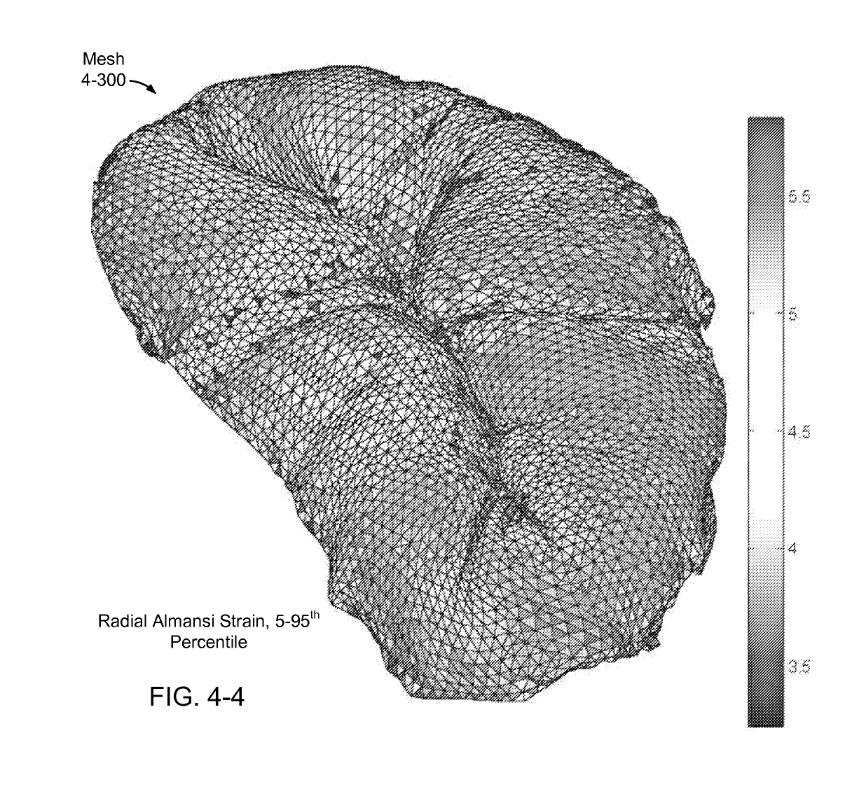

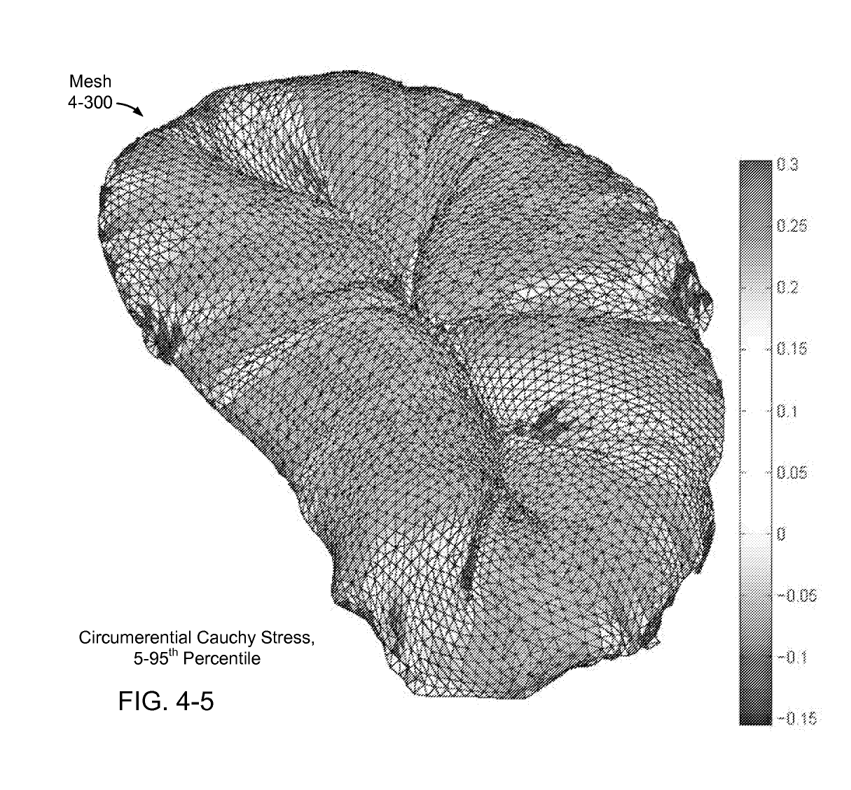

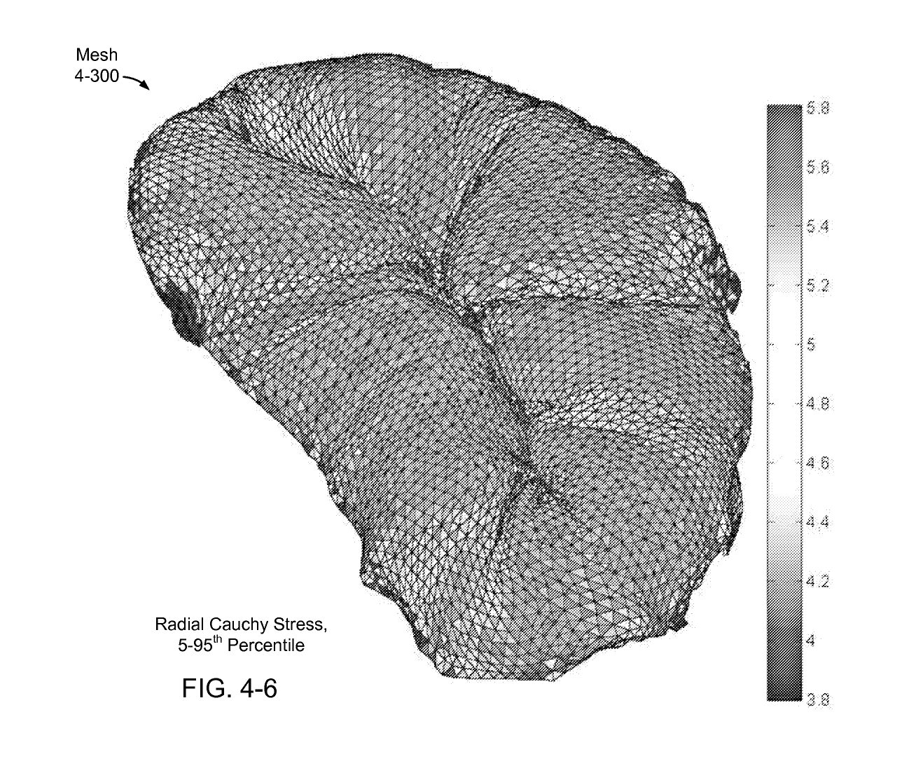

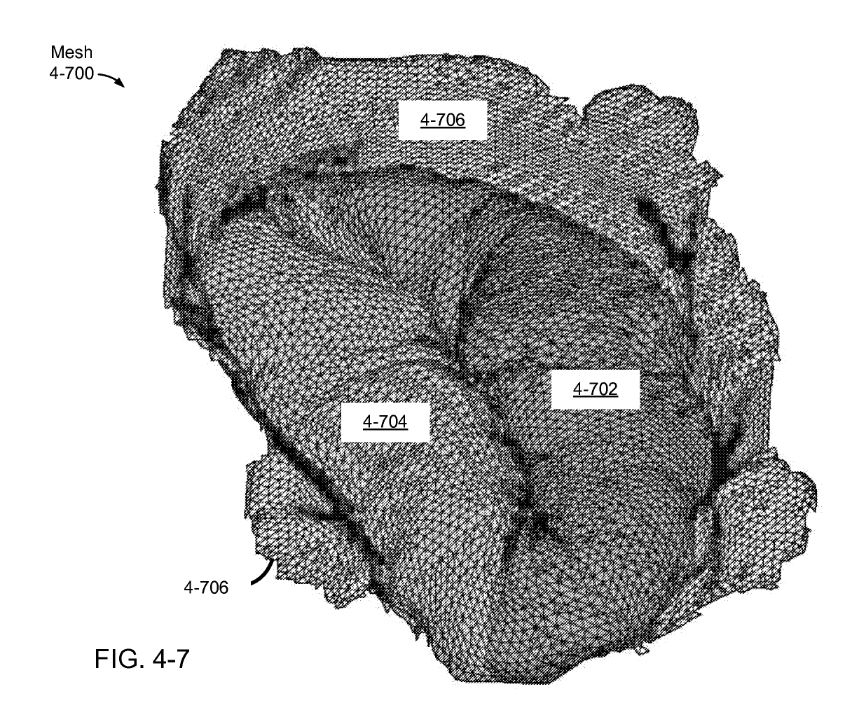

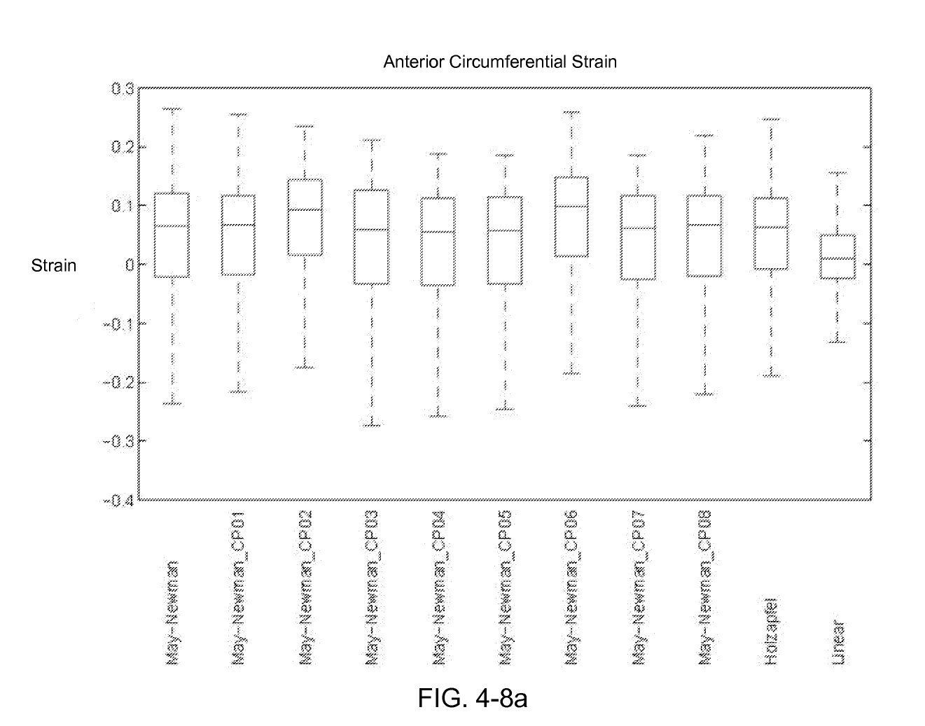

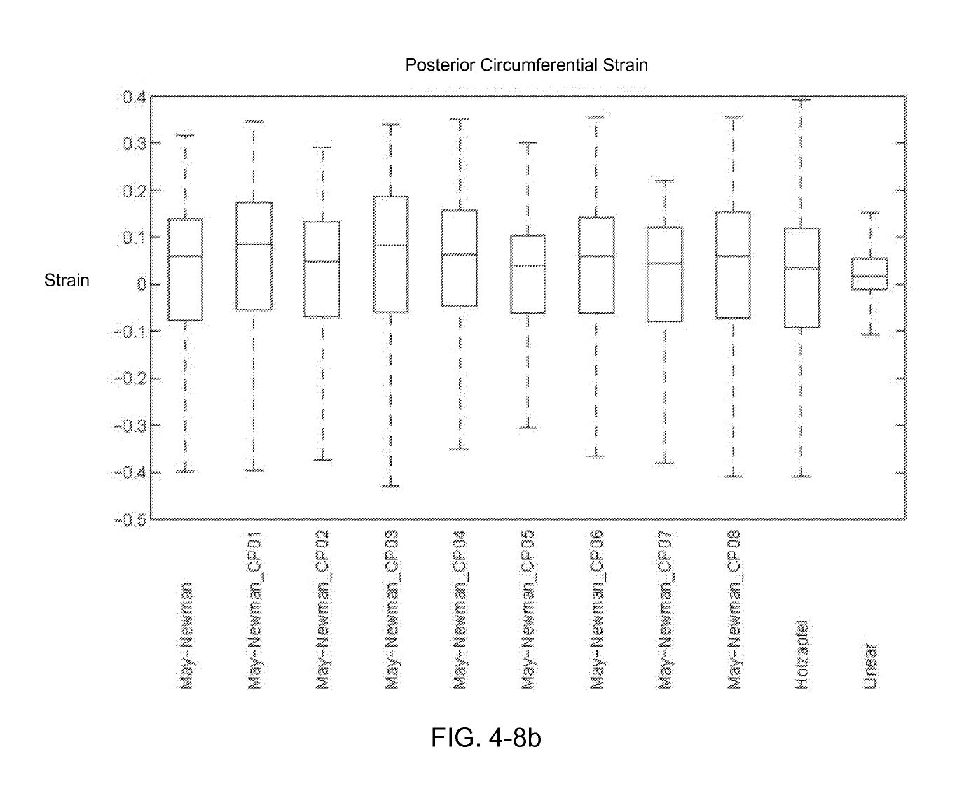

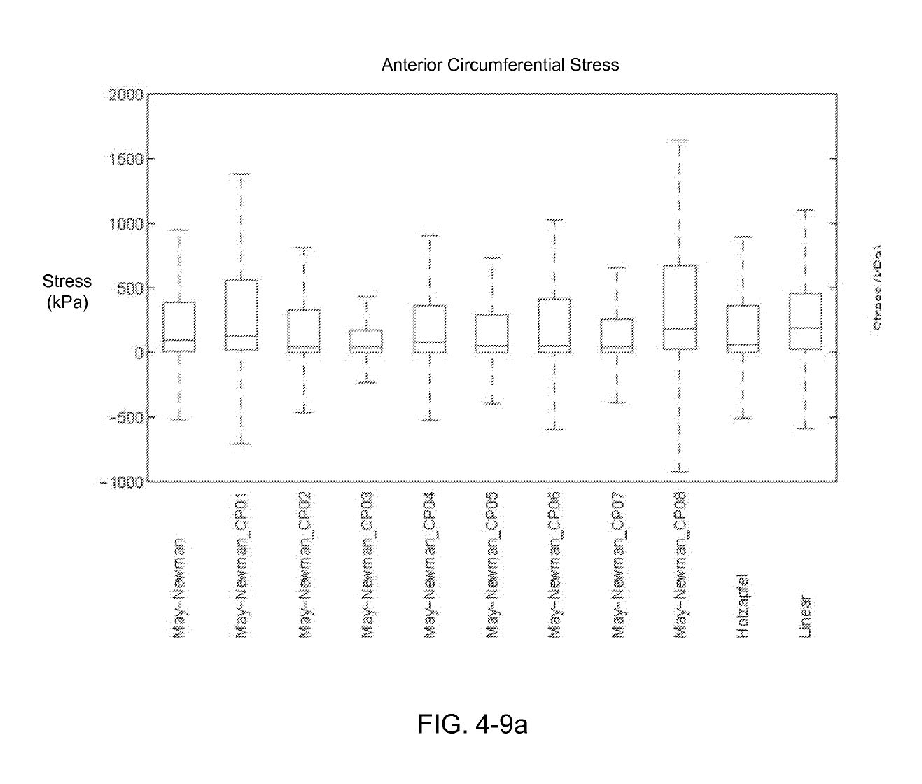

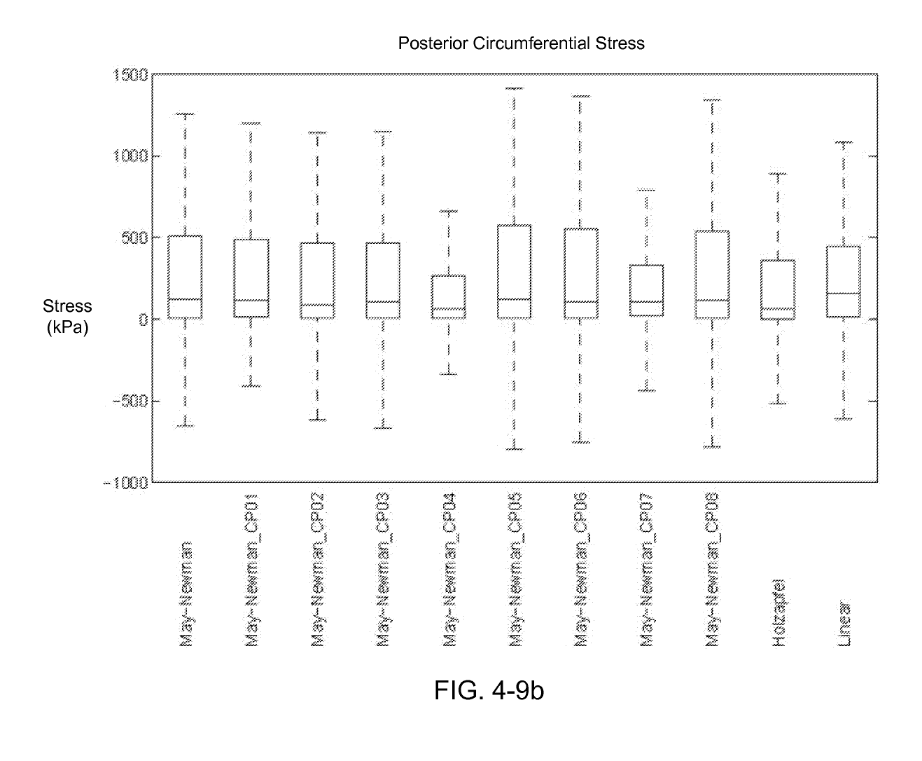

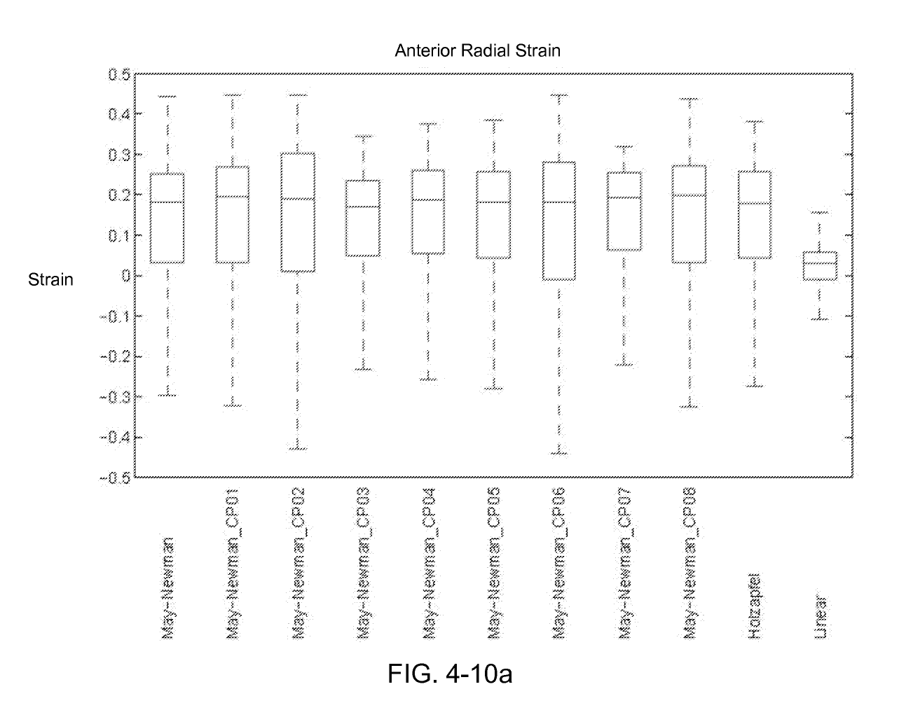

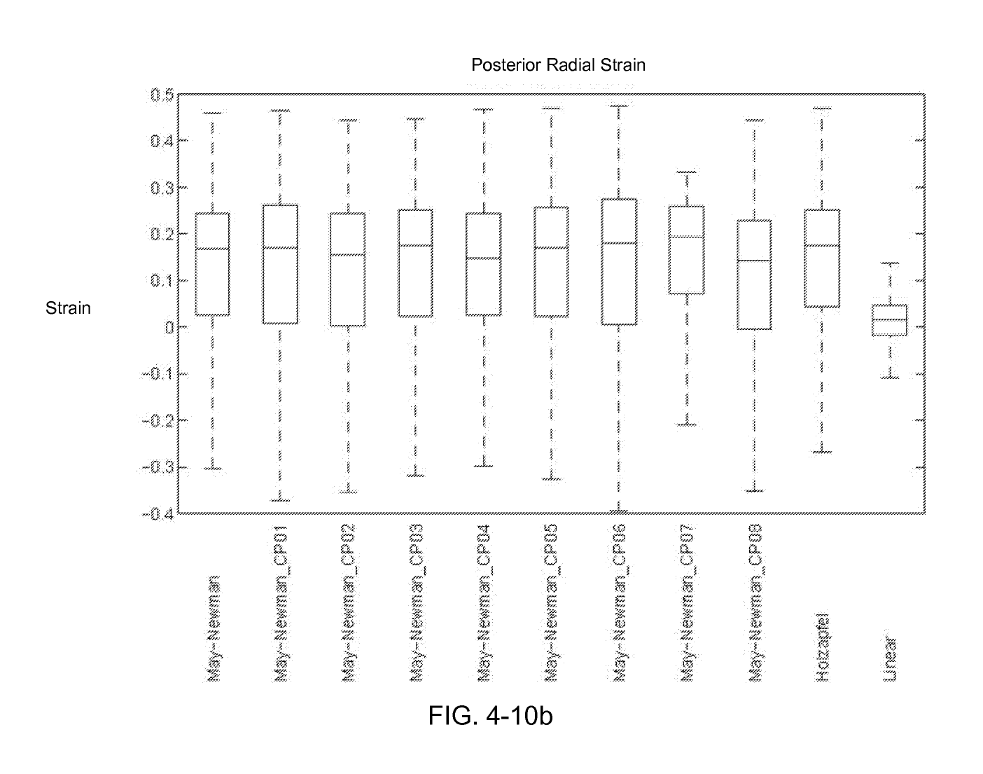

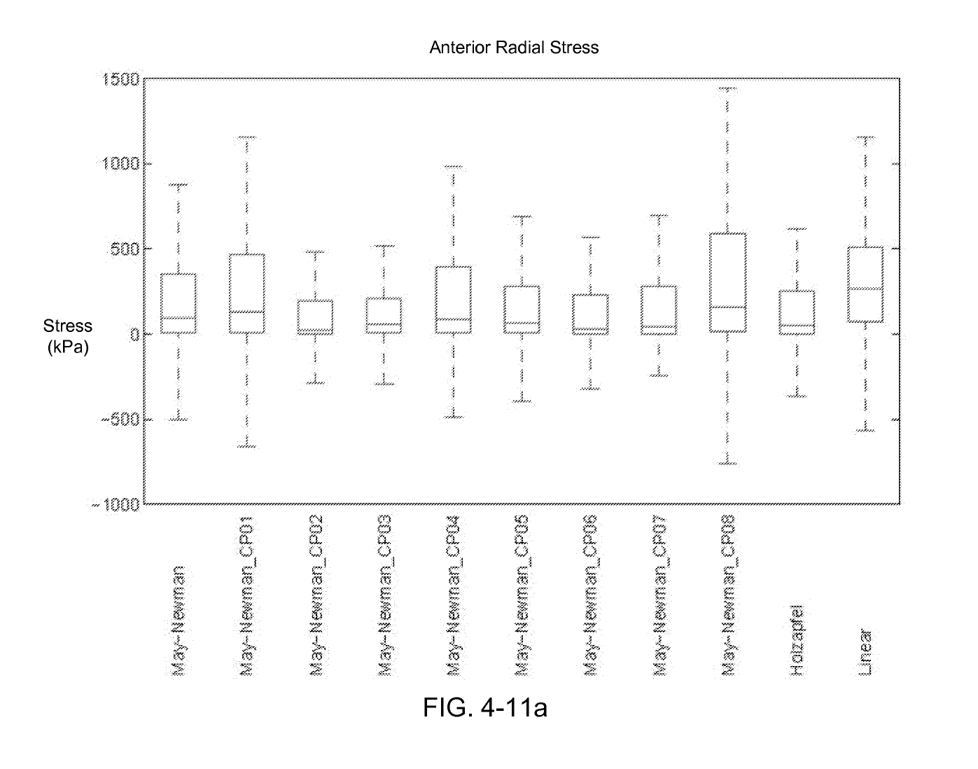

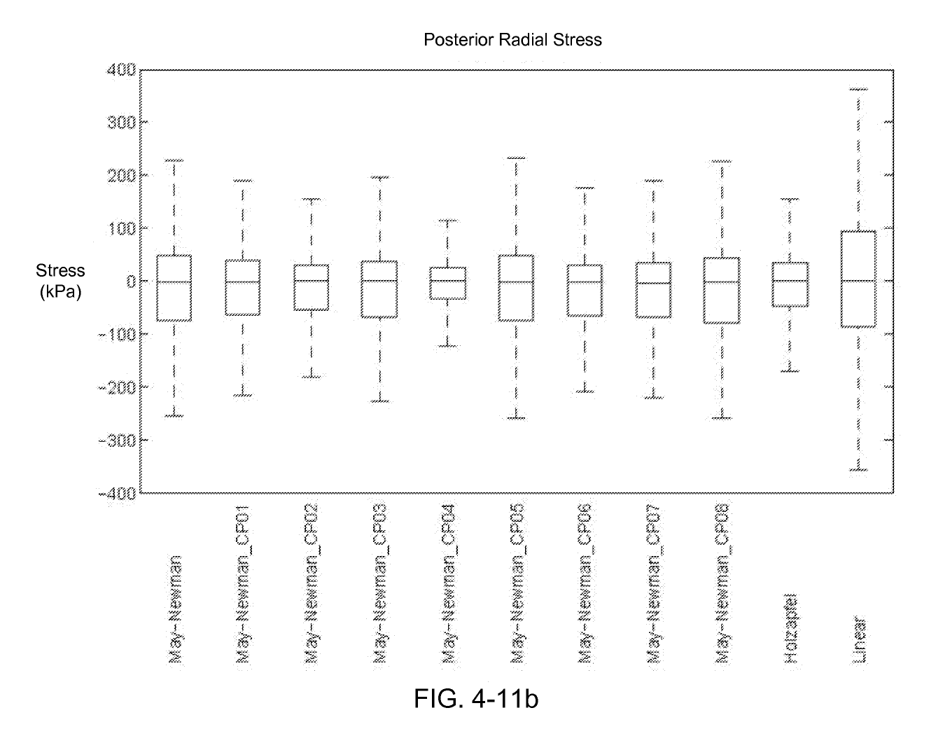

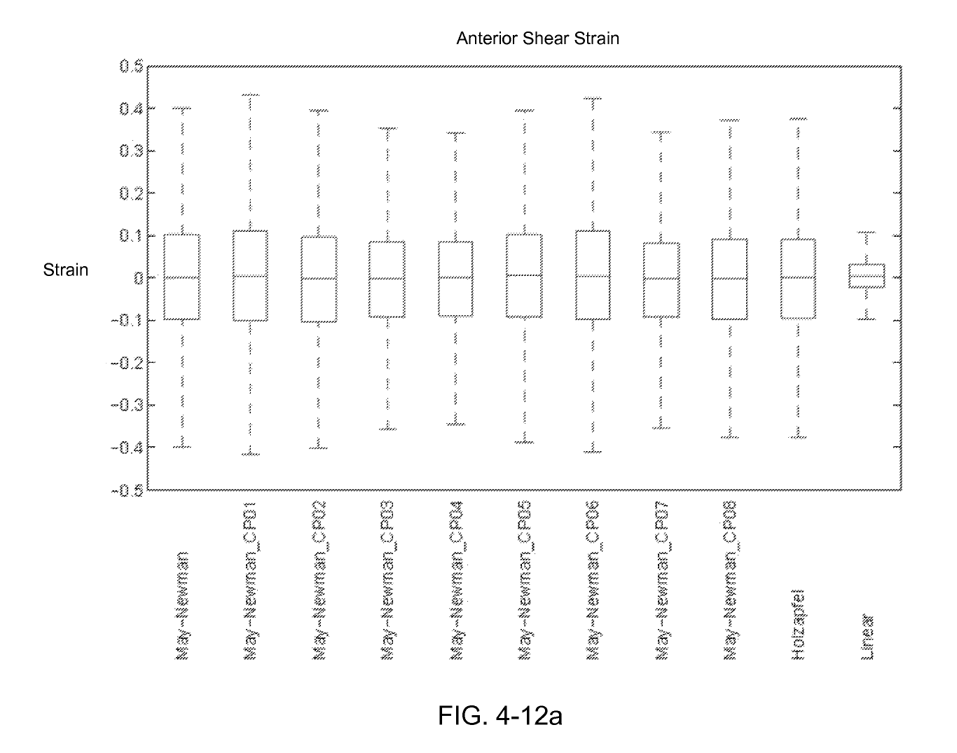

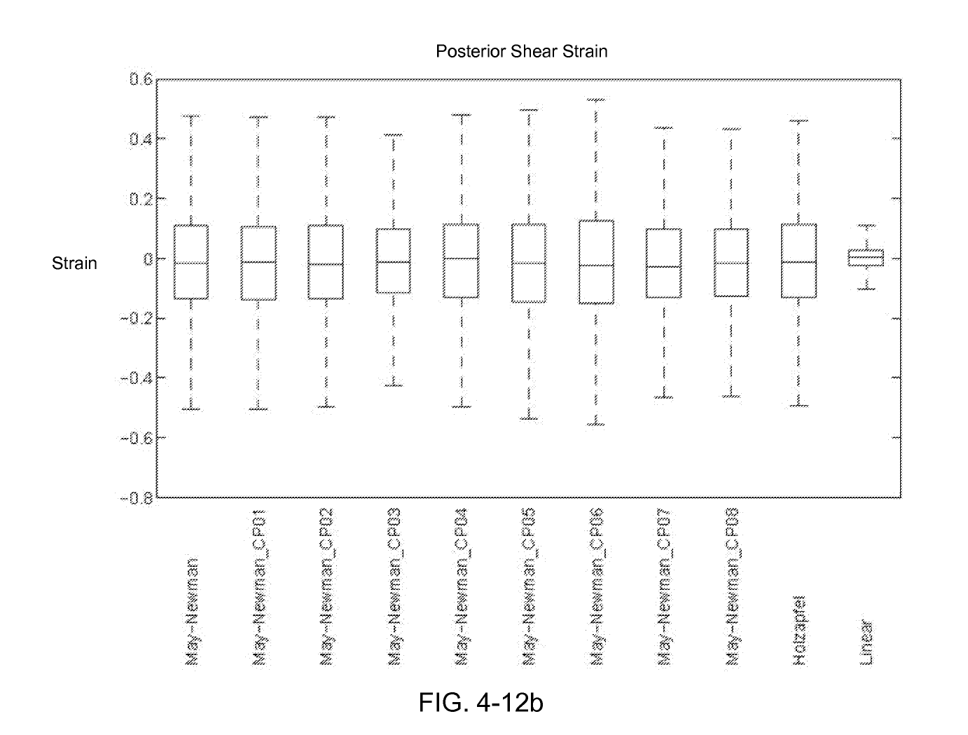

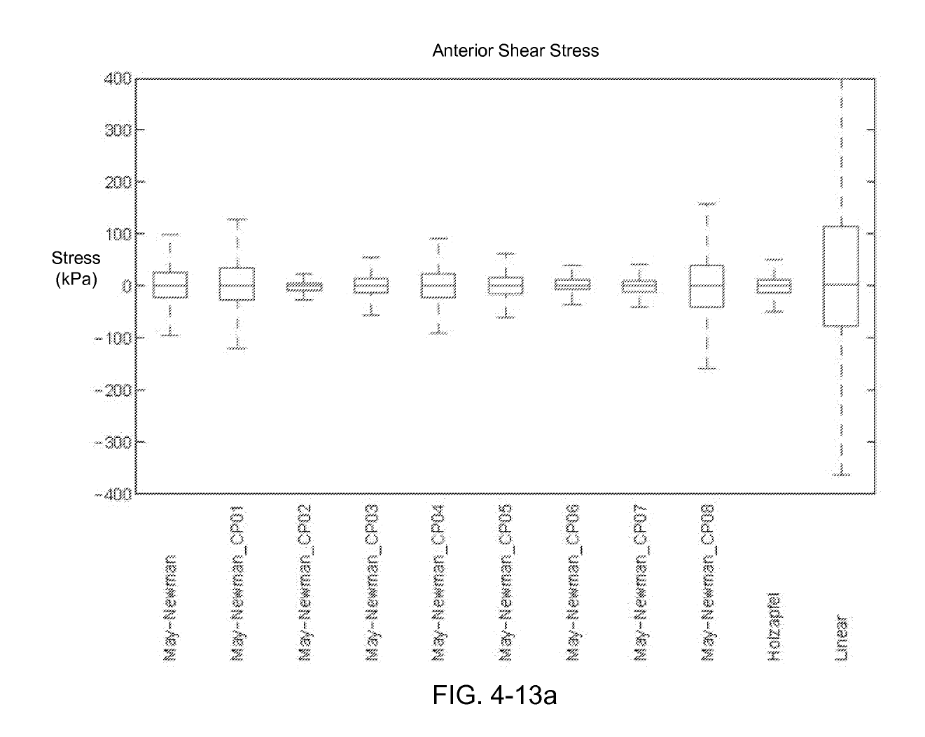

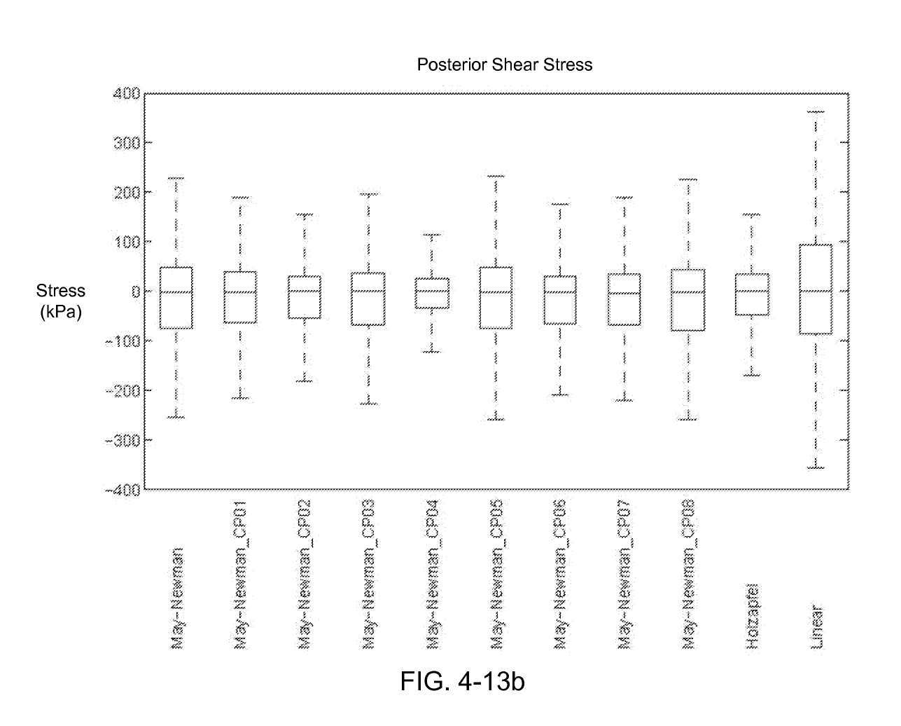

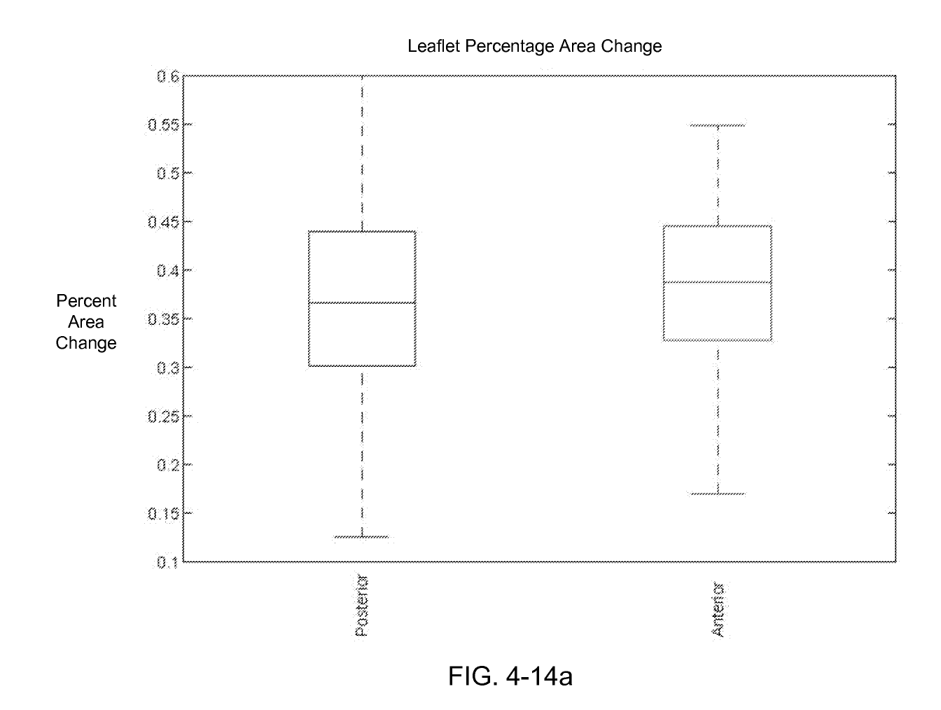

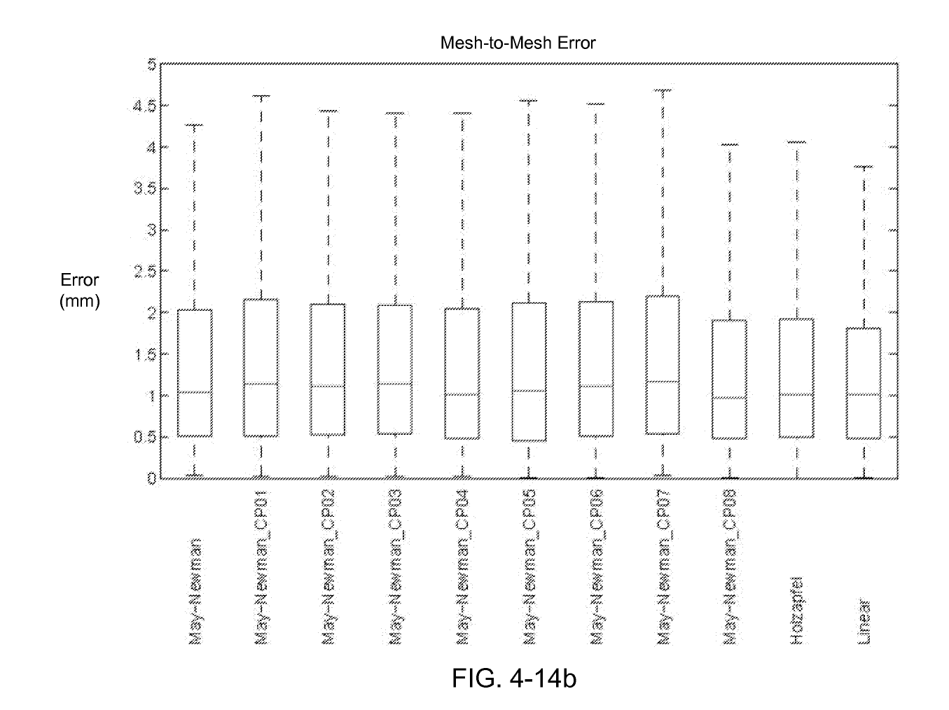

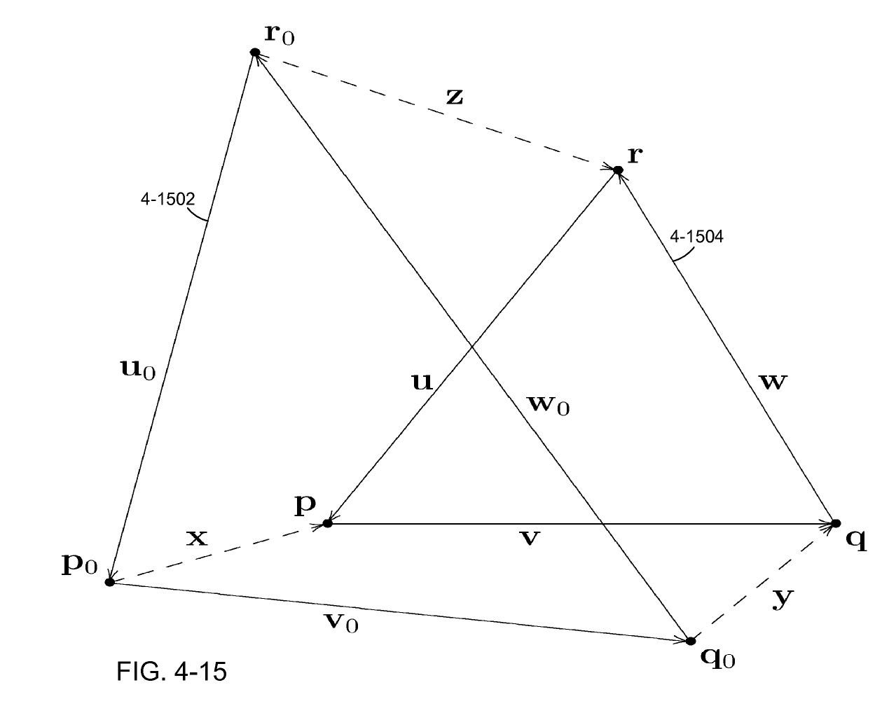

FIG. 3-4 includes an anterior σ_{bb} plot 3-402, an anterior σ_{bb} plot 3-404, a posterior σₐₐ plot 3-406, and a posterior σ_{bb} plot 3-408.

FIG. 3-5 includes an anterior σₐₐ plot 3-502, an anterior σ_{bb} plot 3-504, a posterior σₐₐ plot 5-206, and a posterior σ_{bb} plot 3-508.

The plots of FIGS. 3-2, 3-3, 3-4, and 3-5 exemplify the stretch strain behavior for several scenarios, including linear equibiaxial (where stretch occurs equally along the radial and circumferential MV direction), linear off-biaxial (where radial stretch occurs at 1.5 the amount of stretching along the circumferential MV direction), am strip biaxial (the MV is pre-stretched 15% along the circumferential direction, and the radial stretch then occurs, and vice-versa). As is seen in the plots of FIGS. 3-3, 3-4, 3-5, and 3-6, the strain-stress relationship in the deformed frame of reference is nearly (but not exactly) linear.

5. Tethering Energy

Tethering energy may be used to model effects of the chordae tendineae, whose function is to restrict the range of motion of the leaflets, thereby preventing prolapse in healthy valves. A tethering energy term may be nonlinear and may be specified as:

$${φ}_{i}^{T} = \{ \begin{matrix}{Φ}^{t} \frac{{( \vert {p}_{i} - {q}_{i} \vert - {r}_{i} )}^{3}}{{p}^{3}} & if \vert {p}_{i} - {q}_{i} \vert > {r}_{i} \\ 0 & otherwise\end{matrix} \qquad EQ . ( 3 \text{-} 17 )$$

where Φ^{t} is the strength of the tethering energy coefficient, pᵢ is the position of the displaced node i, qᵢ is the position of the point to which node i is tethered, rᵢ is the chord length, and ρ is the scale of the range dependence of the force.

Example numerical values are as follows: the strength of the tethering energy coefficient may be Φ^{t}=0.07 J, and the scale of the range dependence of the tethering force may be ρ=0.112*E[r] mm, where E[r] is the average voxel side resolution. E[r] may range from, for example, 0.4 mm to about 0.8 mm.

6. Collision Energy

The collision energy function may be designed to prevent self-intersection of the mesh. Collision energy φᵢ^{C} may be specified by considering as repulsive force between all facet pairs in the valve system, such as:

$${φ}_{i}^{C} = {\sum }_{j} {\sum }_{k} {\int }_{{T}_{j}} d {r}_{j} {\int }_{{T}_{k}} d {r}_{k} e ( \vert {r}_{j} - {r}_{k} \vert ) . \qquad EQ . ( 3 \text{-} 18 )$$

In EQ. 3-18, the outer summation is over all the facets Tⱼ not containing node i, while the inner summation is over all the facets Tₖ that are not adjacent to facet Tⱼ. Furthermore, in that same equation, the facet point rⱼ (resp. rₖ) spans the region of the facet Tⱼ (resp. Tₖ), while e(d) specifies a repulsive energy dependent on the distance d between the interacting facet points, and may be defined as:

$$e ( d ) = \{ \begin{matrix}{{Φ}^{C} ( 1 - \frac{d}{δ} )}^{n} & if d < δ \\ 0 & otherwise\end{matrix} \qquad EQ . ( 3 \text{-} 19 )$$

where Φ^{C} specifies the strength of the repulsive force and the exponent n controls the rapidity of the onset of the force, which may be set to. For example, n may be set to n=4, the repulsion energy coefficient may be taken as Φ^{C}=5.7×10⁷ J·m⁻⁴, and the repulsion range may be set to δ=3E[r], where E[r] is the average voxel resolution described above.

The double summation of EQ. 3-18 may be considered only between facets that are “close” to one another. An efficient tree-based range search may be used to restrict the computational impact of the summation. This is an important consideration because computation of the collision energy is a major contributing factor to total computational load.

The range a specifies the interacting node distance under which the collision force becomes active. Since the double integral term of EQ. 3-18 is evaluated by further discretizing points within the facet, the range δ may be set to a value that is on the order of the smallest distance between the mesh nodes. Therefore, at the final configuration, the remaining gap between colliding/coapting leaflets should be on the order of the mesh facet resolution. The mesh resolution may be tuned down to generate smaller gaps, such as to trade slower convergence for finer precision.

7. Optimization

The variation of total potential energy is a function of 3N displacement coordinates, where N is the number of free nodes in the valve system. The annulus may be manually recovered for each patient's valve. Nodes located above the annulus belong to the atrium and are therefore not considered free nodes, and are not included in the energy minimization process.

To find the closed positions of the leaflets given the distributed forces and imposed displacements, a configuration that minimizes the total energy may be determined using the Broyden, Fletcher, Goldfarb, Shanno (BFGS) quasi-Newton optimization process implemented in the Matlab Optimization Toolbox. This may avoid the computation of the Hessian and alleviate potential stability issues related to Newton's methods. Convergence and number of iterations are addressed further below.

8. Annulus Deformation

To account for changes in annulus shape between diastole and systole in a way that is patient-specific, a user/expert may initially segment both the open and closed state annuli from 3D TEE imagery. The user/expert annulus segmentations may be converted to NURBS curves, which may be used to generate an approximate scaling value that is representative of an extent of annulus contraction/expansion between late diastole and begin systole.

The entire open state mesh may be deformed according to the scaling value, while maintaining the un-deformed state as a simulation energy reference point for computing strain and stress. In other words, accrued energy due to leaflet stretching resulting from annulus deformation may be taken into account to in seeking the stationary closed MV configuration. As a result, the annulus facets of the mesh, which remain static during simulation, will more closely resemble their final appearance and location as measured from the 3D TEE imagery. The rest of the mesh that was initially deformed will revert back to its minimal energy state and the leaflets will close as the simulation progresses.

9. Chordal Length Estimation

Patient-specific chordal lengths may be difficult to assess from 3D TEE imagery. Alternatively, simulation may be run by varying the chordal lengths about a nominal set of lengths multiplied by a scaling factor. The nominal set of lengths may be computed by first considering the distance from the papillary muscles positions to the chordal attachments, which then represent a set of assumed and approximate late diastole chordal lengths (EDCL). The estimated lengths may then found by seeking a scaling factor that best represents the patient, in a way that minimizes the prediction error, defined as an error between the predicted valve closure configuration and the actual closed configuration derived by segmentation at systole.

B. Validation Framework Modeling

A modeling validation framework is now described, which includes using patient-specific 3D TEE data and computation of errors based on comparisons of predicted and actual closed configurations.

Intraoperative real-time 3D TEE full-volume data sequences of mitral valves was collected from patients of the Johns Hopkins University's School of Medicine as described further above.

A subset of the acquired sequences was selected for the study described below. In full 3D mode, spatial and temporal resolution is enhanced by collating successive sectors of the 3D frustum, each sector being acquired during a full heart cycle, and temporal synchronization achieved with ECG gating as described further above.

A sub-selection process was used to eliminate sequences that appeared to be affected by sector misalignment. Additional sub-selection criteria were that there had to be nearly no cropping of the MV, that the valve apparatus had to be seen almost in its entirety in the 3D TEE frustum, the resolution had to be sufficient and the imaging conditions with regard to contrast and artifacts had to be reasonably good.

A little less than a third of the acquired sequences were selected based on these criteria, which resulted in nine separate sequences corresponding to six different patients. Two of the cases entailed predicting closure from two different open positions in the same sequence (test cases 3 and 4), resulting in 10 test cases, which are presented below.

Table 3-1 provides information for each case, including voxel resolution in mm, depth, frame rate, and image quality as rated by a cardiologist. A quality measure of 1 corresponds to high quality/no artifacts. A quality measure of 5 corresponds to poor quality/many artifacts.

TABLE 3-1

| | Voxel Resolution | Frame Rate | Ultrasound | Image |
|---|---|---|---|---|
| Case | (mm) | (Hz) | Depth | Quality |
| 1 | 0.72 × 0.71 × 0.63 | 39 | 13 | 2 |
| 2 | 0.67 × 0.66 × 0.58 | 41 | 12 | 1 |
| 3 | 0.67 × 0.66 × 0.58 | 41 | 12 | 1 |
| 4 | 0.67 × 0.66 × 0.58 | 41 | 12 | 1 |
| 5 | 0.78 × 0.77 × 0.68 | 36 | 14 | 2 |
| 6 | 0.67 × 0.66 × 0.58 | 36 | 14 | 2 |
| 7 | 0.67 × 0.66 × 0.58 | 41 | 12 | 2 |
| 8 | 0.41 × 0.4 × 0.44 | 52 | 9 | 2 |
| 9 | 0.78 × 0.77 × 0.68 | 36 | 14 | 2 |
| 10 | 0.72 × 0.71 × 0.63 | 39 | 13 | 2 |

Frames in the sequence corresponding to late diastole and systole were automatically segmented. The chordal lengths, specific to each patient, were found via optimization by seeking the length scaling factor that best describes the patient, i.e. minimizes the prediction error. In the experimental models, the chords included both marginal (also called primary) and basal (also called secondary) chordae tendineae. Marginal chords prevent the leaflet edges from moving into the LA, basal chords' retentive action prevents prolapsing of the mitral leaflets.

FIG. 3-6a is an image of 3D thin tissue segmentation detection of MV leaflets 3-602 with respect to a long axis/four chambers view.

FIG. 3-6b is an image of 3D thin tissue segmentation detection of MV leaflets 3-604 with respect to a long axis/two chambers view.

On average, a total of three basal chords and four marginal chords per leaflet were placed manually for each case, by looking for cues of chordal insertions from the TEE data and resulting meshes, or when this was unavailable, by distributing them based on prior anatomical knowledge. This resulted in a total of about fourteen chords per MV.

Two papillary muscle heads were manually specified for each case. As explained further above, the annuli in open and closed configurations were hand segmented from the 3D TEE frusta, and a dilation (or contraction) factor was computed from open to closed position and was applied on the open mesh annulus prior to running the simulation so as to reflect a transformation to the closed mesh annulus.

For those inputs that required manual intervention (chordal attachments, papillary head placement, valve annulus), no attempt was made in this study at exhaustively evaluating positioning so as to get the best error performance. Instead, these were set once and the chordal length optimizations/simulations were then run. Similarly, all the mechanical model parameters described in the previous section were set once and for all, and remained the same across each case (their value was detailed in the previous section).

FIG. 3-7a illustrates close valve automated segmentation results 3-702.

FIG. 3-7b illustrates close valve segmentation results 3-704 after manual semi-automated segmentation.

FIG. 3-7c illustrates open valve automated segmentation results 3-706.

FIG. 3-7d illustrates open valve segmentation results 3-708 after manual semi-automated segmentation.

FIGS. 3-8a and 3-8b are close-up views of and initial and final computed configurations for test case 1. More specifically, FIG. 3-8a illustrates the initial open valve configuration from TEE segmentation. FIG. 3-8b illustrates a corresponding closed configuration predicted using mechanical modeling.

FIGS. 3-8a and 3-8b each include anterior leaflets 3-802 and posterior leaflets 3-804, each of which includes parts of the attached primary chordae tendineae structure. FIGS. 3-8a and 3-8b each further include the annulus as well as the lower part of the atrium, identified together at 4-306.

Quantitative evaluation involved measuring errors between predicted and ground truth, results of which are summarized in Table 3-2.

TABLE 3-2
Prediction Error Statistics

| | | (OPT) | | | | (EDCL) |
|---|---|---|---|---|---|---|
| Case | Patient | Mean | Std | 5% | 95% | Mean |
| 1 | 1 | 1.81 | 1.32 | 0.25 | 4.29 | 1.93 |
| 2 | 2 | 2.25 | 1.38 | 0.37 | 4.54 | 2.25 |
| 3 | 2 | 2.41 | 2.56 | 0.22 | 7.38 | 3.30 |
| 4 | 2 | 2.01 | 1.98 | 0.21 | 6.26 | 2.31 |
| 5 | 3 | 1.39 | 0.97 | 0.19 | 3.21 | 1.76 |
| 6 | 4 | 1.69 | 1.47 | 0.20 | 4.78 | 1.96 |
| 7 | 5 | 1.33 | 1.19 | 0.19 | 3.56 | 2.28 |
| 8 | 6 | 2.53 | 2.13 | 0.25 | 6.62 | 2.98 |
| 9 | 3 | 1.46 | 1.33 | 0.18 | 4.00 | 1.46 |
| 10 | 1 | 1.86 | 1.53 | 0.23 | 5.28 | 1.90 |
| all | all | 1.86 | 1.72 | 0.21 | 5.27 | 2.21 |

FIG. 3-9 is an error map 3-900 distribution for case 1. Error map 3-900 shows the variation of the error distribution for various parts of the valve for case 1. The predicted closed valve mesh was compared with the actual segmented closed valve mesh, by first registering the two meshes to adjust for the mostly vertical translation of the annulus during closure. The simulated mesh was then cropped to include only what would be “visible” to the ultrasound probe. The visibility cropping matches how the ground-truth segmentation is obtained (only a thin layer of tissue nearest the ultrasound probe is segmented), and prevents the computation of error in obstructed areas below the valve for which ground truth is difficult to obtain due to shadowing and noise.

The error is calculated as the average of minimum distances between centroids of facets on the simulated mesh to centroids of facets on the ground truth. The results reported also correspond to the optimal tether length estimation (labeled “(OPT)” in Table 4-1) and include, for comparison, the mean error found for the late diastole chordal length of the tether without any further optimization (labeled “(EDCL)” in Table 3-2).

From Table 3-2, the mean absolute errors appear to be on the order of the 3D TEE spatial resolution. The magnitudes of errors are, in absolute terms, comparable to the results reported in a recent paper by T. Mansi, et al., “Towards Patient-Specific Finite-Element Simulation of Mitralclip Procedure,” Medical Image Computing and Computer-Assisted Intervention-MICCAI 2011, pp. 452-459, 2011, incorporated herein by reference in its entirety. T. Mansi describes 3D TEE, but different finite element model and valve tracking approaches and in which errors are measured in a different fashion (simulated to tracked position discrepancy). The magnitudes of the errors found in this study are also comparable, when considering the spatial resolution limitations of the imaging modalities used (i.e. when measured in voxels), with results reported in P. Hammer, et al., “Anisotropic Mass-Spring Method Accurately Simulates Mitral Valve Closure from Image-Based Models,” Functional Imaging and Modeling of the Heart, pp. 233-240, 2011, incorporated herein by reference in its entirety. P. Hammer relies on micro-CT with resolution of about 100 μm and with a modeling method based on linear or piecewise-linear mass-spring models. Such comparisons however should be considered with caution because there are differences between the different imaging modalities, datasets, and methods used in these studies, which render it difficult to directly compare error results.

A sensitivity analysis was performed by showing the output of the mean-absolute prediction error for various values of the tether length, for various test cases. FIG. 3-10 includes plots 3-1002, 3-1004, 3-1006, 3-1008, of error versus tether scaling, for cases 5, 6, 7, and 8, respectively.

In the plots of FIG. 3-10, a scaling value of I corresponds to the nominal end diastole chordal lengths, other scaling values of the x-axis correspond to multiplicative factors of the EDCL from 0.6 to 1.4. The plot of FIG. 3-10 show that the results depend on the chordal length. Some results exhibit a step-function behavior when the length is below a certain value (as the valve can no longer close). Beyond the step point, increasing the length usually shows an improvement, followed by a degradation trend. For additional comparisons, the mean absolute prediction errors for the optimized and nominal EDCL lengths are also shown in Table 3-2 above.

The plots of FIG. 3-10 also inform the method as to the estimated patient-specific length of the chords, found as those that minimize the prediction error.

Techniques disclosed herein may be implemented to simulate abnormal valve functions. For example, a “normal” patient's MV model may be modified to simulate pathological cases of special relevance for the valve competency, such as prolapse of leaflets resulting from chordae rupture. This is a life threatening pathology that may result from degenerative disease of the leaflets and the chordae or papillary muscles, or tissue necrosis due to infarct.

FIGS. 3-11a through 3-11d illustrate simulations in which a patient's MV model is modified to simulate various pathological cases, where the patient's MV model that was asymptomatic with regard to MR.

FIG. 3-11a illustrates a simulation for which the patient's MV model was modified to represent chordae rupture leading to prolapse of the anterior leaflet.

FIG. 3-11b illustrates a simulation for which the patient's MV model was modified to represent chordae rupture leading to prolapse of anterior leaflets.

FIG. 3-11c illustrates a simulation for which the patient's MV model was modified to represent chordae rupture leading to prolapse of posterior leaflets.

FIG. 3-11d illustrates a simulation for which the patient's MV model was modified to represent shortened chordae preventing correct coaptation of the leaflets, which may result from a surgical intervention that caused an excessive shortening of the chordae tendineae.

Besides coaptation, techniques disclosed above may provide other valuable information. For example, high leaflet stress may result in decreased longevity and hence the ability to predict the stresses induced in the leaflet may also inform valvuloplasty decisions.

### IV. Patient-Specific Modeling of Tissue Stress/Strain

Studies have performed heart valve modeling experiments using a simplified valve representation. These studies use the strain and stress values predicted by simulation to gauge the validity of the simulation method. However, with respect to the primary purpose of valve simulation (to provide a preoperative tool for surgeons to evaluate valve corrections), these methods have an inherent disadvantage. As has been shown in Kay-Newman-Yin (1998), the elasticity of heart valve tissue may vary widely from one individual to the next. Additionally, as can be seen from FIGS. 4-8 through 4-13, discussed further below, selected parameters may result in a sizable swing in strain and stress values.

Disclosed below are methods and systems to model the mitral valve based on patient-specific 3D Transesophageal Echocardiography (3D TEE). The method may be implemented, for example, to predict a closed configuration of the valve by solving for an equilibrium solution via an energy minimization function that balances various forces, which may include one or more of blood pressure, tissue collision, valve tethering, and tissue elasticity.

The model may incorporate realistic hyperelastic and anisotropic properties for the valve leaflet tissue, and may subject the leaflets to physiological systolic blood pressure loads. A hyper-elastic tissue model, rather than a linear elastic constitutive model, may be used to infer resultant stresses.

Techniques disclosed below may use a shape-finding finite element approach, such as conventionally applied to tensile structures. A shape-finding finite element approach may be useful because the valve leaflets are thin structures made up of connective tissue with elastic properties (tensile, compressive and bending), similar to certain types of fabric. In addition, the valve behaves like a tensile structure since its leaflets are tethered by chords (chordae tendineae) attached to papillary muscles to prevent the leaflets from prolapsing into the atrium under sustained and significant systolic blood pressure.

Modeling may begin with an open 3D valve structure at diastole, which may be derived by segmenting RT3DE imagery, such as described further above, and which may be edited by a surgeon to remove artifacts. The segmented and edited imagery may further modified to reflect contemplated surgical modifications. The closed valve configuration at systole is then predicted from the open valve, via physics-based modeling and simulation, to characterize the ability of the MV leaflets to competently coapt, and to characterize the associated strains and stresses at systole for the closed configuration when the system is under systolic blood load.

Modeling and simulation techniques disclosed herein may be implemented with respect to one or more of a variety of applications including, without limitation, patient-specific diagnostics and/or patient-specific computer-aided surgical planning and guidance.

For example, modeling and simulation techniques disclosed herein may be utilized to predict patient-specific postoperative anatomy and physiology, such as stresses and strains to be experienced by reconstructed tissue or organ. The predicted postoperative anatomy and physiology may be examined prior to surgery to assess the quality of the proposed surgery, such as to select from amongst multiple surgical options and/or to design and/or tailor an option for a specific patient.

Stress and strain is often indicative or predictive of longevity of a surgical reconstruction, which is an important factor when considering postoperative mortality and morbidity associated with surgical procedures such as valvuloplasty. Stress computations may thus be used as guidance by a surgeon in selecting or designing a repair procedure.

A. Segmentation and Mesh Construction

A mesh representing the patient-specific MV anatomy is derived from segmentation using thin tissue detection, such as described further above. The mesh is then fitted to the segmented leaflets and lower atrium. At each node of the mesh, displacements or forces are prescribed or modeled.

B. Force Modeling

Modeled forces may include forces due to fluid pressure, hyperelastic stress, collision with other portions of the mesh, and/or tethering of the valve to the chordae tendineae.

An initial configuration of the open mesh is used to specify a reference energy point for external and internal forces. The steady state configuration of the valve system under load at a closed position, where all forces are at equilibrium, is then found by minimizing total energy of the system.

For any given displacement of the nodes from the initial open configuration and for each node i, the total energy Φ of the displaced system may be expressed as Φ=Σᵢφᵢ, with forces Fᵢ=−∇φᵢ. The energy is expressed as the sum of components in φᵢ=φᵢ^{X}+φᵢ^{E}+φᵢ^{T}+φᵢ^{C}, as:

$$Φ = {\sum }_{all nodes i} {φ}_{i}^{X} + {φ}_{i}^{E} + {φ}_{i}^{T} + {φ}_{i}^{C} \qquad EQ . 4 \text{-} 1$$

where,

φᵢ^{X} is the external energy,

φᵢ^{E} is the leaflets' elastic energy,

φᵢ^{T} is the leaflets-to-chordae tethering energy, and

φᵢ^{C} is the leaflets' collision energy.

The energy terms may be implemented as described further above.

The external energy term may be modified so that the force acting on the facets by the fluid pressure is directed along the facet normal.

The elastic energy term may be modified to allow for hyperelastic behavior as described below.

1. Hyperelastic Modeling

Macroscopic mechanical behavior of the valve leaflets is driven at the microscopic level primarily by the elastic behavior of its constitutive elastin and collagen fibres. Due to the presence of collagen fibres, the leaflets have some ability to stretch that arises when pressure is exerted on the collagen coils. The leaflets' elastic energy term φᵢ^{E} may be modified to allow for hyperelastic material behavior. The leaflet elasticity may be modeled using a hyperelastic strain-energy law associated with hyperelastic materials.

Hyperelastic materials are a class of elastic materials for which the stress-strain relationship is derivable from a strain energy density function, Ψ. Examples are provided below with respect to hyperelastic laws referred to herein Saint Venant-Kirchoff(“SVK”), May-Newman-Yin (“MNY”), and Holzapfel.

The MNY law is formulated in K. May-Newman and F. Yin, “A Constitutive Law for Mitral Valve Tissue,” Journal of Biomechanical Engineering, vol. 120, p. 38 (1998) (hereinafter “May-Newman-Yin), incorporated herein by reference in its entirety.

The Holzapfel law is proposed in V. Prot, et al. “Transversely Isotropic Membrane Shells with Application to Mitral Valve Mechanics: Constitutive Modelling and Finite Element Implementation,” Int. Journal for Numerical Methods in Engineering, vol. 71, no. 8, pp. 987-1008 (2007) (hereinafter “Prot”), incorporated herein by reference in its entirety. The Holzapfel law is related to the MNY law.

The SVK hyperelastic model may be expressed as:

$$\begin{matrix}{Ψ}_{S} = \frac{1}{2} tr SE , \\ where & EQ . ( 4 \text{-} 2 ) \\ S = \frac{E}{1 + v} [ E + \frac{v}{1 - 2 v} ( tr E ) 1 ] , & EQ . ( 4 \text{-} 3 )\end{matrix}$$

for Young's modulus E, and Poisson ratio v.

The MNY hyperelastic model may be expressed as:

Ψ_{M}=c₀[e^{c}^{₁}^{(I}^{₁}⁻³⁾^{²}^{+c}^{₂}^{(λ-1)}^{⁴}−1], EQ. (4-4)

where,

I₁=trC is the first invariant of the right Cauchy-Green deformation tensor; and

λ=\sqrt{â₀Câ₀} is the stretch in the â₀ direction.

The vector â₀ is chosen parallel to the orientation of the collagen fiber to model the increased stiffness in the fiber direction relative to the transverse directions. The values of the coefficients cᵢ are taken from May-Newman-Yin.

The fibre direction may be determined as circumferential to the annulus, as taught in J. Grashow, et al., “Biaxial stress-stretch behavior of the mitral valve anterior leaflet at physiologic strain rates,” Annals of Biomedical Engineering, vol. 34, no. 2, pp. 315-325, 2006, which is incorporated herein by reference in its entirety.

The Holzapfel hyperelastic model may be expressed as:

Ψ_{H}=c₀^{t}[e^{c}^{₁}^{^{t}}^{(I}^{₁}⁻³⁾^{²}^{+c}^{₂}^{^{t}}^{(λ}^{²}⁻¹⁾^{⁴}−1], EQ. (4-5)

with Iᵢ and λ as above, and coefficients c′ᵢ taken from Prot, which were derived to match empirical leaflet elasticity data in May-Newman-Yin, namely: c₀=0.0520 kPa, c₁=4.63, and c₂=22.6 for the anterior leaflet; and c₀=0.171 kPa, c₁=5.28, and c₂=6.46 for the posterior leaflet.

The above-values were obtained by considering leaflet samples from taken from eight porcine MV specimens among which there was considerable variation. Alternatively, patient-specific values may be determined for these coefficients, rather than from pathological tissues of others where plasticity and elasticity may be degraded.

The leaflets may be modeled as thin membranes using a plane-stress assumption.

Derivation of energy density and corresponding force functions are provided further below with respect to a membrane represented by a triangular mesh, for each of the models. The form of the corresponding Cauchy stress and Almansi strain tensors are also provided further below.

Representative plots of the stress-strain relationships for each of the three laws are shown in FIGS. 4-1 and 4-2.

FIG. 4-1 illustrates the stress-strain behavior for the anterior leaflet under equibiaxial deformation in which the membrane is deformed in directions parallel and perpendicular to the fiber direction equally. In FIG. 4-1, stress parallel to the fiber direction (σaa) is plotted versus strain parallel to the fiber direction (εaa).

FIG. 4-1 includes curves 4-101, 4-102, 4-103, 4-104, 4-105, 4-106, 4-107, and 4-108, corresponding to MNY specimens CP01 through CP08, respectively.

FIG. 4-1 further includes a curve 4-109 corresponding to a MNY mean.

FIG. 4-1 further includes a curve 4-110 corresponding to a Holzapfel specimen, and a curve 4-111 corresponding to a SVK specimen.

FIG. 4-2 illustrates stress-strain behavior for the anterior leaflet under parallel strip-biaxial deformation in which the membrane is deformed parallel to the fiber direction while keeping the perpendicular deformation fixed at +15%. In FIG. 4-2, stress parallel to the fiber direction (σaa) is plotted versus strain parallel to the fiber direction (εaa).

FIG. 4-2 includes curves 4-201, 4-202, 4-203, 4-204, 4-205, 4-206, 4-207, and 4-208, corresponding to MNY specimens CP01 through CP08, respectively.

FIG. 4-2 further includes a curve 4-209 corresponding to a MNY mean.

FIG. 4-2 further includes a curve 4-210 corresponding to a Holzapfel specimen, and a curve 4-211 corresponding to a SVK specimen.

In FIG. 4-2, dashed portions of a curve correspond to negative deformation.

Results are shown in FIGS. 4-1 and 4-2 for deformation ranging from −50% to +50%. Compressive deformation in FIGS. 4-1 and 4-2 may be of interest where, for example, the modeling technique includes compression for some portions of the mesh. The stresses induced by compression may be relatively small, which is consistent with the desired behavior for a thin flexible membrane.

Parameters used for each of the three models are shown in Tables 4-1 and 4-2. The MNY parameters are taken from May-Newman-Yin, and both the values obtained for individual specimens and the average parameters are modeled. The Holzapfel parameters are taken from Holzapfel. The parameter values for the SVK model are chosen to match the MNY mean curve for deformation of +15%.

TABLE 4-1
Anterior Leaflet Material Properties

| Case | c₀ (Pa) | c₁ | c₂ | d (mm) |
|---|---|---|---|---|
| MNY CP01 | 1010 | 2.59 | 1376.9 | 0.68 |
| MNY CP02 | 79 | 1.25 | 1320.6 | 0.86 |
| MNY CP03 | 181 | 7.01 | 626.5 | 1.40 |
| MNY CP04 | 214 | 4.90 | 1602.9 | 0.86 |
| MNY CP05 | 105 | 5.23 | 1991.6 | 0.98 |
| MNY CP06 | 203 | 1.76 | 833.0 | 0.78 |
| MNY CP07 | 53 | 6.31 | 1943.2 | 0.76 |
| MNY CP08 | 2171 | 2.19 | 1408.8 | 0.48 |
| MNY Mean | 399 | 4.325 | 1446.5 | 0.85 |
| Holzapfel | 52 | 4.63 | 22.6 | 0.85 |

| | | |
|---|---|---|
| SVK | E = 400 kPa, v = ½ | 1 |

TABLE 4-2
Posterior Leaflet Material Properties

| Case | c₀ (Pa) | c₁ | c₂ | d (mm) |
|---|---|---|---|---|
| MNY CP01 | 519 | 2.65 | 103.1 | 0.57 |
| MNY CP02 | 278 | 5.23 | 478.8 | 0.55 |
| MNY CP03 | 268 | 4.28 | 4.8 | 0.44 |
| MNY CP04 | 762 | 2.33 | 116.8 | 0.85 |
| MNY CP05 | 1507 | 2.91 | 1215.7 | 0.41 |
| MNY CP06 | 399 | 2.14 | 320.3 | 0.44 |
| MNY CP07 | 4176 | 2.16 | 249.2 | 0.52 |
| MNY CP08 | 426 | 6.74 | 81.1 | 0.43 |
| MNY Mean | 414 | 4.848 | 305.4 | 0.53 |
| Holzapfel | 171 | 5.28 | 6.46 | 0.53 |

| | | |
|---|---|---|
| SVK | E = 400 kPa, v = ½ | 1 |

As can be seen in FIGS. 4-1 and 4-2, the parameters provide stiffer leaflets for small deformations. The Holzapfel model has modestly increased stiffness for small deformations along the fiber direction and decreased stiffness across the fiber direction compared to the MNY model.

FIGS. 4-3, 4-4, 4-5, and 4-6 are illustrations of a simulated closed-state mesh 4-300, based on a starting mesh of approximately 21,000 facets. The simulation was run using the average of May-Newman's hyperelastic parameters. In FIGS. 4-3, 4-4, 4-5, and 4-6, a color-scale (illustrated here in greyscale) is log 10 relative to 1 Pa.

FIG. 4-3 illustrates circumferential Almansi strain for each facet overlaid on mesh 4-300.

FIG. 4-4 illustrates circumferential Cauchy stress for each facet overlaid on mesh 4-300.

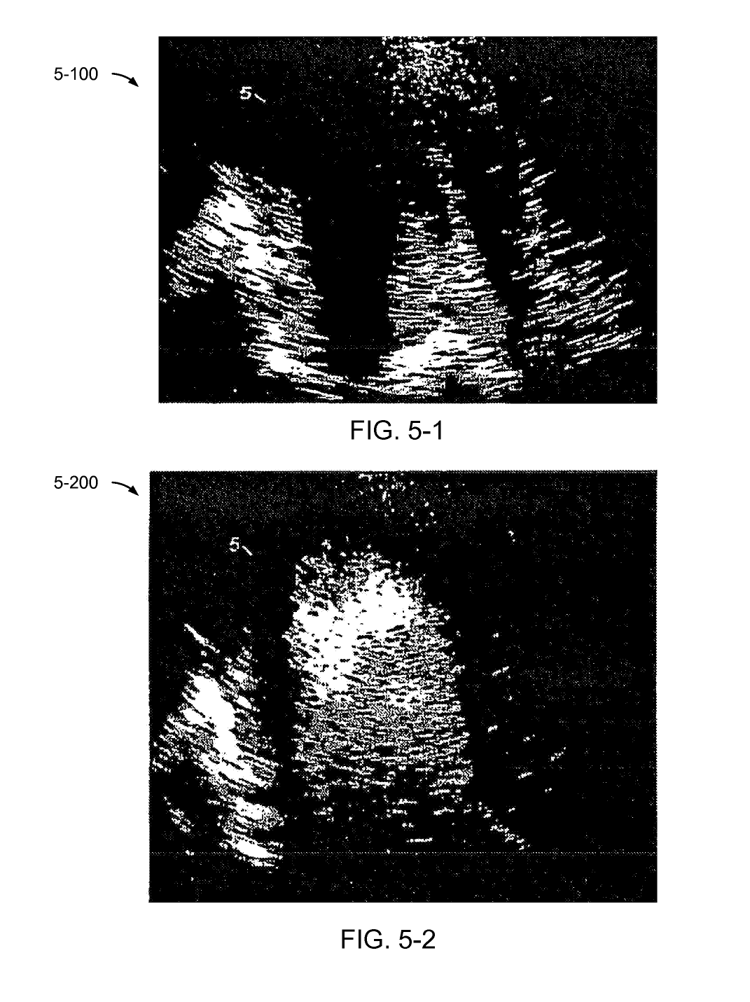

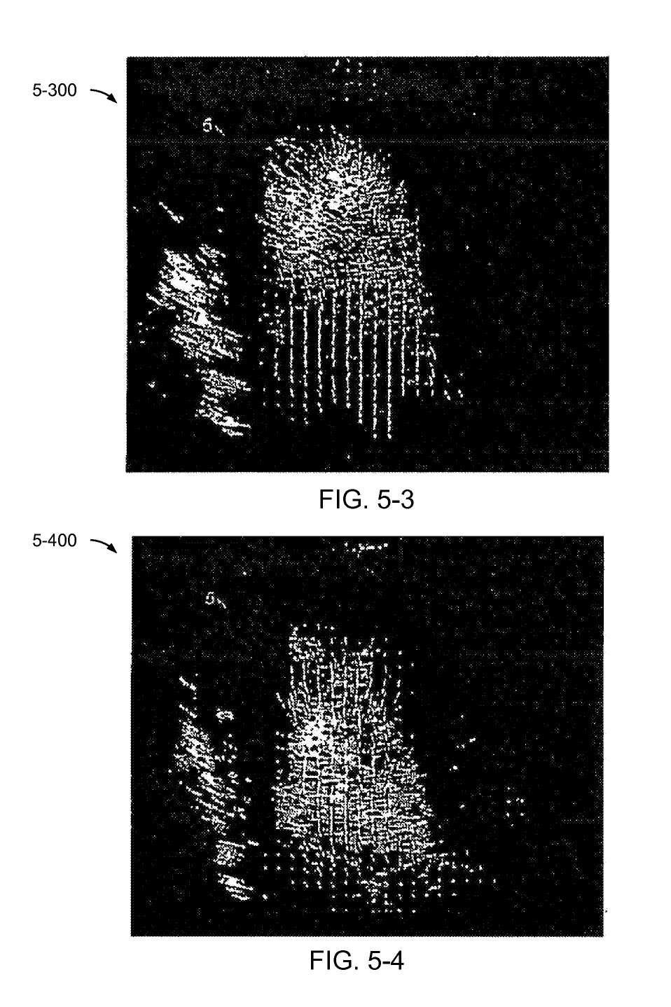

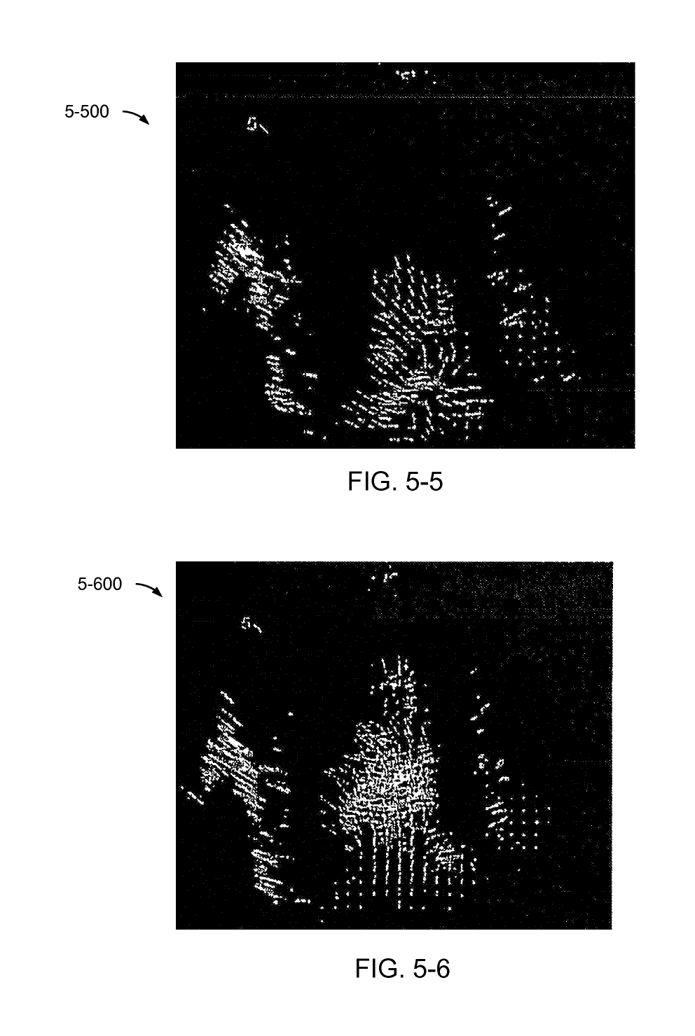

In FIG. 4-5 illustrates radial Almansi strain for each facet overlaid on mesh 4-300.

In FIG. 4-6 illustrates radial Cauchy stress for each facet overlaid on mesh 4-300.

FIG. 4-7 illustrates a simulated final closed-state mesh 4-700, based on a starting mesh of approximately 21,000 facets. The simulation was run using the average of May-Newman's hyperelastic parameters. Mesh 4-700 includes posterior leaflet 4-702, anterior leaflet 4-704, and a portion 4-706, which may include the annulus and/or portions of the left atrium. Annulus and atrium facets were excluded from the simulation, but are shown here for reference.

FIG. 4-8a is a box plot 4-802 depicting circumferential Almansi strain for the anterior leaflets across all experiments tested, as well as for each set of parameters.

FIG. 4-8a is a box plot 4-804 depicting circumferential Almansi strain for the posterior leaflets across all experiments tested, as well as for each set of parameters.

FIG. 4-9a is a box plot 4-902 depicting circumferential Cauchy stress for the anterior leaflets across all experiments tested, as well as for each set of parameters.

FIG. 4-9b is a box plot 4-904 depicting circumferential Cauchy stress for the posterior leaflets across all experiments tested, as well as for each set of parameters.

FIG. 4-10a is a box plot 4-1002a depicting radial Almansi strain for the anterior leaflets across all experiments tested, as well as for each set of parameters.

FIG. 4-10b is a box plot 4-1002b depicting radial Almansi strain for the posterior leaflets across all experiments tested, as well as for each set of parameters.

FIG. 4-11a is a box plot 4-1102a depicting radial Cauchy stress for the anterior leaflets across all experiments tested, as well as for each set of parameters.

FIG. 4-11b is a box plot 4-1102b depicting radial Cauchy stress for the posterior leaflets across all experiments tested, as well as for each set of parameters.

FIG. 4-12a is a box plot 4-1202a depicting shear Almansi strain for the anterior leaflets across all experiments tested, as well as for each set of parameters.

FIG. 4-12b is a box plot 4-1202b depicting shear Almansi strain for the anterior leaflets across all experiments tested, as well as for each set of parameters.

FIG. 4-13a is a box plot 4-1302a depicting shear Cauchy stress for the anterior leaflets across all experiments tested, as well as for each set of parameters.

FIG. 4-13b is a box plot 4-1302b depicting shear Cauchy stress for the posterior leaflets across all experiments tested, as well as for each set of parameters.

FIG. 4-14a is a box plot 4-1402a depicting percent leaflet area change across all experiments.

FIG. 4-14b is a box plot 4-1402b depicting mesh-to-mesh error in mm across all experiments for each set of parameters.

C. Experiments

To evaluate the valve simulation technique disclosed above, ten models of the mitral valve were generated based on intraoperative 4D TEE data obtained from six different patients at the Johns Hopkins University's School of Medicine as described further above.

Table 4-3 includes parameters for the imagery used in this study, and subjective ratings by a cardiologist regarding quality and artifacts present in each TEE cube.

TABLE 4-3

| | Voxel Resolution | Frame | Ultrasound | Image |
|---|---|---|---|---|
| Experiment | (mm) | Rate (Hz) | Depth (cm) | Quality |
| 1 | 0.67 × 0.66 × 0.58 | 41 | 12 | 2 |
| 2 | 0.67 × 0.66 × 0.58 | 41 | 12 | 1 |
| 3 | 0.72 × 0.71 × 0.63 | 39 | 13 | 2 |
| 4 | 0.72 × 0.71 × 0.63 | 39 | 13 | 2 |
| 5 | 0.78 × 0.77 × 0.68 | 36 | 14 | 1 |
| 6 | X | X | X | X |
| 7 | 0.67 × 0.66 × 0.58 | 41 | 12 | 1 |
| 8 | 0.37 × 0.36 × 0.39 | 56 | 8 | 2 |
| 9 | 0.78 × 0.77 × 0.68 | 36 | 14 | 2 |
| 10 | 0.72 × 0.71 × 0.63 | 39 | 13 | 2 |

To create each of the ten mitral valve models, the 4D TEE imagery was processed with the combined level-set/k-means segmentation technique disclosed further above.

The segmentation algorithm extracted a volumetric representation of the mitral valve and leaflets from each 4D TEE cube. The extracted volumetric valve was then converted to a single-plane mesh (tissue thickness is a simulation parameter), and manually examined to remove artifacts and fill holes in the mesh.

Two patient-specific valve meshes were obtained for each model. One valve mesh was acquired from the end of the diastolic phase and another from the beginning of the systolic phase, corresponding to times just before the valve begins to close and immediately after the valve closes, respectively.

The open valve mesh is taken from an image frame immediately before the valve begins to close to ensure that the entire valve closure process is simulated, as the open valve mesh is used as the starting point for the simulation. The closed valve mesh is used as the ground-truth measure for how the valve should appear when closed.

Using a custom tool, papillary muscles as well as primary and secondary chordae tendineae were manually placed and attached to each open valve mesh. By default, the chordae were set to a length equal to the distance between the papillary muscle and each individual chord's attachment point, in other words they are taught. A tether scaling simulation parameter can be varied to increase or decrease the lengths of the chordae. The custom tool also allows for manual specification of the anterior and posterior mitral leaflets. Separating the anterior and posterior leaflets allows the specification of unique physiologic parameters for each individual leaflet.

To account for annulus deformation in the simulation, the mitral valve annulus is segmented in both the open and closed frames. The open valve annulus segmentation defines the annulus on the open valve mesh and is used to differentiate free and fixed nodes. Open valve facets above the annulus are fixed and do not undergo simulation. Facets below the annulus are free and undergo simulated closure.

A patient-specific annulus deformation percentage is also calculated from the open and closed annulus segmentations, and applied during simulation to the annulus of the open valve mesh. Annulus deformation is included because the annulus shape may affect valve closure, and annulus nodes are not simulated and would thus otherwise remain fixed in their open valve configuration.

Simulation runtime ranges from 10-30 minutes for meshes with approximately 550 nodes and 1000 facets, as performed on a laptop with an i7-720QM 1.60 GHz quad-code processor with 4 GB of RAM. The simulation code is mostly un-optimized and single-threaded, running within MATLAB. Significant speed-up may be possible by utilizing multi-threaded or GPGPU approaches.

After a mitral valve model has reached its equilibrium closed state during simulation, it is compared to the ground-truth closed valve mesh that was segmented from the same image sequence. Ground-truth error is obtained by averaging the distances of each simulated closed mesh facet's centroid to the nearest facet centroid on the ground-truth closed mesh. To account for shadowing effects present in ground-truth ultrasound imagery of the closed mitral valve (the tips of each leaflet may be obscured), facets that are hidden behind other facets, according to the acoustic field of view of the ultrasound probe, are removed before error computation is performed.

The SVK model provides similar performance to Fung-type models in closure prediction. However, because the material is significantly stiffer for small deformations, the SVK model tends to under-predict strain compared to the other models. Predicted stresses are comparable across all three models.

D. Equation Derivations

1. Energy Density and Force Functions

FIG. 4-15 is an illustration of a reference feature 4-1502 having nodes p0, q0, and r0, and a feature 4-1504 having nodes p, q, and r. Feature 4-1504 is a deformed version of feature 4-1502 in that nodes p0, q0, and r0 of feature 4-1502 are displaced to positions of nodes p, q, and r, respectively. Vectors x, y, and z represent displacements of the nodes.

A deformation gradient tensor, F, provides a transformation between a reference configuration and a deformed configuration. The transformation is described below, where the node subscript index i is omitted with the understanding that quantities (i.e., stress, strain tensors, etc.), are computed with respect to each node of the model.

The transformation includes a rigid rotation, R, and a symmetric stretch tensor, U, with F=RU. The decomposition may also be performed in the opposite order such that F=VR. Since the rotation R is not physically significant, the right and left Cauchy-Green deformation tensors, C≡F^{T}F=U² and B≡FF^{T}=V², respectively, may provide more useful measures of deformation.

For a triangular patch of a thin-shell membrane, F transforms triangle (e.g., 4-1502 in FIG. 4-15), defined by vertices x₀, y₀, z₀, and opposing edges u₀, v₀, w₀, and normal n₀, into the deformed configuration (e.g., 4-1504 of FIG. 4-15), as:

u=Fu₀v=Fv₀w=Fw₀n=α\hat{n}=F\hat{n}₀, EQ. (4-6)

where \hat{n} and n are the normals to the reference and deformed facets respectively, and where α≡|\hat{n}| is the stretch factor in the direction normal to the facet.

Two orthogonal reference directions are defined in the plane of the facet â₀ and \hat{b}₀ with \hat{n}₀=â₀×\hat{b}₀. These vectors are transformed by F into a=Fâ₀ and b=F\hat{b}₀ with corresponding stretch factors λ=|a| and μ=|b|.

The ratio of deformed to undeformed volume is given by the Jacobian:

J=detF, EQ. (4-7)

with J=1 for incompressible materials.

Without loss of generality, matrices:

G₀≡u₀ê₁^{T}+v₀ê₂^{T}+\hat{n}₀ê₃^{T},and EQ. (4-8)

G≡uê₁^{T}+vê₂^{T}+nê₃^{T}, EQ. (4-9)

are defined such that

F=GG₀⁻¹ EQ. (4-10)

Taking the determinant provides:

$$det F = \frac{det G}{det {G}_{0}} = J . \qquad EQ . ( 4 \text{-} 11 )$$

The determinants are:

$$\begin{matrix}\begin{matrix}det G = n \cdot ( u \times v ) \\ = α \hat{n} \cdot ( u \times v ) \\ = α \frac{u \times v}{\vert u \times v \vert} \cdot ( u \times v ) \\ = α \vert u \times v \vert ,\end{matrix} \\ and & EQ . ( 4 \text{-} 12 ) \\ det {G}_{0} = {\hat{n}}_{0} \cdot ( {u}_{0} \times {v}_{0} ) = \vert {u}_{0} \times {v}_{0} \vert , & EQ . ( 4 \text{-} 13 )\end{matrix}$$

respectively, which provides:

$$α = J \frac{{A}_{0}}{A} , \qquad EQ . ( 4 \text{-} 14 )$$

where A₀≡|u₀×v₀| and A≡u×v|.

It follows that:

$$\begin{matrix}n = α \hat{n} \\ = J \frac{\vert {u}_{0} \times {v}_{0} \vert}{\vert u \times v \vert} \frac{u \times v}{\vert u \times v \vert} \\ = J \frac{{A}_{0}}{{A}^{2}} u \times v .\end{matrix} \qquad EQ . ( 4 \text{-} 15 )$$

A useful formula for A² is:

$$\begin{matrix}{A}^{2} = ( u \times v ) \cdot ( u \times v ) \\ = ( u \cdot u ) ( v \cdot v ) - ( u \cdot v ) ( u \cdot v ) \\ = {\vert u \vert}^{2} {\vert v \vert}^{2} - {( u \cdot v )}^{2} .\end{matrix} \qquad EQ . ( 4 \text{-} 16 )$$

Inverses of the G matrices are of the form:

$${G}^{- 1} = \frac{{\vert v \vert}^{2} {\hat{e}}_{1} - ( u \cdot v ) {\hat{e}}_{2}}{{A}^{2}} {u}^{T} + \frac{{\vert u \vert}^{2} {\hat{e}}_{2} - ( u \cdot v ) {\hat{e}}_{1}}{{A}^{2}} {v}^{T} + \frac{{\hat{e}}_{3}}{{\vert n \vert}^{2}} {n}^{T} , \qquad EQ . ( 4 \text{-} 17 )$$

which gives:

$$\begin{matrix}\begin{matrix}F = \underline{u} {u}_{0}^{T} + \underline{v} {v}_{0}^{T} + n {\hat{n}}_{0}^{T} \\ = u {\underline{u}}_{0}^{T} + v {\underline{v}}_{0}^{T} + n {\hat{n}}_{0}^{T} ,\end{matrix} \\ where \text{:} & EQ . ( 4 \text{-} 18 ) \\ {\underline{u}}_{0} ≡ {A}_{0}^{- 2} [ {\vert {v}_{0} \vert}^{2} {u}_{0} - ( {u}_{0} \cdot {v}_{0} ) {v}_{0} ] , & EQ . ( 4 \text{-} 19 ) \\ {\underline{v}}_{0} ≡ {A}_{0}^{- 2} [ {\vert {u}_{0} \vert}^{2} {v}_{0} - ( {u}_{0} \cdot {v}_{0} ) {u}_{0} ] , & EQ . ( 4 \text{-} 20 ) \\ \underline{u} ≡ {A}_{0}^{- 2} [ {\vert {v}_{0} \vert}^{2} u - ( {u}_{0} \cdot {v}_{0} ) v ] , & EQ . ( 4 \text{-} 21 ) \\ \underline{v} ≡ {A}_{0}^{- 2} [ {\vert {u}_{0} \vert}^{2} v - ( {u}_{0} \cdot {v}_{0} ) u ] . & EQ . ( 4 \text{-} 22 )\end{matrix}$$

Further defining the vectors:

$$\begin{matrix}\overline{u} ≡ {A}^{- 2} [ {\vert v \vert}^{2} u - ( u \cdot v ) v ] , & EQ . ( 4 \text{-} 23 ) \\ \overline{v} ≡ {A}^{- 2} [ {\vert u \vert}^{2} v - ( u \cdot v ) u ] , & EQ . ( 4 \text{-} 24 ) \\ {\overline{u}}_{0} ≡ {A}^{- 2} [ {\vert v \vert}^{2} {u}_{0} - ( u \cdot v ) {v}_{0} ] , & EQ . ( 4 \text{-} 25 ) \\ {\overline{v}}_{0} ≡ {A}^{- 2} [ {\vert u \vert}^{2} {v}_{0} - ( u \cdot v ) {u}_{0} ] , \\ provides \text{:} & EQ . ( 4 \text{-} 26 ) \\ \begin{matrix}{F}^{T} = {\underline{u}}_{0} {u}^{T} + {\underline{v}}_{0} {v}^{T} + {\hat{n}}_{0} {n}^{T} \\ = {u}_{0} {\underline{u}}^{T} + {v}_{0} {\underline{v}}^{T} + {\hat{n}}_{0} {n}^{T} ,\end{matrix} & EQ . ( 4 \text{-} 27 ) \\ \begin{matrix}{F}^{- 1} = {\overline{u}}_{0} {u}^{T} + {\overline{v}}_{0} {v}^{T} + {α}^{- 2} {\hat{n}}_{0} {n}^{T} \\ = {u}_{0} {\overline{u}}^{T} + {v}_{0} {\overline{v}}^{T} + {α}^{- 2} {\hat{n}}_{0} {n}^{T} ,\end{matrix} & EQ . ( 4 \text{-} 28 ) \\ \begin{matrix}{F}^{- T} = \overline{u} {u}_{0}^{T} + \overline{v} {v}_{0}^{T} + {α}^{- 2} n {\hat{n}}_{0}^{T} \\ = u {\overline{u}}_{0}^{T} + {v}_{0} {\overline{v}}_{0}^{T} + {α}^{- 2} n {\hat{n}}_{0}^{T} ,\end{matrix} & EQ . ( 4 \text{-} 29 )\end{matrix}$$

Vectors u₀, v₀, ū, and v̅ obey the orthogonality properties:

u₀·u₀=1v₀·u₀=0\hat{n}·u₀=0, EQ. (4-30)

u₀·v₀=0v₀·v₀=1\hat{n}·v₀=0, EQ. (4-31)

u·ū=1v·ū=0n·ū=0, EQ. (4-32)

u· v̅=0v· v̅=1n· v̅=0, EQ. (4-33)

while the remaining vectors satisfy:

u=Fu₀v=Fv₀ū₀=F⁻¹ū v̅₀=F⁻¹ v̅. EQ. (4-34)

There are several representations for C=FTF in terms of these vectors. One convenient form is:

C=(u·u)u₀u₀^{T}+(u·v)u₀v₀^{T}+(v·u)v₀u₀^{T}+(v·v)v₀v₀^{T}+α²\hat{n}₀\hat{n}₀^{T}, EQ. (4-35)

with:

u·u=A₀⁻²[|v₀|²|u|²−(u₀·v₀)(u·v)], EQ. (4-36)

u·v=A₀⁻²[|u₀|²(u·v)−(u₀·v₀)|u|²], EQ. (4-37)

v·u=A₀⁻²[|v₀|²(u·v)−(u₀·v₀)|v|²], EQ. (4-38)

v·v=A₀⁻²[|u₀|²|v|²−(u₀·v₀)(u·v)]. EQ. (4-36)

For C⁻¹:

C⁻¹=ū₀u₀^{T}+ v̅₀v₀^{T}+α⁻²\hat{n}₀\hat{n}₀^{T}. EQ. (4-40)

Where ∇_{{x,y,z}}C is used to determine forces to which the vertices are subjected, it is noted that:

$$\begin{matrix}{∇}_{x} {\vert u \vert}^{2} = 2 u {∇}_{x} {\vert v \vert}^{2} = - 2 v {∇}_{x} ( u \cdot v ) = v - u & EQ . ( 4 \text{-} 41 ) \\ {∇}_{y} {\vert u \vert}^{2} = 0 {∇}_{y} {\vert v \vert}^{2} = 2 v {∇}_{y} ( u \cdot v ) = u & EQ . ( 4 \text{-} 42 ) \\ {∇}_{z} {\vert u \vert}^{2} = - 2 u {∇}_{z} {\vert v \vert}^{2} = 0 {∇}_{z} ( u \cdot v ) = - v . & EQ . ( 4 \text{-} 43 )\end{matrix}$$

Unifying notation provides:

∇|u|²=2su∇|v|²=2tv∇(u·v)=sv+tu. EQ. (4-44)

for appropriate choices of s and t. These, in turn, give:

u₀≡A₀⁻²[|v₀|²u₀−(u₀·v₀)v₀], EQ. (4-45)

v₀≡A₀⁻²[|u₀|²v₀−(u₀·v₀)u₀], EQ. (4-46)

u≡A₀⁻²[|v₀|²u−(u₀·v₀)v], EQ. (4-47)

v≡A₀⁻²[|u₀|²v−(u₀·v₀)u], EQ. (4-48)

Thus:

$$\begin{matrix}∇ C = ∇ ( u \cdot \underline{u} ) {\underline{u}}_{0} {u}_{0}^{T} + ∇ ( u \cdot \underline{v} ) {\underline{u}}_{0} {v}_{0}^{T} + ∇ ( v \cdot \underline{u} ) {\underline{v}}_{0} {u}_{0}^{T} + ∇ ( v \cdot \underline{v} ) {\underline{v}}_{0} {v}_{0}^{T} + ∇ {α}^{2} {\hat{n}}_{0} {\hat{n}}_{0}^{T} , \\ with , & EQ . ( 4 \text{-} 49 ) \\ \frac{∇ {α}^{2}}{{α}^{2}} = \frac{∇ {J}^{2}}{{J}^{2}} - \frac{∇ {A}^{2}}{{A}^{2}} , \\ where , & EQ . ( 4 \text{-} 50 ) \\ ∇ {J}^{2} = ∇ det C = {J}^{2} tr {C}^{- 1} ∇ C , and & EQ . ( 4 \text{-} 51 ) \\ ∇ {A}^{2} = ∇ [ {\vert u \vert}^{2} {\vert v \vert}^{2} - {( u \cdot v )}^{2} ] = 2 {A}^{2} ( s \overline{u} + t \overline{v} ) . & EQ . ( 4 \text{-} 52 )\end{matrix}$$

∇C is a rank three tensor. Matrix notation will continue to be used below, keeping in mind that products, traces, etc., are taken to operate on the right-most vectors, as appropriate, leaving the leading vector unaffected. The traces of EQS. (4-35) and (4-49) are:

$$\begin{matrix}tr C = ( u \cdot \underline{u} ) + ( v \cdot \underline{v} ) + {α}^{2} , & EQ . ( 4 \text{-} 53 ) \\ \begin{matrix}tr ∇ C = ∇ ( u \cdot \underline{u} ) + ∇ ( v \cdot \underline{v} ) + ∇ {α}^{2} = \\ 2 s ( \underline{u} - {α}^{2} \overline{u} ) + 2 t ( \underline{v} - {α}^{2} \overline{v} ) + {α}^{2} \frac{∇ {J}^{2}}{{J}^{2}} .\end{matrix} & EQ . ( 4 \text{-} 54 )\end{matrix}$$

Writing the vectors â₀ and \hat{b}₀ in terms of u₀ and v₀ as:

$$\begin{matrix}\begin{matrix} {\hat{a}}_{0} = ( {\hat{a}}_{0} \cdot {\underline{u}}_{0} ) {u}_{0} + ( {\hat{a}}_{0} \cdot {\underline{v}}_{0} ) {v}_{0} , \\ = ( {\hat{a}}_{0} \cdot {u}_{0} ) {\underline{u}}_{0} + ( {\hat{a}}_{0} \cdot {v}_{0} ) {\underline{v}}_{0} , EQ . ( 4 \text{-} 56 )\end{matrix} & EQ . ( 4 \text{-} 55 ) \\ \begin{matrix} {\hat{b}}_{0} = {A}_{0}^{- 1} ( {\hat{a}}_{0} \cdot {u}_{0} ) {v}_{0} - {A}_{0}^{- 1} ( {\hat{a}}_{0} \cdot {v}_{0} ) {u}_{0} , \\ = {A}_{0} ( {\hat{a}}_{0} \cdot {\underline{u}}_{0} ) {\underline{v}}_{0} - {A}_{0} ( {\hat{a}}_{0} \cdot {\underline{v}}_{0} ) {\underline{u}}_{0} , EQ . ( 4 \text{-} 58 )\end{matrix} & EQ . ( 4 \text{-} 57 ) \\ gives \text{:} & \\ {λ}^{2} = {\hat{a}}_{0}^{T} C {\hat{a}}_{0} = ( {\hat{a}}_{0} \cdot {u}_{0} ) ( {\hat{a}}_{0} \cdot {\underline{u}}_{0} ) ( u \cdot \underline{u} ) + ( {\hat{a}}_{0} \cdot {v}_{0} ) ( {\hat{a}}_{0} \cdot {\underline{u}}_{0} ) ( u \cdot \underline{v} ) + ( {\hat{a}}_{0} \cdot {u}_{0} ) ( {\hat{a}}_{0} \cdot {\underline{v}}_{0} ) ( v \cdot \underline{u} ) + ( {\hat{a}}_{0} \cdot {v}_{0} ) ( {\hat{a}}_{0} \cdot {\underline{v}}_{0} ) ( v \cdot \underline{v} ) , & EQ . ( 4 \text{-} 59 ) \\ {μ}^{2} = {\hat{b}}_{0}^{T} C {\hat{b}}_{0} = ( {\hat{a}}_{0} \cdot {v}_{0} ) ( {\hat{a}}_{0} \cdot {\underline{v}}_{0} ) ( u \cdot \underline{u} ) - ( {\hat{a}}_{0} \cdot {u}_{0} ) ( {\hat{a}}_{0} \cdot {\underline{v}}_{0} ) ( u \cdot \underline{v} ) - ( {\hat{a}}_{0} \cdot {v}_{0} ) ( {\hat{a}}_{0} \cdot {\underline{u}}_{0} ) ( v \cdot \underline{u} ) + ( {\hat{a}}_{0} \cdot {u}_{0} ) ( {\hat{a}}_{0} \cdot {\underline{u}}_{0} ) ( v \cdot \underline{v} ) , & EQ . ( 4 \text{-} 60 ) \\ and \text{:} & \\ {\hat{a}}_{0}^{T} ∇ C {\hat{a}}_{0} = ( {\hat{a}}_{0} \cdot {u}_{0} ) ( {\hat{a}}_{0} \cdot {\underline{u}}_{0} ) ∇ ( u \cdot \underline{u} ) + ( {\hat{a}}_{0} \cdot {v}_{0} ) ( {\hat{a}}_{0} \cdot {\underline{u}}_{0} ) ∇ ( u \cdot \underline{v} ) + ( {\hat{a}}_{0} \cdot {u}_{0} ) ( {\hat{a}}_{0} \cdot {\underline{v}}_{0} ) ∇ ( v \cdot \underline{u} ) + ( {\hat{a}}_{0} \cdot {v}_{0} ) ( {\hat{a}}_{0} \cdot {\underline{v}}_{0} ) ∇ ( v \cdot \underline{v} ) , & EQ . ( 4 \text{-} 61 ) \\ {\hat{b}}_{0}^{T} ∇ C {\hat{b}}_{0} = ( {\hat{a}}_{0} \cdot {v}_{0} ) ( {\hat{a}}_{0} \cdot {\underline{v}}_{0} ) ∇ ( u \cdot \underline{u} ) - ( {\hat{a}}_{0} \cdot {u}_{0} ) ( {\hat{a}}_{0} \cdot {\underline{v}}_{0} ) ∇ ( u \cdot \underline{v} ) - ( {\hat{a}}_{0} \cdot {v}_{0} ) ( {\hat{a}}_{0} \cdot {\underline{u}}_{0} ) ∇ ( v \cdot \underline{u} ) + ( {\hat{a}}_{0} \cdot {u}_{0} ) ( {\hat{a}}_{0} \cdot {\underline{u}}_{0} ) ∇ ( v \cdot \underline{v} ) , . & EQ . ( 4 \text{-} 62 )\end{matrix}$$

While the second Piola-Kirchhoff stress is used in the above formulation, it is not an objective (i.e., frame-independent) stress measure. The Cauchy stress, σ=J⁻¹FSF^{T}, is an objective tensor and hence is more useful for describing the stress present in the material. Of interest are We are interested in the components of σ in the directions parallel and perpendicular to some reference direction a. For anisotropic models, this may be taken to be the fiber direction. While the vector b₀ is perpendicular to so, the same is not true for the vectors a and b, a vector b₀ may be defined perpendicular to a as:

$$\begin{matrix}c ≡ \frac{b}{μ} - cos θ \frac{a}{λ} = \frac{1}{λμ} F ( λ {\hat{b}}_{0} - μ cos θ {\hat{a}}_{0} ) , \\ where \text{:} & EQ . ( 4 \text{-} 63 ) \\ cos θ ≡ \frac{a \cdot b}{λμ} . & EQ . ( 4 \text{-} 64 )\end{matrix}$$

The magnitude of c is:

$$\begin{matrix}\vert c \vert = \frac{1}{λμ} \sqrt{( λ b - μ cos θ a ) \cdot ( λ b - μ cos θ a )} \\ = sin θ .\end{matrix} \qquad EQ . ( 4 \text{-} 65 )$$

The components of the Cauchy stress tensor parallel and perpendicular to a are thus:

$$\begin{matrix}{σ}_{aa} ≡ {\hat{a}}^{T} σ \hat{a} = \frac{{a}^{T} σ a}{{\vert a \vert}^{2}} = \frac{{\hat{a}}_{0}^{T} CSC {\hat{a}}_{0}}{J {λ}^{2}} , & EQ . ( 4 \text{-} 66 ) \\ {σ}_{cc} = \frac{( λ {\hat{b}}_{0}^{T} - μ cos θ {\hat{a}}_{0}^{T} ) CSC ( λ {\hat{b}}_{0} - μ cos θ {\hat{a}}_{0} )}{J {λ}^{2} {μ}^{2} {sin}^{2} θ} & \\ {σ}_{ac} ≡ {\hat{a}}^{T} σ \hat{c} = \frac{{σ}_{ab} - cos {θσ}_{aa}}{sin θ} . \\ where \text{:} & EQ . ( 4 \text{-} 68 ) \\ {σ}_{bb} = \frac{{\hat{b}}_{0}^{T} CSC {\hat{b}}_{0}}{J {μ}^{2}} , and & EQ . ( 4 \text{-} 69 ) \\ {σ}_{ab} = \frac{{\hat{a}}_{0}^{T} CSC {\hat{b}}_{0}}{J λμ} . & EQ . ( 4 \text{-} 70 )\end{matrix}$$

The Alamansi strain tensor, ε, provides an objective stain measure and is given by:

$$ɛ = \frac{1}{2} ( 1 - {B}^{- 1} ) . \qquad EQ . ( 4 \text{-} 71 )$$

The components are:

$$\begin{matrix}{ɛ}_{aa} ≡ {\hat{a}}^{T} ɛ \hat{a} = \frac{{a}^{T} ɛ a}{{\vert a \vert}^{2}} = \frac{1}{2} \frac{{\hat{a}}_{0}^{T} C {\hat{a}}_{0} - 1}{{\hat{a}}_{0}^{T} C {\hat{a}}_{0}} = \frac{1}{2} ( 1 - {λ}^{- 2} ) , & EQ . ( 4 \text{-} 72 ) \\ {ɛ}_{cc} = \frac{1}{2} ( 1 - \frac{{λ}^{2} + {μ}^{2} {cos}^{2} θ}{{λ}^{2} {μ}^{2} {sin}^{2} θ} ) , and & EQ . ( 4 \text{-} 73 ) \\ {ɛ}_{ac} = \frac{1}{2 {λ}^{2}} \frac{cos θ}{sin θ} . & EQ . ( 4 \text{-} 74 )\end{matrix}$$

2. St. Venant-Kerchoff Model

The St. Venant-Kirchoff model is a generalization of linear elastic materials to the finite strain regime in which the energy density per unit volume of an undeformed configuration is given by:

$$Ψ = \frac{1}{2} tr ( SE ) , \qquad EQ . ( 4 \text{-} 75 )$$

where the Green strain is defined by:

$$E ≡ \frac{1}{2} ( C - 1 ) . \qquad EQ . ( 4 \text{-} 76 )$$

For an isotropic Hookean material:

$$S = 2 G [ E - \frac{1}{3} ( tr E ) 1 ] - {p}^{′} 1 , \qquad EQ . ( 4 \text{-} 77 )$$

where the shear modulus, G, is:

$$G = \frac{E}{2 ( 1 + v )} , \qquad EQ . ( 4 \text{-} 78 )$$

for Young's modulus E and Poisson's ratio v (where v=½ for incompressible materials).

The pressure, p′, is defined as:

$${p}^{′} ≡ - \frac{1}{3} tr S . \qquad EQ . ( 4 \text{-} 79 )$$

Another constraint is that the infinitesimal change in volume is proportion to the pressure:

$$- \frac{1}{3} tr E = \frac{1 - 2 v}{E} {p}^{′} . \qquad EQ . ( 4 \text{-} 80 )$$

The vanishing of the normal stress may be used to determine p′, as:

$${\hat{n}}_{0}^{T} S {\hat{n}}_{0} = \frac{1}{2} \frac{E}{1 + v} ( {α}^{2} - 1 ) - \frac{3 v}{1 + v} {p}^{′} = 0. \qquad EQ . ( 4 \text{-} 81 )$$

which gives:

$$\begin{matrix}{p}^{′} = \frac{1}{6} \frac{E}{v} ( {α}^{2} - 1 ) = - \frac{1}{3} \frac{E}{1 - v} z , \\ where \text{:} & EQ . ( 4 \text{-} 82 ) \\ z ≡ \frac{1 - v}{2 v} ( 1 - {α}^{2} ) . & EQ . ( 4 \text{-} 83 )\end{matrix}$$

EQ. (4-77) may thus be written as:

$$\begin{matrix}S = \frac{1}{2} \frac{E}{1 + v} ( C - {α}^{2} 1 ) \\ = \frac{1}{2} \frac{E}{1 + v} [ C - ( 1 - \frac{2 v}{1 - v} z ) 1 ] .\end{matrix} \qquad EQ . ( 4 \text{-} 84 )$$

From EQS. (4-80) and (4-82):

$$tr E = \frac{1 - 2 v}{1 - v} z . \qquad EQ . ( 4 \text{-} 85 )$$

Taking the trace of EQ. (4-76) and equating it to the above gives:

$$\frac{1}{2} ( trC - 3 ) = \frac{1 - 2 v}{1 - v} z . \qquad EQ . ( 4 \text{-} 86 )$$

With EQ. (4-53), this is:

$$\begin{matrix}3 + 2 \frac{1 - 2 v}{1 - v} z = ( u \cdot \underline{u} ) + ( v \cdot \underline{v} ) + {α}^{2} \\ = ( u \cdot \underline{u} ) + ( v \cdot \underline{v} ) + 1 - \frac{2 v}{1 - v} z .\end{matrix} \qquad EQ . ( 4 \text{-} 87 )$$

Solving for z gives:

$$z = \frac{u \cdot \underline{u} + v \cdot \underline{v}}{2} - 1. \qquad EQ . ( 4 \text{-} 88 )$$

Substituting EQ. (4-84) into EQ. (4-75) gives:

$$Ψ = \frac{1}{4} \frac{E}{1 + v} [ 2 \frac{1 - 2 v}{1 - v} {( z + 1 )}^{2} + \frac{1 + v}{1 - v} - {J}^{2} tr {C}^{- 1} ] . \qquad EQ . ( 4 \text{-} 89 )$$

Here, use has been made of the equivalence:

C=I₁1−I₂C⁻¹+I₃C⁻², EQ. (4-90)

where I₁=trC, I₂=I₃trC⁻¹, and I₃=detC=J², are the invariants of C. From this can be written:

$$\begin{matrix}tr {C}^{2} = ( tr {C}^{2} ) - 2 {J}^{2} tr {C}^{- 1} , \\ and & EQ . ( 4 \text{-} 91 ) \\ \begin{matrix}{J}^{2} tr {C}^{- 1} = \frac{{( tr C )}^{2} - tr {C}^{2}}{2} \\ = ( u \cdot \underline{u} ) ( v \cdot \underline{v} ) - ( u \cdot \underline{v} ) ( v \cdot \underline{u} ) + 2 ( z + 1 ) {α}^{2} .\end{matrix} & EQ . ( 4 \text{-} 92 )\end{matrix}$$

Differentiating EQ. (4-89) gives:

$$\begin{matrix}∇ Ψ = \frac{1}{2} \frac{E}{1 + v} [ \frac{1 - v + 2 z}{1 - v} ( s \underline{u} + t \underline{v} ) - \frac{{A}^{2}}{{A}_{0}^{2}} ( s \overline{u} + t \overline{v} ) ] , \\ where \text{:} & EQ . ( 4 \text{-} 93 ) \\ \begin{matrix} ∇ z = \frac{∇ ( u \cdot \underline{u} ) + ∇ ( v \cdot \underline{v} )}{2} \\ = s \underline{u} + t \underline{v} , and\end{matrix} & EQ . ( 4 \text{-} 94 ) \\ ∇ ( {J}^{2} tr {C}^{- 1} ) = 2 \frac{{A}^{2}}{{A}_{0}^{2}} ( s \overline{u} + t \overline{v} ) + 2 ( 1 - \frac{2 v}{1 - v} - \frac{4 v}{1 - v} ) ∇ z . & EQ . ( 4 \text{-} 95 )\end{matrix}$$

For computing the Cauchy stress, the quantity CSC is needed, which is given by:

$$CSC = \frac{1}{2} \frac{E}{1 + v} [ 2 ( 1 + z ) {C}^{2} - {J}^{2} ( tr {C}^{- 1} ) C + {J}^{2} 1 ] , \qquad EQ . ( 4 \text{-} 96 )$$

where EQ. (4-90) has again been used.

3. May-Newman-Yin (MNY) Model

A Fung-type hyperelastic law proposed by May-Newman-Yin may be used to model properties of biological tissue, with strain energy density function:

Ψ=c₀[e^{c}^{₁}^{(I}^{₁}⁻³⁾^{²}^{+c}^{₂}^{(λ-1)}^{⁴}−1], EQ. (4-97)

where I₁=trC and:

λ²≡|a|²=â₀^{T}F^{T}Fâ₀=â₀^{T}Câ₀≡I₄. EQ. (4-98)

with â₀ the fiber direction in the reference configuration.

For incompressible materials (J=1), the second Piola-Kirchoff stress tensor S is:

$$\begin{matrix}S = 2 {\sum }_{i = 1 , 4}^{ } {ψ}_{i} \frac{\partial {I}_{i}}{\partial C} - {p}^{′} {C}^{- 1} \\ = 2 {ψ}_{1} 1 + 2 {ψ}_{4} {\hat{a}}_{0} {\hat{a}}_{0}^{T} - {p}^{′} {C}^{- 1} \\ ≡ {S}^{′} - {p}^{′} {C}^{- 1} ,\end{matrix} \qquad EQ . ( 4 \text{-} 99 )$$

where ψ₁≡∂Ψ/∂I₁ with:

ψ₁=2c₀c₁(I₁−3)e^{c}^{₁}^{(I}^{₁}⁻³⁾^{²}^{+c}^{₂}^{(λ-1)}^{⁴},and EQ. (4-100)

ψ₄=2c₀c₂λ⁻¹(λ−1)³e^{c}^{₁}^{(I}^{₁}⁻³⁾^{²}^{+c}^{₂}^{(λ-1)}^{⁴}, EQ. (4-101)

and from the condition that the normal stress is zero ((\hat{n}₀^{T}S\hat{n}₀=0):

$$2 {ψ}_{1} {α}^{2} , \begin{matrix}{p}^{′} = \frac{{\hat{n}}_{0}^{T} {S}^{′} {\hat{n}}_{0}}{{\hat{n}}_{0}^{T} {C}^{- 1} {\hat{n}}_{0}} \\ = \frac{2 {ψ}_{1}}{{\hat{n}}_{0}^{T} {C}^{- 1} {\hat{n}}_{0}} \\ = \frac{2 {ψ}_{1}}{{\vert F - {}_{}^{T}{\hat{n}}{}_{0}^{} \vert}^{2}}\end{matrix} \qquad EQ . ( 4 \text{-} 102 )$$

which gives:

S=2ψ₁(1−α²C⁻¹)+2ψ₄â₀â₀^{T}. EQ. (4-103)

From the strain energy density, Ψ, the force on each node is given by:

$$\begin{matrix}∇ Ψ = \frac{1}{2} tr S ∇ C \\ = {ψ}_{1} tr ∇ C + {ψ}_{4} {\hat{a}}_{0}^{T} ∇ C {\hat{a}}_{0} ,\end{matrix} \qquad EQ . ( 4 \text{-} 104 )$$

where trC⁻¹∇C=∇j²/j²=0 is used due to the incompressibility assumption. From EQS. (4-54) and (4-61), this is given by:

$$∇ Ψ = 2 {ψ}_{1} [ s ( \underline{u} - {α}^{2} \overline{u} ) + t ( \underline{v} - {α}^{2} \overline{v} ) ] + 2 {ψ}_{4} \frac{s [ {\vert {v}_{0} \vert}^{2} - {( {\hat{a}}_{0} \cdot {v}_{0} )}^{2} ] u + t [ {\vert {u}_{0} \vert}^{2} - {( {\hat{a}}_{0} \cdot {u}_{0} )}^{2} ] v}{{A}_{0}^{2}} + 2 {ψ}_{4} \frac{[ ( {\hat{a}}_{0} \cdot {u}_{0} ) ( {\hat{a}}_{0} \cdot {v}_{0} ) - ( {u}_{0} \cdot {v}_{0} ) ] ( t u + s v )}{{A}_{0}^{2}} , \qquad EQ . ( 4 \text{-} 105 )$$

where (s, t)=(1, −1), (0, 1), (−1, 0) for ∇ₓ, ∇_{y}, and ∇_{z}, respectively.

CSC=2ψ₁(C²−α²C)+2ψ₄Câ₀â₀^{T}C. EQ. (4-106)

The in-plane components of the Cauchy stress are:

$$\begin{matrix}{σ}_{aa} = 2 {ψ}_{1} [ \frac{{\hat{a}}_{0}^{T} {C}^{2} {\hat{a}}_{0}}{{λ}^{2}} - {α}^{2} ] + 2 {ψ}_{4} {λ}^{2} , & EQ . ( 4 \text{-} 107 ) \\ {σ}_{bb} = 2 {ψ}_{1} [ \frac{{\hat{b}}_{0}^{T} {C}^{2} {\hat{b}}_{0}}{{μ}^{2}} - {α}^{2} ] + 2 {ψ}_{4} \frac{{( {\hat{a}}_{0}^{T} {C}^{2} {\hat{b}}_{0} )}^{2}}{{μ}^{2}} , \\ and & EQ . ( 4 \text{-} 108 ) \\ {σ}_{ab} = 2 {ψ}_{1} [ \frac{{\hat{a}}_{0}^{T} {C}^{2} {\hat{b}}_{0}}{λμ} - {α}^{2} \frac{{\hat{a}}_{0}^{T} {C}^{2} {\hat{b}}_{0}}{λμ} ] + 2 {ψ}_{4} {λ}^{2} \frac{{\hat{a}}_{0}^{T} {C}^{2} {\hat{b}}_{0}}{λμ} , & EQ . ( 4 \text{-} 109 )\end{matrix}$$

with σ_{cc} and σ_{ac} given by EQS. (4-67) and 4-(68), respectively.

4. Holzapfel Model

For the Holzapfel hyperelastic model, the force, stress, and strain are given above with the energy density function replaced by:

Ψ=c₀¹[e^{c}^{₁}^{¹}^{(I}^{₁}⁻³⁾^{²}^{+c}^{₂}^{¹}^{(I}^{₄}⁻¹⁾^{²}−1], EQ. (4-110)

with derivatives:

ψ₁=2c₀¹c₁¹(I₁−3)e^{c}^{₁}^{¹}^{(I}^{₁}⁻³⁾^{²}^{+c}^{₂}^{¹}^{(I}^{₄}⁻¹⁾^{²}−1,and EQ. (4-111)

ψ₄=2c₀¹c₂¹(I₄−1)e^{c}^{₁}^{¹}^{(I}^{₁}⁻³⁾^{²}^{+c}^{₂}^{¹}^{(I}^{₄}⁻¹⁾^{²}−1. EQ. (4-112)

### V. Patient-Specific Blood Flow Motion Estimation

Methods and systems are disclosed below to characterize hemodynamics, or blood motion flow from ultrasound images using computer vision-inspired optical flow computational techniques. Also disclosed below are techniques to exploit images obtained contrast enhanced ultrasound (CEUS), such as with an echographic contrast agent.

Methods and systems are described below with respect to characterization of hemodynamics in the left heart complex. The methods and systems are not, however, limited to the heart.

Methods and systems described below may be useful in one or more of a variety of applications, examples of which are provided below. The methods and systems are not, however, limited to these examples.

Techniques disclosed below may be employed clinically as part of automated or machine-implemented diagnostic technique for pathologies such as Hypertrophic Cardiomyopathy (HCM).

Techniques disclosed below may be used in the detection of organ laceration and hemorrhage.

Techniques disclosed below may be implemented with computer simulation models, such as disclosed herein, such as to provide a training tool for ultra-sonographers.

Recovered blood flow may be used in constructing a modeling tool, such as disclosed herein, which may be used, for example, in computed assisted surgery.

### A. Contrast Enhanced Ultrasound

With contrast enhanced ultrasound (CEUS), a solution of micro-bubbles or micro-spheres is injected in the blood stream. The microspheres include a gas to be absorbed, such as octafluoropropane or nitrogen, encased in a shell, such as a lipid layer. An impedance mismatch between blood and air, and to a greater extent the

Oscillation of the microspheres under excitation by the ultrasonic acoustic signal and, to a lesser extent, impedance mismatch between blood and air, result in backscatter. The bubbles therefore become relatively highly echogenic which results in an image having significant contrast between the bubbles/blood and surrounding tissues.

Bubble studies have been conducted with respect to visual segmentation of the myocardium, blood perfusion, and to compute physiologically entities such as ejection fraction.

The micro-spheres are of the order of the micron, however, whereas pixel size resolution of ultrasound may be several orders of magnitude greater (e.g., millimeters or fractions of millimeters). The micro-spheres do, however, form intensity contrast fronts and shadows, which are exploited herein to compute motion of blood flow.

Since the micro-spheres perfuse through organs, such as heart, liver, kidneys, the intensity contrast fronts and shadows may be exploited for other purposes including, without limitation, lacerations and/or metastases in organs.

A contrast agent, such as an echographic contrast agent, may improve segmentation of the myocardium boundary.

FIG. 5-1 is an image of a frame 5-100 of a sequence of transthoracic CEUS images taken during systole, showing contrast enhanced blood (light areas) in the center of frame 5-100 and surrounding myocardium (darker areas).

FIG. 5-2 is an image of another frame 5-200 of the sequence of transthoracic CEUS images taken during diastole.

In frames 5-100 and 5-200 blood appears with sufficient contrast and texture to be distinguished from myocardium.

As a result, in sequences of sufficient quality, contrast allows the visualization of apparent blood motion. Flow may then be derived from a sequence of generated images using one or more optic flow techniques, such as taught in Liu, Brox, Bruhn, Horn, and/or Lucas.

### B. Blood Motion Flow Estimation

Disclosed below are computational techniques to recover blood motion flow, such as left ventricle hemodynamics, based on the estimation of apparent optical flow observed in CEUS.

Visual flow may be computed from contrast enhanced echocardiographic images with a multi-resolution approach that exploits an image brightness constancy assumption and a second order constraint.

For the first constraint, the brightness intensity of the ultrasound image, denoted as I(x, t), is a spatiotemporal function of both the image pixel position x[x,y] and time t.

The brightness constancy assumption states that the intensity of a given feature point will not change in the small time interval at when a point moves from one frame to the next, as in:

I(x,t)=I(x+u,t+∂t) EQ. (5-1)

Taking the first order Taylor series expansion and neglecting terms higher than the first order yields:

∇I(x,t)·u+∂t=0 EQ. (5-2)

which is the familiar optical flow equation where the vector u denotes the unknown motion flow vector.

EQ. (5-2) may be re-written to state that the total derivative of the intensity is zero:

$$\frac{d l ( x ( t ) , t )}{d t} = 0 \qquad EQ . ( 5 \text{-} 3$$

which again echoes the brightness constancy constraint in EQ. (5-1).

Each of EQS. (5-1) and (5-2) include two unknowns. Additional constraints, such as a regularization smoothness constraint, may be imposed to overcome this. Regularization smoothness constraints may be expressed or defined in one or more of a variety of forms. An example constraint may be that flow of neighboring pixels be similar, or that flow changes be temporally smooth.

Another consideration for flow computation is efficiency.

Another consideration for flow computation is that image displacements may be sufficiently large to invalidate the assumptions in EQ. (5-1). A remedy for this is the use of image pyramids, such as in Lucas.

In Lucas, flow is first computed at the lowest resolution level of the pyramid. The computed flow is used to warp one image into another. Residual flow remaining after up-sampling and warping is then recomputed at the next finer level of the image pyramid. This is repeated until the finest level is reached. The various residual flows are then combined across all levels to form a final estimate of the flow vector u.

In Liu, Brox, and Bruhn, in addition to the first order brightness constancy constraint in EQ. (5-1), an additional constraint is added, which states that the image intensity gradient remains constant when following a point from one frame to the next, as in:

∇I(x,t)=∇I(x+u,t++∂t) EQ. (5-4)

An energy functional is disclosed herein that combines constraints EQS. (5-1) and (5-2), and further includes an additional spatiotemporal smoothness constraint for the computed flow vector u.

A coarse-to-fine multi-resolution warp-and-refine approach, such as described above, may be employed. A solution is found by minimizing the energy function, such as with a Gauss-Seidel SOR approach or a conjugate gradient approach. The Gauss-Seidel SOR approach is taught in Liu and in Brox. The conjugate gradient approach is taught in Bruhn. In experiments described below, the conjugate gradient approach of Bruhn is used.

A. Experiments

Transthoracic Echocardiographic acquisition was performed allowing the viewing of the intraventricular cavity with the use of a contrast agent (Definity, Perflutren Lipid Microsphere).

Optical flow estimation techniques disclosed further above are used to exploit the first and second order intensity constraints.

Intensity-based segmentation of the echocardiographic image, such as described further above, is used to segment the intraventricular cavity from the surrounding myocardium.

Blood flow is computed over an entire heart cycle.

FIG. 5-3 is an image 5-300 of computed flow at early systole stage.

FIG. 5-4 is an image 5-400 of computed flow at mid systole stage.

FIG. 5-5 is an image 5-500 of computed flow at early diastole stage.

FIG. 5-6 is an image 5-600 of computed flow at mid diastole stage.

In FIGS. 5-3 through 5-6, yellow arrows indicate blood flow in the intraventricular cavity. Red arrows denote blood flow in the surrounding tissues.

Qualitative assessments of the computed flow agree with expected physiological behavior of the blood motion during the diastolic phase (i.e., inflow from the atrium into the ventricle) and the systolic phase (i.e., ejection from the ventricle into the aortic artery).

### VI. Example Implementations

Methods and systems disclosed herein may be implemented in a system and/or machine, which may include hardware, firmware, a computer system, and combinations thereof, including discrete and integrated circuitry, application specific integrated circuits (ASICs), and/or microcontrollers, and may be implemented as part of a domain-specific integrated circuit package or system-on-a-chip (SOC), and/or a combination of integrated circuit packages.

FIG. 6-1 is a block diagram of a computer system 6-100, configured to process ultrasound data, such as 3DTEE.

Computer system 6-100 includes one or more computer instruction processor units and/or processor cores, illustrated here as a processor 6-102, to execute instructions of a computer program, which may also referred to herein as software, code, and/or computer program logic. Processor 6-102 may include a general purpose instruction processor, a controller, a microcontroller, or other instruction-based processor.

Computer system 6-100 further includes storage 6-104, which may include a non-transitory medium.

FIG. 6-2 is a block diagram of processor 6-102 and storage 6-104, where storage 6-104 includes primary storage 6-202, secondary storage 6-204, and off-line storage 6-206.

Primary storage 6-202 includes registers 6-208, processor cache 6-210, and main memory or system memory 6-212. Registers 6-208 and cache 6-210 may be directly accessible by processor 6-102. Main memory 6-212 may be accessible to processor 6-102 directly and/or indirectly through a memory bus. Primary storage 6-202 may include volatile memory such as random-access memory (RAM) and variations thereof including, without limitation, static RAM (SRAM) and/or dynamic RAM (DRAM).

Secondary storage 6-204 may be indirectly accessible to processor 6-102 through an input/output (I/O) channel, and may include non-volatile memory such as read-only memory (ROM) and variations thereof including, without limitation, programmable ROM (PROM), erasable PROM (EPROM), and electrically erasable PROM (EEPROM). Non-volatile memory may also include non-volatile RAM (NVRAM) such as flash memory. Secondary storage 6-204 may be configured as a mass storage device, such as a hard disk or hard drive, a flash memory drive, stick, or key, a floppy disk, and/or a zip drive.

Off-line storage 6-206 may include a physical device driver and an associated removable storage medium, such as an optical disc.

In FIG. 6-1, storage 6-104 includes data 6-108 to be used by processor 6-102 during execution of a computer program, and/or generated by processor 6-102 during execution of a computer program.

Storage 6-104 further includes a computer program 6-110 to cause processor 6-102 to process ultrasound image data.

In the example of FIG. 6-1, computer program 6-116 includes segmentation instructions 6-110 to cause processor 6-102 to segment ultrasound image data 6-114 as segmented image data 6-116, such as described further above. Ultrasound image data 114 may include 3D TEE image data.

Computer program 6-116 may further include displacement vector instructions 6-118 to cause processor 6-102 to compute displacement vectors 120 from a sequence of frames of segmented image data 6-116, such as described further above.

Ultrasound image data 6-114 may include CEUS image data, and computer program 6-116 may further include blood motion flow instructions 6-126 to cause processor 6-102 to compute blood motion flow data 6-128 the CEUS image data, such as described further above.

Computer program 6-116 may further includes motion modeling instructions 6-122 to cause processor 6-102 to construct one or more models 6-124 from a multi-frame sequence of segmented image data 6-116 (e.g., 4D TEE image data), such as described further above. Motion modeling instructions 6-122 may include instructions to utilize displacement vectors 6-120 and or blood motion flow data 6-128.

Computer system 6-100 may include communications infrastructure to communicate amongst devices and/or resources of computer system 6-100.

Computer system 6-100 may include one or more input/output (I/O) devices and/or controllers 6-142 to communicate with one or more other systems, such as to receive ultrasound image data 6-114 from an ultrasound probe and/or from an ultrasound system, and/or to output one or more of segmented image data 6-116, displacement vectors 6-120, model(s) 6-124, and blood motion flow data 6-128 to one or more other systems, such as a display or other storage device.

Features disclosed herein may be implemented alone and/or in combination with one another, and/or in combination with one or more other techniques. For example, and without limitation, one or more of the segmentation techniques, tissue displacement computation techniques, tissue motion modeling techniques, tissue stress/strain computation techniques, and blood motion flow computation techniques disclosed herein may be implemented alone and/or in combination with one another, and/or in combination with one or more other techniques. Examples implementations are provided below.

A machine-implemented method of processing volumetric (3D) ultrasound or time-sequential volumetric (4D) ultrasound image data to analyze and predict patient-specific physiological behavior of a human anatomical entity, organ, and subcomponents, such to assist physicians in performing diagnostics and preoperative planning, may include one or more of:
automatically segmenting and tracking the patient-specific anatomical entity and organ anatomical features from 3D/4D ultrasound;
computing the patient-specific organ tissue motion from 3D/4D ultrasound image data, and blood flow from contrast-enhanced 3D/4D ultrasound image data;
simulating the patient specific mechanical behavior of the organ and anatomical entity using 3D/4D ultrasound image data and physics-based models; and
estimating stress and strain of the organ tissues and physiological constitutive parameters of the organ tissues from 3D/4D ultrasound.

A machine-implemented method of processing volumetric (3D) ultrasound or time-sequential volumetric (4D) ultrasound image data to analyze and predict patient-specific physiological behavior of the heart complex and the heart subcomponents, including any of the heart valve complex components, including the mitral valve and aortic apparatus, and/or the left and right atria, and/or the left and right ventricles, to assist physicians in performing diagnostics and cardiac preoperative planning, may include one or more of:
automatically segmenting and tracking patient-specific cardiac anatomical features from 3D/4D ultrasound;
computing the patient-specific tissue motion from 3D/4D ultrasound image data and blood flow from contrast-enhanced 3D/4D ultrasound image data;
simulating the patient specific mechanical behavior of the heart and cardiac anatomical subcomponents using 3D/4D ultrasound image data and physics-based models; and
estimating stress and strain of the heart tissues and physiological constitutive parameters of the heart tissues from 3D/4D ultrasound.

In the methods above, the delineation of the anatomical components may be obtained using an automated segmentation technique including thresholding, k-means clustering, structure tensors, level sets, graph cuts, texture-based segmentation, or Markov random fields. Tracking of anatomical components may be obtained using an automated tracking method including Bayesian filtering, Kalman filter, condensation filter, particle filter, or machine learning-based filter.

A method described above may include computing 3D displacement vectors from 3D/4D ultrasound image data, and computing 3D blood flow vectors from 3D/4D contrast enhanced ultrasound.

The computing may include computing displacement vectors for voxels of the time-sequential series of frames with an energy function that includes a first-order brightness-constancy function that penalizes differences in voxel values between adjacent image frames, and a spatiotemporal smoothness function that penalizes tensor gradient in flow vectors at each voxel based on magnitudes of the gradients.

The energy function may include a second order regularization component including a smoothness constraint including one or more of: penalizing flow based on difference in flow of a neighboring pixel; penalizing flow based on temporal smoothness; and penalizing flow based on a measure of energy efficiency.

The computing of displacement vectors may include iteratively computing displacement vectors for each frame with coarse-to-fine pyramid computations and median-filtering at intermediate computation stages of the pyramid.

The computing of displacement vectors may include minimizing an energy function using an iterative numeric approximation technique that includes gradient descent or quasi-Newton or inner and outer fixed-point iterations.

A method as described above may include constructing a patient-specific machine-implemented model based on the patient-specific 3D segmented image data to simulate motion of anatomical features therein between first and second configurations. The method may include constructing a patient-specific mesh corresponding to the first configuration, associating at least three degrees of motion freedom with each node of the mesh.

The method may further include associating an energy term with each node of the mesh, including an energy component, including at least strain energy and external force energy, and minimizing this energy to identify displacements of the mesh from the first configuration to the second configuration based on the patient-specific segmented image data.

Alternatively, the method may further include solving Newton's equations for each node to determine the time-sequential dynamic trajectory of the mesh from the first configuration to the second configuration based on the patient-specific segmented image data.

In a method described above, a patient-specific machine-implemented model of the mitral or aortic valve may constructed based on the patient-specific 3D segmented image data to simulate motion of the said valve complex therein between the open valve and closed valve configurations. This may include constructing a patient-specific mesh of the valve and its subcomponents corresponding to the open valve configuration, and associating at least three degrees of motion freedom with each node of the mesh.

The method may further include associating an energy term with each node of the mesh, including an energy component, including at least strain energy and external force energy, including blood loading energy and leaflet collision energy, and minimizing the energy to identify displacements of the mesh from the open configuration to the closed configuration based on the patient-specific segmented image data.

Alternatively, the method may further including solving Newton's equations for each node to determine a time-sequential dynamic trajectory of the mesh from the open configuration to the closed configuration based on the patient-specific segmented image data.

A method as described above may include estimating constitutive tissue parameters associated with the anatomical features and performing the associating and the minimizing with respect to the estimated parameter so as to minimize the error between the second configuration obtained from the 3D/4D ultrasound image segmentation and the second configuration obtained from simulating the segmented first configuration.

A method as described above may include estimating constitutive tissue parameters associated with a heart valve and performing the associating and the minimizing with respect to the estimated parameter so as to minimize the error between the closed valve configuration obtained from the 3D/4D ultrasound image segmentation obtained when the valve was closed and the closed valve configuration obtained by simulating the closure of the open valve configuration obtained by segmenting a 3D/4D ultrasound image of the open valve.

Parameter estimation may start with intrinsic anatomical feature parameter value, and may include determining nominal parameter values and simulating the second configuration of the patient-specific anatomical features for each of the surmised parameter values and selecting the anatomical parameters based on an extent to which the simulated second configuration of the patient-specific anatomical features corresponds to the second configuration in the patient-specific 3D segmented image data.

Parameter estimation may start with intrinsic anatomical feature parameter values of a heart valve, including valve chordal complex geometry, leaflet geometry, tissue fiber direction, mitral valve chordal lengths, valve annulus geometry, and papillary muscle placement. Parameter estimation may include determining nominal parameter values and simulating the closed configuration of the patient-specific anatomical features for each of the surmised parameter values and selecting the anatomical parameters based on an extent to which the simulated closed configuration of the patient-specific anatomical features corresponds to the closed configuration in the patient-specific 3D segmented image data.

One or more features disclosed herein may be implemented as a computer program encoded within a non-transitory computer readable medium, including instructions to cause a processor to implement one or more features described herein.

Methods and systems are disclosed herein with the aid of functional building blocks illustrating functions, features, and relationships thereof. At least some of the boundaries of these functional building blocks have been arbitrarily defined herein for the convenience of the description. Alternate boundaries may be defined so long as the specified functions and relationships thereof are appropriately performed. While various embodiments are disclosed herein, it should be understood that they are presented as examples. The scope of the claims should not be limited by any of the example embodiments disclosed herein.

1. A method of constructing a patient-specific model to simulate motion of anatomical features of a particular patient, comprising:
constructing a mesh from segmented patient-specific image data, wherein the mesh includes first and second configurations corresponding to respective first and second configurations of the anatomical features, and wherein the patient-specific image data includes one or more of volumetric (3D) ultrasound image data and time-sequential volumetric (4D) ultrasound image data;
predicting the second configuration based on the first configuration, including associating an energy term with each node of the mesh in the first configuration and minimizing the energy term, wherein the energy term includes at least a strain energy function and an external force energy function;
determining a prediction error based on a comparison of the segmented patient-specific image data and the predicted second configuration;
estimating patient-specific parameter values, including iteratively modifying an initial set of parameter value to minimize the prediction error, and providing resultant corresponding parameter values as estimated patient-specific model parameters; and
constructing a patient-specific model of the mesh to predict the second configuration from an expert-modified version of first configuration based on the estimated patient-specific model parameters.

2. The method of claim 1, wherein the anatomical features include a mitral valve, the first configuration corresponds to end diastole when the mitral valve is open, and the second configuration corresponds to systole when the valve is closed.

3. The method of claim 1, wherein the predicting includes predict 3D displacements, including solving Newton's equations for each node to determine a time-sequential dynamic trajectory of the mesh from the first configuration to the second configuration based on the segmented patient-specific image data.

4. The method of claim 1, further including providing a user-interface to permit modification of one or more of the segmented patient-specific image data, the patient-specific mesh, and the model.

5. The method of claim 4, wherein the patient-specific image data includes a heart valve, and wherein the user-interface is configured to permit modification of the segmented user-specific image of the heart valve, and addition of one or more anatomical features that are not detectable in the patient-specific image data.

6. The method of claim 4, wherein the user-interface is configured to permit modification of the patient-specific model based on a contemplated surgical procedure, and wherein the modified model predicts a corresponding patient-specific post-operative configuration of the anatomical features.

7. The method of claim 6, wherein the user-interface is configured to permit modification of the patient-specific model based on one or more selectable surgical procedure templates, and wherein the modified model predicts a corresponding patient-specific post-operative configuration of the anatomical features.

8. The method of claim 1, further including segmenting anatomical features of the image data based on at least a subset of thresholding, k-means clustering, structure tensors, level sets, graph cuts, texture-based segmentation, and Markov random fields, wherein the segmenting includes tracking the identified anatomical components based on one or more of a Bayesian filter, a Kalman filter, a condensation filter, a particle filter, and a machine learning-based filter.

9. The method of claim 1, wherein the predicting includes computing 3D displacement vectors from the patient-specific image data, wherein the computing 3D displacement vectors includes:
computing displacement vectors for voxels of time-sequential series of frames of the image data with an energy function, wherein the energy function includes,
a first-order brightness-constancy function that penalizes differences in voxel values between adjacent image frames,
a spatiotemporal smoothness function that penalizes tensor gradient in flow vectors at each voxel based on magnitudes of the gradients,
a second order regularization component including a smoothness constraint to penalize flow based on one or more of a difference in flow of a neighboring pixel, temporal smoothness, and a measure of energy efficiency;
iteratively computing displacement vectors for each frame with coarse-to-fine pyramid computations and median-filtering at intermediate computation stages of the pyramid; and
minimizing an energy function using an iterative numeric approximation technique that includes one or more of gradient descent, quasi-Newton, and inner and outer fixed-point iterations.

10. The method of claim 1, wherein the parameter estimating includes using intrinsic anatomical feature parameter values for a heart valve, including valve chordal complex geometry, leaflet geometry, tissue fiber direction, mitral valve chordal lengths, valve annulus geometry, and papillary muscle placement, and wherein the parameter estimating further includes:
determining nominal parameter values;
simulating a closed configuration of the patient-specific anatomical features for each of nominal parameter values; and
selecting the patient-specific model parameters based on an extent to which the simulated closed configuration of the patient-specific anatomical features corresponds to the closed configuration in the segmented patient-specific image data.

11. A system to construct a patient-specific model to simulate motion of anatomical features of a particular patient, comprising:
a mesh constructor to construct a mesh from segmented patient-specific image data, wherein the mesh includes first and second configurations corresponding to respective first and second configurations of the anatomical features, and wherein the patient-specific image data includes one or more of volumetric (3D) ultrasound image data and time-sequential volumetric (4D) ultrasound image data;
a predictor to predict the second configuration based on the first configuration, including to associate an energy term with each node of the mesh in the first configuration and minimize the energy term to determine, wherein the energy term includes at least a strain energy function and an external force energy function;
a comparator to determine a prediction error based on a comparison of the segmented patient-specific image data and the predicted second configuration;
a parameter estimator to iteratively modify a set of parameters to minimize the prediction error, and provide resultant parameters as estimated patient-specific model parameters; and
a model constructor to construct a patient-specific model of the mesh to predict the second configuration from an expert-modified version of first configuration based on the estimated patient-specific model parameters.

12. The system of claim 11, wherein the anatomical features include a mitral valve, wherein the first configuration corresponds to end diastole when the mitral valve is open, and wherein the second configuration corresponds to systole when the valve is closed.

13. The system of claim 11, wherein the predictor is configured to predict 3D displacements, including solving Newton's equations for each node to determine time-sequential dynamic trajectory of the mesh from the first configuration to the second configuration based on the segmented patient-specific image data.

14. The system of claim 11, further including a user-interface to permit modification of one or more of the segmented patient-specific image data, the patient-specific mesh, and the model.

15. The system of claim 14, wherein the patient-specific image data includes a heart valve, wherein the user-interface is configured to permit modification of the segmented user-specific image of the heart valve, and addition of one or more anatomical features that are not detectable in the patient-specific image data.

16. The system of claim 14, wherein the user-interface is configured to permit modification of the patient-specific model based on a contemplated surgical procedure, and wherein the modified model predicts a corresponding patient-specific post-operative configuration of the anatomical features.

17. The system of claim 14, wherein the user-interface is configured to permit modification of the patient-specific model based on one or more selectable surgical procedure templates, and wherein the modified model predicts a corresponding patient-specific post-operative configuration of the anatomical features.

18. The system of claim 11, further including a segmentation module to identify anatomical features of the image data based on at least a subset of thresholding, k-means clustering, structure tensors, level sets, graph cuts, texture-based segmentation, and Markov random fields, wherein the segmentation module includes a tracking module to track the identified anatomical components, and wherein the tracking module includes one or more of a Bayesian filter, a Kalman filter, a condensation filter, a particle filter, and a machine learning-based filter.

19. The system of claim 11, wherein the predictor includes a displacement module to compute 3D displacement vectors from the image data, wherein the displacement module is configured to:
compute displacement vectors for voxels of time-sequential series of frames of the image data with an energy function, wherein the energy function includes,
a first-order brightness-constancy function that penalizes differences in voxel values between adjacent image frames,
a spatiotemporal smoothness function that penalizes tensor gradient in flow vectors at each voxel based on magnitudes of the gradients,
a second order regularization component including a smoothness constraint to penalize flow based on one or more of a difference in flow of a neighboring pixel, temporal smoothness, and a measure of energy efficiency;
iteratively compute displacement vectors for each frame with coarse-to-fine pyramid computations and median-filtering at intermediate computation stages of the pyramid; and
minimize an energy function using an iterative numeric approximation technique that includes one or more of gradient descent, quasi-Newton, and inner and outer fixed-point iterations.

20. A non-transitory computer readable medium encoded with a computer program, including instructions to cause a processor to:
construct a mesh from segmented patient-specific image data, wherein the mesh includes first and second configurations corresponding to respective first and second configurations of the anatomical features, and wherein the patient-specific image data includes one or more of volumetric (3D) ultrasound image data and time-sequential volumetric (4D) ultrasound image data;
predict the second configuration based on the first configuration, including to associate an energy term with each node of the mesh in the first configuration and minimize the energy term to determine, wherein the energy term includes at least a strain energy function and an external force energy function;
determine a prediction error based on a comparison of the segmented patient-specific image data and the predicted second configuration;
iteratively modify a set of parameters to minimize the prediction error, and provide resultant parameters as estimated patient-specific model parameters; and
construct a patient-specific model of the mesh to predict the second configuration from an expert-modified version of first configuration based on the estimated patient-specific model parameters.
